(19) United States
(12) Patent Application Publication
(10) Pub. No.: US 2024/0399684 A1
(43) Pub. Date: Dec. 5, 2024

(54) EMBEDDED HYDROGEL CONTACT LENSES

(71) Applicant: Alcon Inc., Fribourg (CH)

(72) Inventors: Newton T. Samuel, Suwanee, GA (US); Ya-Wen Chang, Alpharetta, GA (US); Richard Charles Breitkopf, Dunwoody, GA (US); Augustine Twum Kumi, Grayson, GA (US); Steve Yun Zhang, Sugar Hill, GA (US); David Borja, Suwanee, GA (US); Ethan Leveillee, Atlanta, GA (US); Joseph Michael Lindacher, Suwanee, GA (US)

(21) Appl. No.: 18/678,833

(22) Filed: May 30, 2024

Related U.S. Application Data
(60) Provisional application No. 63/505,530, filed on Jun. 1, 2023.
(60) Provisional application No. 63/505,533, filed on Jun. 1, 2023.
(60) Provisional application No. 63/505,539, filed on Jun. 1, 2023.
(60) Provisional application No. 63/505,542, filed on Jun. 1, 2023.

(51) Int. Cl. B29D 11/00; B29C 35/08; B29K 105/24; B29L 11/00; G02B 1/04

(52) U.S. Cl. CPC B29D 11/00048; B29D 11/00134; G02B 1/043; B29C 2035/0822; B29C 2035/0827; B29K 2105/24; B29K 2995/0031; B29L 2011/0041; G02B 2207/109

(57) ABSTRACT

The invention provides a method for producing embedded diffractive contact lenses involving use of a mold set in two-curing steps. The mold set consists of three mold halves, one of which is used twice, the first time for molding a diffractive insert and the second time for an embedded contact lens with the molded diffractive insert embedded therein. The twice-used mold half has been treated with a corona plasma or a vacuum UV in a central circular area having a diameter equal to or smaller than the diameter of the insert to ensure that the molded insert consistently adheres to the twice-used mold half, even though the other mating insert mold half for molding the diffractive insert has a great tendency to bind strongly the molded insert due to the diffractive structure on its molding surface.

This application claims the benefits under 35 USC § 119 (e) of U.S. provisional application Nos. 63/505,530, 63/505,533, 63/505,539, 63/505,542, all filed on 1 Jun. 2023, incorporated by references in their entireties.

The present invention generally relates to a method for producing embedded hydrogel contact lenses. In addition, the present invention provides embedded hydrogel contact lenses produced according to a method of the invention.

### BACKGROUND

Presbyopia is a well-known disorder in which the eye loses its ability to focus at close distance, affecting more than 2 billion patients worldwide. Extensive research efforts have been contributed to develop multifocal ophthalmic lenses (intraocular lenses or contact lenses) for correcting presbyopia. One of extensive research areas is the development of multifocal diffractive ophthalmic lenses. See, for example, U.S. Pat. Nos. 4,210,391, 4,338,005, 4,340,283, 4,637,697, 4,641,934, 4,642,112, 4,655,565, 4,830,481, 4,881,804, 4,881,805, 4,936,666, 4,995,714, 4,99,5715, 5,054,905, 5,056,908, 5,076,684, 5,100,226, 5,104,212, 5,114,220, 5,116,111, 5,117,306, 5,120,120, 5,121,979, 5,121,980, 5,229,797, 5,748,282, 5,760,871, 5,982,543, 6,120,148, 6,364,483, 6,536,899, 6,951,391, 6,957,891, 7,025,456, 7,073,906, 7,093,938, 7,156,516, 7,188,949, 7,232,218, 7,891,810, 8,038,293, 8,128,222, 8,142,016, 8,382,281, 8,480,228, 8,556,416, 8,573,775, 8,678,583, 8,755,117, 9,033,494, 9,310,624, 9,320,594, 9,370,416, 10,197,815, 10,209,533, 10,426,599, 10,463,474, 10,524,899, 10,675,146, 10,725,320, 10,932,901, and 10,945,834. Currently, multifocal diffractive intraocular lenses are commercially available for correcting presbyopia.

Multifocal diffractive contact lenses are still not commercially available for correcting presbyopia (see, Pérez-Prados, et al., “Soft Multifocal Simultaneous Image Contact Lenses: Review”, Clin. Exp. Optom. 2017, 100: 107-127) probably due to some issues uniquely associated with contact lenses. For example, the standard lens materials have a refractive index of about 1.42 or less, i.e., about 0.04 higher than the refractive index of tear film. With such a small difference in refractive index, a higher diffraction grating height needs to be created on one of the anterior and posterior surfaces of a contact lens. But, contact lenses require smooth anterior and posterior surfaces for wearing comfort. Such a diffraction grating likely causes discomfort to a patient.

U.S. Pat. Appl. Pub. Nos. 2021/0191153 A1, 2021/0191154A1 and 2023/0004023A1 disclose contact lenses with an embedded diffractive optic insert therein for correction of presbyopia. There are challenges for mass production of such multifocal diffractive contact lenses. For example, insert with a diffractive optical element typically needs to be placed and fixed precisely in a position concentric with the central axis of the multifocal diffractive contact lens.

Therefore, there is still a need for producing multifocal diffractive contact lenses having inserts that each include a diffractive optical element and are positioned accurately therein in a relatively efficient and consistent manner, and which can be easily implemented in a production environment.

### SUMMARY OF THE INVENTION

In some aspects, the invention provides a method for producing embedded hydrogel contact lenses, the method of invention comprising the steps of: (1) obtaining a female mold half, a first male mold half and a second male mold half, wherein the female mold half has a first molding surface defining the anterior surface of a contact lens to be molded and also the front surface of an insert to be molded, wherein the first male mold half has a second molding surface defining the back surface of the insert to be molded and a diffractive structure thereon, wherein the second male mold half has a third molding surface defining the posterior surface of the contact lens to be molded, wherein the first male mold half and the female mold half are configured to receive each other such that an insert-molding cavity is formed between the second molding surface and a central portion of the first molding surface when the female mold half is closed with the first male mold half, wherein the second male mold half and the female mold half are configured to receive each other such that a lens-molding cavity is formed between the first and third molding surfaces when the female mold half is closed with the second male mold half; (2) treating a central circular area of the first molding surfaces by using a vacuum UV or a corona plasma, wherein the central circular area has a diameter equal to or smaller than the diameter of the insert to be molded; (3) dispensing an amount of an insert-forming composition on the central portion of the first molding surface of the female mold half obtained in step (2); (4) placing the first male mold half on top of the insert-forming composition in the female mold half and closing the first male mold half and the female mold half to form a first molding assembly comprising the insert-forming composition within the insert-molding cavity; (5) curing the insert-forming composition in the insert-molding cavity of the first molding assembly to form a molded insert made of a crosslinked polymeric material formed from the insert-forming composition; (6) separating the first molding assembly obtained in step (5) into the first male mold half and the female mold half with the molded insert that is adhered onto the central portion of the first molding surface; (7) dispensing a lens-forming composition in the female mold half with the molded insert adhered thereon in an amount sufficient for filling the lens-molding cavity; (8) placing the second male mold half on top of the lens-forming composition in the female mold half and closing the second male mold half and the female mold half to form a second molding assembly comprising the lens-forming composition and the molded insert immersed therein in the lens-molding cavity; (9) curing the lens-forming composition in the lens-molding cavity of the second molding assembly to form an embedded hydrogel contact lens precursor that comprise a bulk hydrogel material formed from the lens-forming composition and the insert embedded in the bulk material; (10) separating the second molding assembly obtained in step (9) into the second male mold half and the female mold half, with the embedded hydrogel contact lens precursor adhered on a lens-adhered mold half which is one of the female and second male mold halves; (11) removing the embedded hydrogel contact lens precursor from the lens-adhered mold half (preferably before the embedded hydrogel contact lens precursor is contact with water or any liquid); and (12) subjecting the embedded hydrogel contact lens precursor to post-molding processes including one or more processes selected from the group consisting of extraction, hydration, surface treatment, packaging, sterilization, and combinations thereof to obtain an embedded hydrogel contact lens.

In other aspects, the invention provides a method for producing embedded hydrogel contact lenses, the method of invention comprising the steps of: (1) obtaining a first female mold half, a male mold half and a second female mold half, wherein the first female mold half has a first molding surface defining the front surface of an insert to be molded and a diffractive structure thereon, wherein the male mold half has a second molding surface defining the posterior surface of a contact lens to be molded and also the back surface of the insert to be molded, wherein the second female mold half has a third molding surface defining the anterior surface of the contact lens to be molded, wherein the first female mold half and the male mold half are configured to receive each other such that an insert-molding cavity is formed between the first molding surface and a central portion of the second molding surface when the male mold half is closed with the first female mold half, wherein the second female mold half and the male mold half are configured to receive each other such that a lens-molding cavity is formed between the second and third molding surfaces when the male mold half is closed with the second female mold half; (2) treating a central circular area of the second molding surface by using a vacuum UV or a corona plasma, wherein the central circular area has a diameter equal to or smaller than the diameter of the insert to be molded; (3) dispensing an amount of an insert-forming composition on the first molding surface of the first female mold half; (4) placing the male mold half obtained in step (2) on top of the insert-forming composition in the first female mold half and closing the first female mold half and the male mold half to form a first molding assembly comprising the insert-forming composition within the insert-molding cavity; (5) curing the insert-forming composition in the insert-molding cavity of the first molding assembly to form a molded insert made of a crosslinked polymeric material formed from the insert-forming composition; (6) separating the first molding assembly obtained in step (5) into the first female mold half and the male mold half with the molded insert that is adhered onto the central portion of the second molding surface; (7) dispensing a lens-forming composition in the second female mold half in an amount sufficient for filling the lens-molding cavity; (8) placing the male mold half with the molded insert adhered thereon on top of the lens-forming composition in the second female mold half and closing the male mold half and the second female mold half to form a second molding assembly comprising the lens-forming composition and the molded insert immersed therein in the lens-molding cavity; (9) curing the lens-forming composition in the lens-molding cavity of the second molding assembly to form an embedded hydrogel contact lens precursor that comprise a bulk hydrogel material formed from the lens-forming composition and the insert embedded in the bulk material; (10) separating the second molding assembly obtained in step (9) into the male mold half and the second female mold half, with the embedded hydrogel contact lens precursor adhered on a lens-adhered mold half which is one of the male and second female mold halves; (11) removing the embedded hydrogel contact lens precursor from the lens-adhered mold half (preferably before the embedded hydrogel contact lens precursor is contact with water or any liquid); and (12) subjecting the embedded hydrogel contact lens precursor to post-molding processes including one or more processes selected from the group consisting of extraction, hydration, surface treatment, packaging, sterilization, and combinations thereof to obtain an embedded hydrogel contact lens.

These and other aspects of the invention will become apparent from the following description of the presently preferred embodiments. The detailed description is merely illustrative of the invention and does not limit the scope of the invention, which is defined by the appended claims and equivalents thereof. As would be obvious to one skilled in the art, many variations and modifications of the invention may be effected without departing from the spirit and scope of the novel concepts of the disclosure.

### BRIEF DESCRIPTION OF DRAWINGS

FIG. 1 schematically illustrates an embedded hydrogel contact lens according to a preferred embodiment of the invention.

FIG. 2 schematically illustrates an embedded hydrogel contact lens according to a preferred embodiment of the invention.

### DETAILED DESCRIPTION OF EMBODIMENTS OF THE INVENTION

Unless defined otherwise, all technical and scientific terms used herein have the same meaning as commonly understood by one of ordinary skill in the art to which this invention belongs. Generally, the nomenclature used herein and the laboratory procedures are well known and commonly employed in the art. Conventional methods are used for these procedures, such as those provided in the art and various general references. Where a term is provided in the singular, the inventors also contemplate the plural of that term. The nomenclature used herein and the laboratory procedures described below are those well-known and commonly employed in the art.

“About” as used herein in this application means that a number, which is referred to as “about”, comprises the recited number plus or minus 1-10% of that recited number.

“Contact Lens” refers to a structure that can be placed on or within a wearer's eye. A contact lens can correct, improve, or alter a user's eyesight, but that need not be the case. A contact lens can be of any appropriate material known in the art or later developed, and can be a soft lens, a hard lens, or an embedded lens.

A “hydrogel contact lens” refers to a contact lens comprising a hydrogel bulk (core) material. A hydrogel bulk material can be a non-silicone hydrogel material or preferably a silicone hydrogel material.

A “hydrogel” or “hydrogel material” refers to a crosslinked polymeric material which has three-dimensional polymer networks (i.e., polymer matrix), is insoluble in water, but can hold at least 10% by weight of water in its polymer matrix when it is fully hydrated (or equilibrated).

A “silicone hydrogel” or “SiHy” interchangeably refers to a silicone-containing hydrogel obtained by copolymerization of a polymerizable composition comprising at least one silicone-containing monomer or at least one silicone-containing macromer or at least one crosslinkable silicone-containing prepolymer.

A siloxane, which often also described as a silicone, refers to a molecule having at least one moiety of —Si—O—Si— where each Si atom carries two organic groups as substituents.

As used in this application, the term “non-silicone hydrogel” or “non-silicone hydrogel material” interchangeably refers to a hydrogel that is theoretically free of silicon.

An “embedded hydrogel contact lens” refers a hydrogel contact lens comprising at least one insert which is embedded within the bulk hydrogel material of the embedded hydrogel contact lens to an extend that at most one of the anterior or posterior surfaces of the insert can be exposed fully or partially. It is understood that the material of the insert is different from the bulk hydrogel material of the embedded hydrogel contact lens.

An “insert” refers to any 3-dimensional article which has a dimension of at least 5 microns but is smaller in dimension sufficient to be embedded in the bulk material of an embedded hydrogel contact lens and which is made of a material (preferably a non-hydrogel material) that is different from the bulk hydrogel material.

In accordance with the invention, a non-hydrogel material can be any material that can absorb less than 5% (preferably about 4% or less, more preferably about 3% or less, even more preferably about 2% or less) by weight of water when being fully hydrated.

In accordance with the invention, an insert of the invention has a thickness less than any thickness of an embedded hydrogel contact lens in the region where the insert is embedded. An insert can be any object have any geometrical shape and can have any desired functions. Examples of preferred inserts include without limitation thin rigid inserts for providing rigid center optics for masking astigmatism like a rigid gas permeable (RGP) contact lens, multifocal lens inserts, photochromic inserts, cosmetic inserts having color patterns printed thereon, etc.

“Hydrophilic,” as used herein, describes a material or portion thereof that will more readily associate with water than with lipids.

“Hydrophobic” in reference to an insert material or insert that has an equilibrium water content (i.e., water content in fully hydrated state) of less than 5% (preferably about 4% or less, more preferably about 3% or less, even more preferably about 2% or less).

The term “room temperature” refers to a temperature of about 22° C. to about 26° C.

The term “soluble”, in reference to a compound or material in a solvent, means that the compound or material can be dissolved in the solvent to give a solution with a concentration of at least about 0.5% by weight at room temperature (i.e., from about 22° C. to about 26° C.).

The term “insoluble”, in reference to a compound or material in a solvent, means that the compound or material can be dissolved in the solvent to give a solution with a concentration of less than 0.01% by weight at room temperature (as defined above).

A “vinylic monomer” refers to a compound that has one sole ethylenically unsaturated group, is soluble in a solvent, and can be polymerized actinically or thermally.

As used in this application, the term “ethylenically unsaturated group” is employed herein in a broad sense and is intended to encompass any groups containing at least one >C═CH₂ group. Exemplary ethylenically unsaturated groups include without limitation (meth)acryloyl

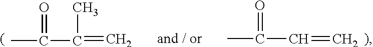

allyl, vinyl, styrenyl, or other C═CH₂ containing groups.

An “acrylic monomer” refers to a vinylic monomer having one sole (meth)acryloyl group. Examples of acrylic monomrs includes (meth)acryloxy [or(meth)acryloyloxy] monomers and (meth)acrylamido monomers.

An “(meth)acryloxy monomer” or “(meth)acryloyloxy monomer” refers to a vinylic monomer having one sole group of

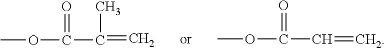

An “(meth)acrylamido monomer” refers to a vinylic monomer having one sole group of

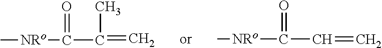

in which R^{∘} is H or C₁-C₄ alkyl.

The term “aryl vinylic monomer” refers to a vinylic monomer having an aromatic ring.

The term “(meth)acrylamide” refers to methacrylamide and/or acrylamide.

The term “(meth)acrylate” refers to methacrylate and/or acrylate.

An “N-vinyl amide monomer” refers to an amide compound having a vinyl group (—CH═CH₂) that is directly attached to the nitrogen atom of the amide group.

An “ene monomer” refers to a vinylic monomer having one sole ene group.

A “hydrophilic vinylic monomer”, a “hydrophilic acrylic monomer”, a “hydrophilic (meth)acryloxy monomer”, or a “hydrophilic (meth)acrylamido monomer”, as used herein, respectively refers to a vinylic monomer, an acrylic monomer, a (meth)acryloxy monomer, or a (meth)acrylamido monomer), which typically yields a homopolymer that is water-soluble or can absorb at least 10 percent by weight of water.

A “hydrophobic vinylic monomer”, a “hydrophobic acrylic monomer”, a “hydrophobic (meth)acryloxy monomer”, or a “hydrophobic (meth)acrylamido monomer”, as used herein, respectively refers to a vinylic monomer, an acrylic monomer, a (meth)acryloxy monomer, or a (meth)acrylamido monomer), which typically yields a homopolymer that is insoluble in water and can absorb less than 10% by weight of water.

As used in this application, the term “vinylic crosslinker” refers to an organic compound having at least two ethylenically unsaturated groups. A “vinylic crosslinking agent” refers to a vinylic crosslinker having a molecular weight of 700 Daltons or less.

An “acrylic crosslinker” refers to a vinylic crosslinker having at least two (meth)acryloyl groups.

An “aryl vinylic crosslinker” refers to a vinylic crosslinker having an aromatic ring.

The term “acrylic repeating units” refers to repeating units of a polymeric material, each of which is derived from an acrylic monomer or crosslinker in a free-radical polymerization to form the polymeric material.

The term “terminal (meth)acryloyl group” refers to one (meth)acryloyl group at one of the two ends of the main chain (or backbone) of an organic compound.

As used herein, “actinically” in reference to curing, crosslinking or polymerizing of a polymerizable composition, a prepolymer or a material means that the curing (e.g., crosslinked and/or polymerized) is performed by actinic irradiation, such as, for example, UV/visible irradiation, ionizing radiation (e.g. gamma ray or X-ray irradiation), microwave irradiation, and the like. Thermal curing or actinic curing methods are well-known to a person skilled in the art.

As used in this application, the term “polymer” means a material formed by polymerizing one or more monomers or macromers or prepolymers or combinations thereof.

A “macromer” or “prepolymer” refers to a compound or polymer that contains ethylenically unsaturated groups and has a number average molecular weight of greater than 700 Daltons.

As used in this application, the term “molecular weight” of a polymeric material (including monomeric or macromeric materials) refers to the number-average molecular weight unless otherwise specifically noted or unless testing conditions indicate otherwise. A skilled person knows how to determine the molecular weight of a polymer according to known methods, e.g., GPC (gel permeation chromatography) with one or more of a refractive index detector, a low-angle laser light scattering detector, a multi-angle laser light scattering detector, a differential viscometry detector, a UV detector, and an infrared (IR) detector; MALDI-TOF MS (matrix-assisted laser desorption/ionization time-of-flight mass spectroscopy); ¹H NMR (Proton nuclear magnetic resonance) spectroscopy, etc.

A “polysiloxane segment” or “polydiorganosiloxane segment” interchangeably refers to a polymer chain segment (i.e., a divalent radical) of

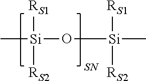

in which SN is an integer of 3 or larger and each of Rₛ₁ and Rₛ₂ independent of one another are selected from the group consisting of: C₁-C₁₀ alkyl; phenyl; C₁-C₄-alkyl-substituted phenyl; C₁-C₄-alkoxy-substituted phenyl; phenyl-C₁-C₆-alkyl; C₁-C₁₀ fluoroalkyl; C₁-C₁₀ fluoroether; aryl; aryl C₁-C₈ alkyl; -alk-(OC₂H₄)_{γ1}—OR∘ (in which alk is C₁-C₆ alkylene diradical, R∘ is H or C₁-C₄ alkyl and γ1 is an integer from 1 to 10); a C₂-C₄₀ organic radical having at least one functional group selected from the group consisting of hydroxyl group (—OH), carboxyl group (—COOH), amino group (—NR_{N1}R_{N1}′), amino linkages of —NR_{N1}—, amide linkages of —CONR_{N1}—, amide of —CONR_{N1}R_{N1}′, urethane linkages of —OCONH—, and C₁-C₄ alkoxy group, or a linear hydrophilic polymer chain, in which R_{N1} and R_{N1}′ independent of each other are hydrogen or a C₁-C₁₅ alkyl.

A “polysiloxane vinylic monomer” refers to a compound comprising at least one polysiloxane segment and one sole ethylenically-unsaturated group.

A “polydiorganosiloxane vinylic crosslinker” or polysiloxane vinylic crosslinker” interchangeably refers to a compound comprising at least one polysiloxane segment and at least two ethylenically-unsaturated groups.

A “linear polydiorganosiloxane vinylic crosslinker” or “linear polysiloxane vinylic crosslinker” interchangeably refers to a compound comprising a main chain which includes at least one polysiloxane segment and is terminated with one ethylenically-unsaturated group at each of the two ends of the main chain.

A “chain-extended polydiorganosiloxane vinylic crosslinker” or “chain-extended polysiloxane vinylic crosslinker” interchangeably refers to a compound comprising at least two ethylenically-unsaturated groups and at least two polysiloxane segments each pair of which are linked by one divalent radical.

The term “fluid” as used herein indicates that a material is capable of flowing like a liquid.

As used in this application, the term “clear” in reference to a polymerizable composition means that the polymerizable composition is a transparent solution or liquid mixture (i.e., having a light transmissibility of 85% or greater, preferably 90% or greater in the range between 400 to 700 nm).

The term “monovalent radical” refers to an organic radical that is obtained by removing a hydrogen atom from an organic compound and that forms one bond with one other group in an organic compound. Examples include without limitation, alkyl (by removal of a hydrogen atom from an alkane), alkoxy (or alkoxyl) (by removal of one hydrogen atom from the hydroxyl group of an alkyl alcohol), thiyl (by removal of one hydrogen atom from the thiol group of an alkylthiol), cycloalkyl (by removal of a hydrogen atom from a cycloalkane), cycloheteroalkyl (by removal of a hydrogen atom from a cycloheteroalkane), aryl (by removal of a hydrogen atom from an aromatic ring of the aromatic hydrocarbon), heteroaryl (by removal of a hydrogen atom from any ring atom), amino (by removal of one hydrogen atom from an amine), etc.

The term “divalent radical” refers to an organic radical that is obtained by removing two hydrogen atoms from an organic compound and that forms two bonds with other two groups in an organic compound. For example, an alkylene divalent radical (i.e., alkylenyl) is obtained by removal of two hydrogen atoms from an alkane, a cycloalkylene divalent radical (i.e., cycloalkylenyl) is obtained by removal of two hydrogen atoms from the cyclic ring.

In this application, the term “substituted” in reference to an alkyl or an alkylenyl means that the alkyl or the alkylenyl comprises at least one substituent which replaces one hydrogen atom of the alkyl or the alkylenyl and is selected from the group consisting of hydroxyl (—OH), carboxyl (—COOH), —NH₂, sulfhydryl (—SH), C₁-C₄ alkyl, C₁-C₄ alkoxy, C₁-C₄ alkylthio (alkyl sulfide), C₁-C₄ acylamino, C₁-C₄ alkylamino, di-C₁-C₄ alkylamino, and combinations thereof.

A free radical initiator can be either a photoinitiator or a thermal initiator. A “photoinitiator” refers to a chemical that initiates free radical crosslinking/polymerizing reaction by the use of light. A “thermal initiator” refers to a chemical that initiates free radical crosslinking/polymerizing reaction by the use of heat energy.

The intrinsic “oxygen permeability”, Dkᵢ, of a material is the rate at which oxygen will pass through a material. Oxygen permeability is conventionally expressed in units of barrers, where “barrer” is defined as [(cm³ oxygen)(mm)/(cm²)(sec)(mm Hg)]×10⁻¹⁰.

The “oxygen transmissibility”, Dk/t, of an insert or material is the rate at which oxygen will pass through a specific insert or material with an average thickness of t [in units of mm] over the area being measured. Oxygen transmissibility is conventionally expressed in units of barrers/mm, where “barrers/mm” is defined as [(cm³ oxygen)/(cm²)(sec)(mm Hg)]×10⁻⁹.

The “ion permeability” through a lens correlates with the lonoflux Diffusion Coefficient. The lonoflux Diffusion Coefficient, D (in units of [mm²/min]), is determined by applying Fick's law as follows:

$$D = - {n}^{′} / ( A \times dc / dx )$$

where n′=rate of ion transport [mol/min]; A=area of lens exposed [mm²]; dc=concentration difference [mol/L]; dx=thickness of lens [mm].

The term “modulus” or “elastic modulus” in reference to a contact lens or a material means the tensile modulus or Young's modulus which is a measure of the stiffness of a contact lens or a material. The modulus can be measured according to the procedures described in Example 1.

A “precursor” refers to an insert or contact lens which is obtained by cast-molding of a polymerizable composition in a mold and has not been subjected to extraction and/or hydration post-molding processes (i.e., having not been in contact with water or any organic solvent or any liquid after molding).

A “male mold half” or “base curve mold half” interchangeably refers to a mold half having a molding surface that is a substantially convex surface and that defines the posterior surface of a contact lens or an insert.

A “female mold half” or “front curve mold half” interchangeably refers to a mold half having a molding surface that is a substantially concave surface and that defines the anterior surface of a contact lens or an insert.

The term “anterior surface”, “front surface”, “front curve surface” or “FC surface” in reference to a contact lens or an insert, as used in this application, interchangeably means a surface of the contact lens or insert that faces away from the eye during wear. The anterior surface (FC surface) is convex.

The “posterior surface”, “back surface”, “base curve surface” or “BC surface” in reference to a contact lens or insert, as used in this application, interchangeably means a surface of the contact lens or insert that faces towards the eye during wear. The posterior surface (BC surface) is concave.

A “central axis” in reference to a contact lens, as used in this application, means an imaginary reference line passing through the geometrical centers of the anterior and posterior surfaces of a contact lens.

A “central axis” in reference to a mold half, as used in this application, means an imaginary reference line passing normally (i.e., normal to the molding surface at the geometrical center) through the geometrical centers of the molding surface of the mold half.

The term “diameter” in reference to a contact lens or an insert, as used in this application, means the width of the contact lens or the insert from edge to edge.

A corona treatment (aka, so-called a “air plasma”) refers to a surface modification technique that uses a low temperature corona discharge plasma to impart changes in the properties of a surface. The corona plasma is generated by the application of high voltage to an electrode that has a sharp tip.

The term “vacuum UV” refers to ultraviolet radiation with wavelengths below 200 nm.

In general, the invention is directed to a method for producing embedded diffractive contact lenses in a cost-effective manner. A method of the invention involves use of a special set of three mold halves in a two-consecutive cast molding process. One of the three mold halves ahs been used twice, the first time for forming a first molding assembly with a mating insert mod half for molding a diffractive insert and the second time for forming a second molding assembly with a mating lens mod half for molding an embedded hydrogel contact lens with a diffractive insert embedded therein. This twice-used mold half has been treated with a corona plasma or a vacuum UV in a central circular area having a diameter equal to or smaller than the diameter of the insert. It is discovered that when the molding surface of the other mating insert mold half comprises a diffractive structure, the molded insert would have a great tendency to stick (adhere) to the other mating insert mold half during the separation of the insert molding assembly. However, when the molding surface of such a mold half has been treated with a corona plasma or a vacuum UV in a central circular area having a diameter equal to or less than the diameter of the insert, the molded insert can consistently adhere to the twice-used mold half during the separation of the insert molding assembly.

A method of the invention can offer the following advantages. First, one mold half for molding an insert is eliminated, saving the costs associated with that mold half. Second, no guide for centrally positioning an insert is required during lens molding process. By eliminating positioning guides, any small voids in the lenses from the positioning guides are eliminated, thus removing any potential for bioburden trapping. Third, by using a special set of three mold halves and by eliminating the step of removing inserts from insert-adhered mold halves, the accurately positioning of inserts during molding in a method of the invention can be achieved. Fourth, a method of the invention can be easily implemented in an automatic product line for producing embedded hydrogel contact lenses in mass. Fifth, because the diffractive structure is buried inside the contact lens, the changes in tear film thickness would not adversely affect the diffractive power and the contact lens would have smooth anterior and posterior surfaces for wearing comfort.

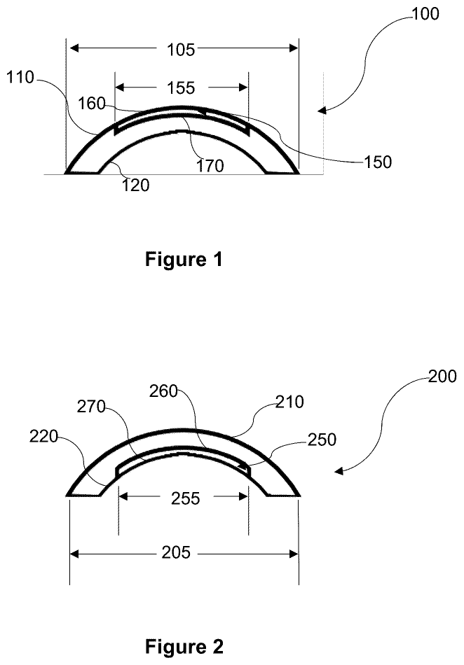

FIG. 1 schematically illustrates a cross-sectional view of an embedded hydrogel contact lens according to an embodiment of the invention. An embedded hydrogel contact lens 100 comprises an anterior surface 110, an opposite posterior surface 120, and an insert 150 and has a diameter 105 sufficient large to cover the cornea of a human eye. The insert 150 is made of a polymeric material different from the polymeric material of the remaining part of the embedded hydrogel contact lens 100 and comprises a front surface 160 and an opposite back surface 170. The insert 150 has a diameter 155 sufficient small so as to be located within the optical zone of the embedded hydrogel contact lens 100. According to this preferred embodiment, the front surface 160 of the insert 150 substantially merges with the anterior surface 110 of the embedded hydrogel contact lens 100 (excluding any coating on the embedded hydrogel contact lens 100).

FIG. 2 schematically illustrates a cross-sectional view of an embedded hydrogel contact lens according to another embodiment of the invention. An embedded hydrogel contact lens 200 comprises an anterior surface 210, an opposite posterior surface 220, and an insert 250 and has a diameter 205 sufficient large to cover the cornea of a human eye. The insert 250 is made of a polymeric material different from the polymeric material of the remaining part of the embedded hydrogel contact lens 200 and comprises a front surface 260 and an opposite back surface 270. The insert 250 has a diameter 255 sufficient small so as to be located within the optical zone of the embedded hydrogel contact lens 200. According to this preferred embodiment, the back surface 270 of the insert 250 substantially merges with the posterior surface 220 of the embedded contact lens 200 (excluding any coating on the embedded hydrogel contact lens 200).

The present invention provides, in one aspect, a method for producing embedded hydrogel contact lenses, comprising the steps of: (1) obtaining a female mold half, a first male mold half and a second male mold half, wherein the female mold half has a first molding surface defining the anterior surface of a contact lens to be molded and also the front surface of an insert to be molded, wherein the first male mold half has a second molding surface defining the back surface of the insert to be molded and a diffractive structure thereon, wherein the second male mold half has a third molding surface defining the posterior surface of the contact lens to be molded, wherein the first male mold half and the female mold half are configured to receive each other such that an insert-molding cavity is formed between the second molding surface and a central portion of the first molding surface when the female mold half is closed with the first male mold half, wherein the second male mold half and the female mold half are configured to receive each other such that a lens-molding cavity is formed between the first and third molding surfaces when the female mold half is closed with the second male mold half; (2) treating a central circular area of the first molding surfaces by using a vacuum UV or a corona plasma, wherein the central circular area has a diameter equal to or smaller than the diameter of the insert to be molded; (3) dispensing an amount of an insert-forming composition on the central portion of the first molding surface of the female mold half obtained in step (2); (4) placing the first male mold half on top of the insert-forming composition in the female mold half and closing the first male mold half and the female mold half to form a first molding assembly comprising the insert-forming composition within the insert-molding cavity; (5) curing the insert-forming composition in the insert-molding cavity of the first molding assembly to form a molded insert made of a crosslinked polymeric material formed from the insert-forming composition; (6) separating the first molding assembly obtained in step (5) into the first male mold half and the female mold half with the molded insert that is adhered onto the central portion of the first molding surface; (7) dispensing a lens-forming composition in the female mold half with the molded insert adhered thereon in an amount sufficient for filling the lens-molding cavity; (8) placing the second male mold half on top of the lens-forming composition in the female mold half and closing the second male mold half and the female mold half to form a second molding assembly comprising the lens-forming composition and the molded insert immersed therein in the lens-molding cavity; (9) curing the lens-forming composition in the lens-molding cavity of the second molding assembly to form an embedded hydrogel contact lens precursor that comprise a bulk hydrogel material formed from the lens-forming composition and the insert embedded in the bulk hydrogel material; (10) separating the second molding assembly obtained in step (9) into the second male mold half and the female mold half, with the embedded hydrogel contact lens precursor adhered on a lens-adhered mold half which is one of the female and second male mold halves; (11) removing the embedded hydrogel contact lens precursor from the lens-adhered mold half (preferably before the embedded hydrogel contact lens precursor is contact with water or any liquid); and (12) subjecting the embedded hydrogel contact lens precursor to post-molding processes including one or more processes selected from the group consisting of extraction, hydration, surface treatment, packaging, sterilization, and combinations thereof to obtain an embedded hydrogel contact lens.

The present invention, in another aspect, provides a method for producing embedded hydrogel contact lenses, the method of invention comprising the steps of: (1) obtaining a first female mold half, a male mold half and a second female mold half, wherein the first female mold half has a first molding surface defining the front surface of an insert to be molded and a diffractive structure thereon, wherein the male mold half has a second molding surface defining the posterior surface of a contact lens to be molded and also the back surface of the insert to be molded, wherein the second female mold half has a third molding surface defining the anterior surface of the contact lens to be molded, wherein the first female mold half and the male mold half are configured to receive each other such that an insert-molding cavity is formed between the first molding surface and a central portion of the second molding surface when the male mold half is closed with the first female mold half, wherein the second female mold half and the male mold half are configured to receive each other such that a lens-molding cavity is formed between the second and third molding surfaces when the male mold half is closed with the second female mold half; (2) treating a central circular area of the second molding surface by using a vacuum UV or a corona plasma, wherein the central circular area has a diameter equal to or smaller than the diameter of the insert to be molded; (3) dispensing an amount of an insert-forming composition on the first molding surface of the first female mold half; (4) placing the male mold half obtained in step (2) on top of the insert-forming composition in the first female mold half and closing the first female mold half and the male mold half to form a first molding assembly comprising the insert-forming composition within the insert-molding cavity; (5) curing the insert-forming composition in the insert-molding cavity of the first molding assembly to form a molded insert made of a crosslinked polymeric material formed from the insert-forming composition; (6) separating the first molding assembly obtained in step (5) into the first female mold half and the male mold half with the molded insert that is adhered onto the central portion of the second molding surface; (7) dispensing a lens-forming composition in the second female mold half in an amount sufficient for filling the lens-molding cavity; (8) placing the male mold half with the molded insert adhered thereon on top of the lens-forming composition in the second female mold half and closing the male mold half and the second female mold half to form a second molding assembly comprising the lens-forming composition and the molded insert immersed therein in the lens-molding cavity; (9) curing the lens-forming composition in the lens-molding cavity of the second molding assembly to form an embedded hydrogel contact lens precursor that comprise a bulk hydrogel material formed from the lens-forming composition and the insert embedded in the bulk material; (10) separating the second molding assembly obtained in step (9) into the male mold half and the second female mold half, with the embedded hydrogel contact lens precursor adhered on a lens-adhered mold half which is one of the male and second female mold halves; (11) removing the embedded hydrogel contact lens precursor from the lens-adhered mold half (preferably before the embedded hydrogel contact lens precursor is contact with water or any liquid); and (12) subjecting the embedded hydrogel contact lens precursor to post-molding processes including one or more processes selected from the group consisting of extraction, hydration, surface treatment, packaging, sterilization, and combinations thereof to obtain an embedded hydrogel contact lens.

Mold halves for making contact lenses (or inserts) are well known to a person skilled in the art and, for example, are employed in cast molding. In general, a molding assembly comprises at least two mold halves, one male half and one female mold half. The male mold half has a first molding (or optical) surface which is in direct contact with a polymerizable composition for cast molding of a contact lens (or an insert) and defines the posterior (back) surface of a molded contact lens (or a molded insert); and the female mold half has a second molding (or optical) surface which is in direct contact with the polymerizable composition and defines the anterior (front) surface of the molded contact lens (or molded insert). The male and female mold halves are configured to receive each other such that a lens- or insert-forming cavity is formed between the first molding surface and the second molding surface.

In a preferred embodiment, the first female or male mold half having a molding surface defining front or back surface of the insert comprise an overflow groove which surrounds the molding surface and receives any excess insert-forming material when the first molding assembly is closed. By having such an overflow groove, one can ensure that any flushes formed from the excess insert-forming material during molding of the insert can be stuck on the first female or male mold half during the step of separating the first molding assembly, thereby removing the flushes.

Methods of manufacturing mold halves for cast-molding a contact lens or an insert are generally well known to those of ordinary skill in the art. The process of the present invention is not limited to any particular method of forming a mold half. In fact, any method of forming a mold half can be used in the present invention. The mold halves can be formed through various techniques, such as injection molding or lathing. Examples of suitable processes for forming the mold halves are disclosed in U.S. Pat. Nos. 4,444,711; 4,460,534; 5,843,346; and 5,894,002.

Virtually all materials known in the art for making mold halves can be used to make mold halves for making contact lenses or inserts. For example, polymeric materials, such as polyethylene, polypropylene, polystyrene, PMMA, Topas® COC grade 8007-S10 (clear amorphous copolymer of ethylene and norbornene, from Ticona GmbH of Frankfurt, Germany and Summit, New Jersey), or the like can be used.

According to with the invention, a diffractive structure is essentially a transmission diffraction grating. A transmission diffraction grating is typically comprised of a plurality of repetitive ridges and/or grooves regularly or periodically spaced and arranged in concentrically rings or zones—annular zones (i.e., echelettes) at a respective surface of a lens (i.e., an insert in this application). The periodic spacing or pitch of the ridges and/or grooves substantially determines the points of destructive and constructive interference at the optical axis of the lens. The shape and height of the ridges and/or grooves control the amount of incident light that is provided at a point of constructive interference by diffraction. The points of constructive interference are generally called diffraction orders or focal points.

The diffractive power is related to the properties of these zones, for instance their number, shape, size and position. Currently used echelettes may typically be defined by a primary zone, a secondary zone between the primary zone and a primary zone of an adjacent echelette, and an echelette geometry. The echelette geometry includes inner and outer diameters and a shaped or sloped profile. Secondary zones may describe the situation where the theoretical primary zone is a discontinuous function, leading to discrete steps in the profile height. Secondary zones may be introduced to solve the manufacturing issue of making sharp corner in a surface, and/or to reduce possible light scatter from sharp corners. The overall profile may be characterized by an echelette height or step height between adjacent echelettes. The relative radial spacing of the echelettes largely determine the power(s) of the lens and the step height of the secondary zones largely determines the light distribution between the different add powers. Together, these echelettes define a diffractive profile, often saw-toothed or stepped, on one of the surfaces of the lens.

The diffractive profile (Z_{diff}) (or so-called sag profile) can be given by Equation 1

$${Z}_{{diff}^{=}} \frac{m λ φ ( x )}{{Rl}_{2} - {Rl}_{1}} {x}^{2} \qquad ( 1 )$$

in which m is the diffraction order (typically 0 for the distance focus and 1 for the ADD order), λ is the design wavelength (typically 550 nm), x is radial position (i.e., the radial distance from the center), and φ(x) is a phase function in the radial x direction.

The radial position x of the diffractive transitions is a function of the diffractive optical power to be added to the system or Add power and the wavelength:

$$Zone ( i ) = \sqrt{\frac{2 i λ}{Add}} \qquad ( 2 )$$

And the height of the diffractive transition is given by:

$$Height ( i ) = \vert \frac{m λ}{{RI}_{2} - {RI}_{1}} \vert \qquad ( 3 )$$

It is understood that any phase function known to a person skilled in the art can be used in creating a desired diffractive profile. Exemplary phase functions can be a modulo 2 pi kinoform design which would function as a Fresnel lens, an apodized bifocal lens design similar to ReSTOR or a Quadrafocal design similar to PanOptix which would result in a trifocal lens.

The central area of the molding surface of the first female or mold half can be treated with a corona plasma and a vacuum UV according to any techniques known to a person skilled in the art. For example, the molding surface can be covered with a mask having a circular opening which limits the area of the molding surface of the female mold half to be treated with a corona plasma or a vacuum UV.

In accordance with the invention, the central area to be treated on the molding surface of the first female or male mold half has a diameter equal to or smaller than the diameter of the insert. In some preferred embodiment, the diameter of the central area to be treated is about 90% or smaller, preferably about 75% or smaller, more preferably about 60% or smaller, even more preferably about 45% or smaller of the diameter of the insert.

In accordance with the invention, an insert-forming composition can be any polymerizable compositions, so long as the crosslinked polymeric materials resulted therefrom have a refractive index that is at least 0.03 higher than the refractive index of the bulk hydrogel material.

In various preferred embodiments, the crosslinked polymeric material of the insert has a refractive index of at least 1.44, (preferably at least 1.46, more preferably at least 1.48, even more preferably at least 1.50).

In other various preferred embodiments, an insert-forming composition comprises at least one aryl vinylic monomer and/or at least one aryl vinylic crosslinker. Aryl vinylic monomers and aryl vinylic crosslinkers can provide resultant insert with a relatively high refractive index.

Examples of preferred aryl vinylic monomers include, but are not limited to: 2-ethylphenoxy acrylate; 2-ethylphenoxy methacrylate; phenyl acrylate; phenyl methacrylate; benzyl acrylate; benzyl methacrylate; 2-phenylethyl acrylate; 2-phenylethyl methacrylate; 3-phenylpropyl acrylate; 3-phenylpropyl methacrylate; 4-phenylbutyl acrylate; 4-phenylbutyl methacrylate; 4-methylphenyl acrylate; 4-methylphenyl methacrylate; 4-methylbenzyl acrylate; 4-methylbenzyl methacrylate; 2-(2-methylphenyl)ethyl acrylate; 2-(2-methylphenyl)ethyl methacrylate; 2-(3-methylphenyl)ethyl acrylate; 2-(3-methylphenyl)ethyl methacrylate; 2-(4-methylphenyl)ethyl acrylate; 2-(4-methylphenyl)ethyl methacrylate; 2-(4-propylphenyl)ethyl acrylate; 2-(4-propylphenyl)ethyl methacrylate; 2-(4-(1-methylethyl)phenyl)ethyl acrylate; 2-(4-(1-methylethyl)phenyl)ethyl methacrylate; 2-(4-methoxyphenyl)ethyl acrylate; 2-(4-methoxy-phenyl)ethyl methacrylate; 2-(4-cyclohexylphenyl)ethyl acrylate; 2-(4-cyclohexylphenyl)ethyl methacrylate; 2-(2-chlorophenyl)ethyl acrylate; 2-(2-chlorophenyl)ethyl methacrylate; 2-(3-chlorophenyl)ethyl acrylate; 2-(3-chlorophenyl)ethyl methacrylate; 2-(4-chlorophenyl)ethyl acrylate; 2-(4-chlorophenyl)ethyl methacrylate; 2-(4-bromophenyl)ethyl acrylate; 2-(4-bromophenyl)ethyl methacrylate; 2-(3-phenylphenyl)ethyl acrylate; 2-(3-phenylphenyl)ethyl methacrylate; 2-(4-phenylphenyl)ethyl acrylate; 2-(4-phenylphenyl)ethyl methacrylate; 2-(4-benzylphenyl)ethyl acrylate; 2-(4-benzylphenyl)ethyl methacrylate; 2-(phenylthio)ethyl acrylate; 2-(phenylthio)ethyl methacrylate; 2-benzyloxyethyl acrylate; 3-benzyloxypropyl acrylate; 2-benzyloxyethyl methacrylate; 3-benzyloxypropyl methacrylate; 2-[2-(benzyloxy)ethoxy]ethyl acrylate; 2-[2-(benzyloxy)ethoxy]ethyl methacrylate; silicone-containing aryl vinylic monomers (e.g., p-vinylphenyltris(trimethylsiloxy)silane, m-vinylphenyltris(trimethylsiloxy)silane, o-vinylphenyltris(trimethylsiloxy)silane, p-styrylethyltris(trimethylsiloxy)silane, m-styrylethyl-tris-(trimethylsiloxy)silane, o-styrylethyltris(trimethylsiloxy)silane); aryl-containing ene monomers; or combinations thereof. The above listed aryl acrylic monomers can be obtained from commercial sources or alternatively prepared according to methods known in the art.

Examples of aryl-containing ene monomers include without limitation vinyl naphthalenes, vinyl anthracenes, vinyl phenanthrenes, vinyl pyrenes, vinyl biphenyls, vinyl terphenyls, vinyl phenyl naphthalenes, vinyl phenyl anthracenes, vinyl phenyl phenanthrenes, vinyl phenyl pyrenes, vinyl phenyl terphenyls, phenoxy styrenes, phenyl carbonyl styrenes, phenyl carboxy styrenes, phenoxy carbonyl styrenes, allyl naphthalenes, allyl anthracenes, allyl phenanthrenes, allyl pyrenes, allyl biphenyls, allyl terphenyls, allyl phenyl naphthalenes, allyl phenyl anthracenes, allyl phenyl phenanthrenes, allyl phenyl pyrenes, allyl phenyl terphenyls, allyl phenoxy benzenes, allyl(phenylcarbonyl)benzenes, allyl phenoxy benzenes, allyl(phenyl carbonyl)benzenes, allyl(phenylcarboxy)benzenes, and allyl(phenoxy carbonyl)benzenes.

Examples of preferred aryl-containing ene monomers include without limitation styrene, 2,5-dimethylstyrene, 2-(trifluoromethyl)styrene, 2-chlorostyrene, 3,4-dimethoxystyrene, 3-chlorostyrene, 3-bromostyrene, 3-vinylanisole, 3-methylstyrene, 4-bromostyrene, 4-tert-butylstyrene, 2,3,4,5,6-pentanfluorostyrene, 2,4-dimethylstyrene, 1-methoxy-4-vinylbenzene, 1-chloro-4-vinylbenzene, 1-methyl-4-vinylbenzene, 1-(chloromethyl)-4-vinylbenzene, 1-(bromomethyl)-4-vinylbenzene, 3-nitrostyrene, 1,2-vinyl phenyl benzene, 1,3-vinyl phenyl benzene, 1,4-vinyl phenyl benzene, 4-vinyl-1,1′-(4′-phenyl)biphenylene, 1-vinyl-4-(phenyloxy) benzene, 1-vinyl-3-(phenyloxy)benzene, 1-vinyl-2-(phenyloxy)benzene, 1-vinyl-4-(phenyl carbonyl)benzene, 1-vinyl-3-(phenylcarboxy)benzene, 1-vinyl-2-(phenoxycarbonyl)benzene, allyl phenyl ether, 2-biphenylylallyl ether, allyl 4-phenoxyphenyl ether, allyl 2,4,6-tribromophenyl ether, allyl phenyl carbonate, 1-allyloxy-2-trifluoromethylbenzene, allylbenzene, 1-phenyl-2-prop-2-enylbenzene, 4-phenyl-1-butene, 4-phenyl-1-butene-4-ol, 1-(4-methylphenyl)-3-buten-1-ol, 1-(4-chlorophenyl)-3-buten-1-ol, 4- allyltoluene, 1-allyl-4-fluorobenzene, 1-allyl-2-methylbenzene, 1-allyl-3-methylbenzene, 1-allyl-3-methylbenzene, 2-allylanisole, 4-allylanisole, 1-allyl-4-(trifluromethyl)benzene, allylpentafluorobenzene, 1-allyl-2-methoxybenzene, 4-allyl-1,2-dimethoxybenzene, 2-allylphenol, 2-allyl-6-methylphenol, 4-allyl-2-methoxyphenol, 2-allyloxyanisole, 4-allyl-2-methoxyphenyl acetate, 2-allyl-6-methoxyphenol, 1-allyl-2-bromobezene, alpha-vinylbenzyl alcohol, 1-phenyl-3-butene-1-one, allylbenzyl ether, (3-allyloxy)propyl)benzene, allyl phenylethyl ether, 1-benzyloxy-4-pentene, (1-allyloxy)ethyl)-benzene, 1-phenylallyl ethyl ether, (2-methyl-2-(2-propenyloxy)propyl)benzene, ((5-hexenyloxy)methyl)benzene, 1-allyloxy-4-propoxybenzene, 1-phenoxy-4-(3-prop-2-enoxypropoxy)benzene, 6-(4′-Hydroxyphenoxy)-1-Hexene, 4-but-3-enoxyphenol, 1-allyloxy-4-butoxybenzene, 1-allyloxy-4-ethoxybenzene, 1-allyl-4-benzyloxybenzene, 1-allyl-4-(phenoxy)benzene, 1-allyl-3-(phenoxy)benzene, 1-allyl-2-(phenoxy)benzene, 1-allyl-4-(phenyl carbonyl)benzene, 1-allyl-3-(phenyl carboxy)benzene, 1-allyl-2-(phenoxycarbonyl)benzene, 1,2-allyl phenyl benzene, 1,3-allyl phenyl benzene, 1,4-allyl phenyl benzene, 4-vinyl-1,1′-(4′-phenyl)biphenylene, 1-allyl-4-(phenyloxy)benzene, 1-allyl-3-(phenyloxy)benzene, 1-allyl-2-(phenyloxy)benzene, 1-allyl-4-(phenyl carbonyl)benzene, 1-allyl-3-(phenyl carboxy)benzene, and 1-allyl-2-(phenoxycarbonyl)benzene, 1-vinyl naphthylene, 2-vinyl naphthylene, 1-allyl naphthalene, 2-allyl naphthalene, allyl-2-naphthyl ether, 2-(2-methylprop-2-enyl)naphthalene, 2-prop-2-enylnaphthalene, 4-(2-naphthyl)-1-butene, 1-(3-butenyl)naphthalene, 1-allyl naphthalene, 2-allyl naphthalene, 1-allyl-4-napthyl naphthalene, 2-(allyloxy)-1-bromonaphthalene, 2-bromo-6-allyloxynaphthalene, 1,2-vinyl(1-naphthyl)benzene, 1,2-vinyl(2-naphthyl)benzene, 1,3-vinyl(1-naphthyl)benzene, 1,3-vinyl(2-naphthyl)benzene, 1,4-vinyl(1-naphthyl)benzene, 1,4-vinyl(2-naphthyl)benzene, 1-naphthyl-4-vinyl naphthalene, 1-allyl naphthalene, 2-allyl naphthalene, 1,2-allyl(1-naphthyl) benzene, 1,2-allyl(2-naphthyl)benzene, 1,3-allyl(1-naphthyl)benzene, 1,3-allyl(2-naphthyl)benzene, 1,4-allyl(1-naphthyl)benzene, 1,4-allyl(2-naphthyl)benzene, 1-allyl-4-napthyl naphthalene, 1-vinyl anthracene, 2-vinyl anthracene, 9-vinyl anthracene, 1-allyl anthracene, 2-allyl anthracene, 9-allyl anthracene, 9-pent-4-enylanthracene, 9-allyl-1,2,3,4-tetrachloroanthracene, 1-vinyl phenanthrene, 2-vinyl phenanthrene, 3-vinyl phenanthrene, 4-vinyl phenanthrene, 9-vinyl phenanthrene, 1-allyl phenanthrene, 2-allyl phenanthrene, 3-allyl phenanthrene, 4-allyl phenanthrene, 9-allyl phenanthrene, and combinations thereof.

Preferred aryl vinylic monomers are 2-phenylethyl acrylate; 3-phenylpropyl acrylate; 4-phenylbutyl acrylate; 5-phenylpentyl (meth)acrylate; 2-benzyloxyethyl (meth)acrylate; 3-benzyloxypropyl (meth)acrylate; 2-[2-(benzyloxy)ethoxy]ethyl (meth)acrylate; p-vinylphenyl-tris(trimethylsiloxy)silane; m-vinylphenyltris(trimethylsiloxy)silane; o-vinylphenyl-tris(trimethylsiloxy)silane; p-styrylethyltris(trimethylsiloxy)silane; m-styrylethyl-tris(trimethylsiloxy)silane; o-styrylethyltris(trimethylsiloxy)silane; or combinations thereof. Most preferred are p-vinylphenyltris(trimethylsiloxy)silane; m-vinylphenyltris(trimethylsiloxy)silane; o-vinylphenyltris(trimethylsiloxy)silane; p-styrylethyltris(trimethylsiloxy)silane; m-styrylethyl-tris(trimethylsiloxy)silane; o-styrylethyltris(trimethylsiloxy)silane; or combinations thereof.

Any aryl vinylic crosslinkers can be used. Examples of aryl vinylic crosslinkers include without limitation non-silicone aryl vinylic crosslinkers (e.g., divinylbenzene, 2-methyl-1,4-divinylbenzene, bis(4-vinylphenyl)methane, 1,2-bis(4-vinylphenyl)ethane, etc.), silicone-containing aryl vinylic crosslinkers.

Preferred silicone-containing aryl vinylic crosslinkers are aryl-containing polysiloxane vinylic crosslinkers each of which comprises: (1) a polydiorganosiloxane segment comprising dimethylsiloxane units and aryl-containing siloxane units each having at least one aryl-containing substituent having up to 45 carbon atoms; and (2) ethylenically-unsaturated groups (preferably (meth)acryloyl groups). In a preferred embodiment, the polydiorganosiloxane segment comprises at least 25% by mole of the aryl-containing siloxane units. The preferred aryl-containing polysiloxane vinylic crosslinkers can have a number average molecular weight of at least 1000 Daltons (preferably from 1500 Daltons to 100000 Daltons, more preferably from 2000 to 80000 Daltons, even more preferably from 2500 to 60000 Dalton).

Examples of such preferred aryl-containing polysiloxane vinylic crosslinkers include without limitation vinyl terminated polyphenylmethysiloxanes (e.g., PMV9925 from Gelest), vinylphenylmethyl terminated phenylmethyl-vinylphenylsiloxane copolymer (e.g., PVV-3522 from Gelest), vinyl terminated diphenylsiloxane-dimethylsiloxane copolymers (e.g., PDV-1625 from Gelest), (meth)acryloxyalkyl-terminated polyphenylmethysiloxanes, (meth)acryloxyalkyl-terminated phenylmethyl-vinylphenylsiloxane copolymers, (meth)acryloxyalkyl-terminated diphenylsiloxane-dimethylsiloxane copolymers, ethylenically-unsaturated group-terminated dimethylsiloxane-arylmethylsiloxane copolymers disclosed in U.S. Pat. Appl. Pub. No. 2022/00306810, or combinations thereof.

An insert-forming composition can further comprises one or more hydrophobic acrylic monomers free of aryl group (e.g., silicone-containing acrylic monomers, non-silicone hydrophobic acrylic monomers, vinyl alkanoates, vinyloxyalkanes, or combinations thereof), vinylic crosslinkers free of aryl group (e.g., acrylic crosslinking agents (crosslinkers) as described below, allyl methacrylate, allyl acrylate, triallyl isocyanurate, 2,4,6-triallyloxy-1,3,5-triazine, 1,2,4-trivinylcyclohexane, or combinations thereof), at least one UV-absorbing vinylic monomer (any one of those described later in this application), at least one UV/HEVL-absorbing vinylic monomer (any one of those described later in this application), at least one photochromic vinylic monomer (any one of those described later in this application), or combinations thereof.

Examples of silicone-containing acrylic monomers free of aryl group can be any one of those described below in this application; examples of non-silicone hydrophobic acrylic monomers free of aryl group can be any one of those described below in this application.

Examples of acrylic crosslinkers free of aryl group include without limitation ethylene glycol di-(meth)methacrylate; 1,3-propanediol di-(meth)acrylate; 2,3-propanediol diacrylate; 2,3-propanediol di-(meth)acrylate; 1,4-butanediol di-(meth)acrylate; 1,5-pentanediol di-(meth)acrylate; 1,6-hexanediol di-(meth)acrylate; diethylene glycol di-(meth)acrylate; triethylene glycol di-(meth)acrylate; tetraethylene glycol di-(meth)acrylate; glycerol 1,3-diglycerolate di-(meth)acrylate, ethylenebis[oxy(2-hydroxypropane-1,3-diyl)] di-(meth)acrylate, bis[2-(meth)acryloxyethyl] phosphate, trimethylolpropane di-(meth)acrylate, 3,4-bis[(meth)acryloyl]tetrahydrofuan, diacrylamide, dimethacrylamide, N,N-di(meth)acryloyl-N-methylamine, N,N-di(meth)acryloyl-N-ethylamine, N,N′-methylene bis(acrylamide); N,N′-methylene bis(methacrylamide); N,N′-ethylene bis(acrylamide); N,N′-ethylene bis(methacrylamide); N,N′-hexamethylene bisacrylamide; N,N′-hexamethylene bismethacrylamide; N,N′-dihydroxyethylene bis(meth)acrylamide, N,N′-propylene bis(meth)acrylamide, N,N′-2-hydroxypropylene bis(meth)acrylamide, N,N′-2,3-dihydroxybutylene bis(meth)acrylamide, 1,3-bis(meth)acrylamidepropane-2-yl dihydrogen phosphate, piperazine diacrylamide, pentaerythritol triacrylate, pentaerythritol trimethacrylate, trimethyloylpropane triacrylate, trimethyloylpropane trimethacrylate, tris(2-hydroxyethyl)isocyanurate triacrylate, tris(2-hydroxyethyl)isocyanurate trimethacrylate, 1,3,5-triacryloxylhexahydro-1,3,5-triazine, 1,3,5-trimethacryloxylhexahydro-1,3,5-triazine; pentaerythritol tetraacrylate, pentaerythritol tetramethacrylate, di(trimethyloylpropane) tetraacrylate, di(trimethyloylpropane) tetramethacrylate, or combinations thereof.

In a preferred embodiment, the polymerizable composition for forming hydrophobic insert comprises at least one acrylic crosslinking agent (any one of those described above).

An insert-forming composition can be prepared by mixing all polymerizable materials as described above in the desired proportions, together with one or more polymerization initiators (thermal polymerization initiators or photoinitiators) in the presence or preferably in the absence of a non-reactive organic solvent (i.e., a non-reactive diluent) as described later in this application.

Any thermal polymerization initiators can be used in the invention. Suitable thermal polymerization initiators are known to the skilled artisan and comprise, for example peroxides, hydroperoxides, azo-bis(alkyl- or cycloalkylnitriles), persulfates, percarbonates, or mixtures thereof. Examples of preferred thermal polymerization initiators include without limitation benzoyl peroxide, t-butyl peroxide, t-amyl peroxybenzoate, 2,2-bis(tert-butylperoxy)butane, 1,1-bis(tert-butylperoxy)cyclohexane, 2,5-Bis(tert-butylperoxy)-2,5- dimethylhexane, 2,5-bis(tert-butylperoxy)-2,5-dimethyl-3-hexyne, bis(1-(tert-butylperoxy)-1-methylethyl)benzene, 1,1-bis(tert-butylperoxy)-3,3,5-trimethylcyclohexane, di-t-butyl-diperoxyphthalate, t-butyl hydro-peroxide, t-butyl peracetate, t-butyl peroxybenzoate, t-butylperoxy isopropyl carbonate, acetyl peroxide, lauroyl peroxide, decanoyl peroxide, dicetyl peroxydicarbonate, di(4-t-butylcyclohexyl)peroxy dicarbonate (Perkadox 16S), di(2-ethylhexyl)peroxy dicarbonate, t-butylperoxy pivalate (Lupersol 11); t-butylperoxy-2-ethylhexanoate (Trigonox 21-C50), 2,4-pentanedione peroxide, dicumyl peroxide, peracetic acid, potassium persulfate, sodium persulfate, ammonium persulfate, 2,2′-azobis(4-methoxy-2,4-dimethylvaleronitrile) (VAZO 33), 2,2′-Azobis[2-(2-imidazolin-2-yl)propane]dihydrochloride (VAZO 44), 2,2′-azobis(2-amidinopropane) dihydrochloride (VAZO 50), 2,2′-azobis(2,4-dimethylvaleronitrile) (VAZO 52), 2,2′-azobis(isobutyronitrile) (VAZO 64 or AIBN), 2,2′-azobis-2-methylbutyronitrile (VAZO 67), 1,1-azobis(1-cyclohexanecarbonitrile) (VAZO 88); 2,2′-azobis(2-cyclopropylpropionitrile), 2,2′-azobis(methylisobutyrate), 4,4′-Azobis(4-cyanovaleric acid), and combinations thereof. Preferably, the thermal initiator is 2,2′-azobis(isobutyronitrile) (AIBN or VAZO 64).

Suitable photoinitiators are benzoin methyl ether, diethoxyacetophenone, a benzoylphosphine oxide, 1-hydroxycyclohexyl phenyl ketone and Darocur and Irgacur types, preferably Darocur 1173@ and Darocur 2959@, Germanium-based Norrish Type I photoinitiators (e.g., those described in U.S. Pat. No. 7,605,190). Examples of benzoylphosphine initiators include 2,4,6-trimethylbenzoyldiphenylophosphine oxide; bis-(2,6-dichlorobenzoyl)-4-N-propylphenylphosphine oxide; and bis-(2,6-dichlorobenzoyl)-4-N-butylphenylphosphine oxide. Reactive photoinitiators which can be incorporated, for example, into a macromer or can be used as a special monomer are also suitable. Examples of reactive photoinitiators are those disclosed in EP 632 329.

In accordance with the invention, the lens-forming composition is a hydrogel lens-forming composition, preferably a silicone hydrogel (SiHy) lens-forming composition.

In a preferred embodiment, the lens-forming composition is a non-silicone hydrogel lens-forming composition (or non-silicone hydrogel lens formulation) which is either (1) a monomeric reaction composition comprising (a) at least one hydrophilic vinylic monomer (e.g., hydroxyl-containing vinylic monomer, N-vinylpyrrolidone, or combinations thereof) and (b) at least one component selected from the group consisting of a vinylic crosslinker, a hydrophobic vinylic monomer, a free-radical initiator (photoinitiator or thermal initiator), a UV-absorbing vinylic monomer, a high-energy-violet-light (“HEVL”) absorbing vinylic monomer, a visibility tinting agent, and combinations thereof; or (2) an aqueous solution comprising one or more water-soluble prepolymers and at least one component selected from the group consisting of hydrophilic vinylic monomer, a crosslinking agent, a hydrophobic vinylic monomer, a lubricating agent (or so-called internal wetting agents incorporated in a lens formulation), a free-radical initiator (photoinitiator or thermal initiator), a UV-absorbing vinylic monomer, a HEVL absorbing vinylic monomer, a visibility tinting agent, and combinations thereof.

Examples of water-soluble prepolymers include without limitation: a water-soluble crosslinkable poly(vinyl alcohol) prepolymer described in U.S. Pat. Nos. 5,583,163 and 6,303,687; a water-soluble vinyl group-terminated polyurethane prepolymer described in U.S. Pat. No. 6,995,192; derivatives of a polyvinyl alcohol, polyethyleneimine or polyvinylamine, which are disclosed in U.S. Pat. No. 5,849,841; a water-soluble crosslinkable polyurea prepolymer described in U.S. Pat. Nos. 6,479,587 and 7,977,430; crosslinkable polyacrylamide; crosslinkable statistical copolymers of vinyl lactam, MMA and a comonomer, which are disclosed in U.S. Pat. No. 5,712,356; crosslinkable copolymers of vinyl lactam, vinyl acetate and vinyl alcohol, which are disclosed in U.S. Pat. No. 5,665,840; polyether-polyester copolymers with crosslinkable side chains which are disclosed in U.S. Pat. No. 6,492,478; branched polyalkylene glycol-urethane prepolymers disclosed in U.S. Pat. No. 6,165,408; polyalkylene glycol-tetra(meth)acrylate prepolymers disclosed in U.S. Pat. No. 6,221,303; crosslinkable polyallylamine gluconolactone prepolymers disclosed in U.S. Pat. No. 6,472,489.

Numerous non-silicone hydrogel lens formulations have been described in numerous patents and patent applications published by the filing date of this application and have been used in producing commercial non-silicone hydrogel contact lenses. Examples of commercial non-silicone hydrogel contact lenses include, without limitation, alfafilcon A, acofilcon A, deltafilcon A, etafilcon A, focofilcon A, helfilcon A, helfilcon B, hilafilcon B, hioxifilcon A, hioxifilcon B, hioxifilcon D, methafilcon A, methafilcon B, nelfilcon A, nesofilcon A, ocufilcon A, ocufilcon B, ocufilcon C, ocufilcon D, omafilcon A, phemfilcon A, polymacon, samfilcon A, telfilcon A, tetrafilcon A, and vifilcon A. They can be used in the invention.

Preferably, non-silicone hydrogel lens-forming composition comprises at least 50% by mole of at least one hydroxyl-containing vinylic monomer, preferably selected from the group consisting of hydroxyethyl (meth)acrylate, glycerol (meth)acrylate, 3-hydroxypropyl (meth)acrylate, 2-hydroxypropyl (meth)acrylate, 3-amino-2-hydroxypropyl (meth)acrylate, N-2-hydroxyethyl (meth)acrylamide, N-3-hydroxypropyl (meth)acrylamide, N-2-hydroxypropyl (meth)acrylamide, N-2,3-dihydroxypropyl (meth)acrylamide, N-tris(hydroxymethyl)methyl (meth)acrylamide, vinyl alcohol, allyl alcohol, and combinations thereof, more preferably selected from the group consisting of hydroxyethyl (meth)acrylate, glycerol (meth)acrylate, and vinyl alcohol.

In another preferred embodiment, a lens-forming composition is a SiHy lens-forming composition (i.e. a SiHy lens formulation). Numerous SiHy lens formulations have been described in numerous patents and patent applications published by the filing date of this application and have been used in producing commercial SiHy contact lenses. Examples of commercial SiHy contact lenses include, without limitation, asmofilcon A, balafilcon A, comfilcon A, delefilcon A, efrofilcon A, enfilcon A, fanfilcon A, galyfilcon A, lotrafilcon A, lotrafilcon B, narafilcon A, narafilcon B, senofilcon A, senofilcon B, senofilcon C, smafilcon A, somofilcon A, and stenfilcon A. They can be used as a lens-forming composition of the invention.

Preferably, a SiHy lens-forming composition comprises (a) at least one silicone-containing vinylic monomer and/or at least one polysiloxane vinylic crosslinker, (b) at least one hydrophilic vinylic monomer, (c) at least one free-radical initiator, (d) at least one component selected from the group consisting of at least one non-silicone vinylic crosslinker, at least one UV-absorbing vinylic monomer, at least one HEVL-absorbing vinylic monomer, a visibility tinting agent, and combinations thereof.

In accordance with the invention, a silicone-containing (or siloxane-containing) vinylic monomer can be any silicone-containing vinylic monomer known to a person skilled in the art. Examples of preferred silicone-containing vinylic monomers include without limitation vinylic monomers each having a bis(trialkylsilyloxy)alkylsilyl group (preferably a bis(trimethylsilyloxy)alkylsilyl group) or a tris(trialkylsilyloxy)silyl group (preferably a tris(trimethylsilyloxy)silyl group), polysiloxane vinylic monomers, 3-methacryloxy propylpentamethyldisiloxane, t-butyldimethyl-siloxyethyl vinyl carbonate, trimethylsilylethyl vinyl carbonate, and trimethylsilylmethyl vinyl carbonate, and combinations thereof.

Examples of preferred siloxane-containing vinylic monomers each having a bis(trialkylsilyloxy)alkylsilyl group or a tris(trialkylsilyloxy)silyl group include without limitation tris(trimethylsilyloxy)-silylpropyl (meth)acrylate, [3-(meth)acryloxy-2-hydroxypropyloxy]propyl-bis(trimethylsiloxy)-methylsilane, [3-(meth)acryloxy-2-hydroxypropyloxy]propylbis(trimethyl-siloxy)butylsilane, 3-(meth)acryloxy-2-(2-hydroxyethoxy)-propyloxy)propyl-bis(trimethylsiloxy)-methylsilane, 3-(meth)acryloxy-2-hydroxypropyloxy)propyltris(trimethylsiloxy) silane, N-[tris(trimethylsiloxy)silylpropyl]-(meth)acrylamide, N-(2-hydroxy-3-(3-(bis(trimethylsilyloxy)-methylsilyl)propyloxy)-propyl)-2-methyl (meth)acrylamide, N-(2-hydroxy-3-(3-(bis(trimethyl-silyloxy)methylsilyl)propyloxy)propyl)-(meth)acrylamide, N-(2-hydroxy-3-(3-(tris(trimethyl-silyloxy)silyl)propyloxy)-propyl)-2-methyl acrylamide, N-(2-hydroxy-3-(3-(tris(trimethylsilyloxy)-silyl)propyloxy)propyl) (meth)acrylamide, N-[tris(dimethylpropylsiloxy)-silylpropyl]-(meth)acrylamide, N-[tris(dimethylphenylsiloxy)silylpropyl] (meth)acrylamide, N-[tris(dimethyl-ethylsiloxy)silylpropyl] (meth)acrylamide, N,N-bis[2-hydroxy-3-(3-(bis(trimethylsilyloxy)-methylsilyl)propyloxy)propyl]-2-methyl (meth)acrylamide, N,N-bis[2-hydroxy-3-(3-(bis(trimethyl-silyloxy)methylsilyl)propyloxy)-propyl] (meth)acrylamide, N,N-bis[2-hydroxy-3-(3-(tris(trimethyl-silyloxy)silyl)propyloxy)propyl]-2-methyl (meth)acrylamide, N,N-bis[2-hydroxy-3-(3-(tris(trimethyl-silyloxy)silyl)propyloxy)propyl] (meth)acrylamide, N-[2-hydroxy-3-(3-(t-butyldimethylsilyl)-propyloxy)propyl]-2-methyl (meth)acrylamide, N-[2-hydroxy-3-(3-(t-butyldimethylsilyl)propyloxy)-propyl] (meth)acrylamide, N,N-bis[2-hydroxy-3-(3-(t-butyldimethylsilyl)propyloxy)propyl]-2-methyl (meth)acrylamide, N-2-(meth)acryloxyethyl-O-(methyl-bis-trimethylsiloxy-3-propyl)silyl carbamate, 3-(trimethylsilyl)propylvinyl carbonate, 3-(vinyloxycarbonylthio)propyl-tris(trimethyl-siloxy)silane, 3-[tris(trimethylsiloxy)silyl]propylvinyl carbamate, 3-[tris(trimethylsiloxy)silyl] propyl allyl carbamate, 3-[tris(trimethylsiloxy)silyl]propyl vinyl carbonate, those disclosed in U.S. Pat. Nos. 9,097,840, 9,103,965 and 9,475,827 (herein incorporated by references in their entireties), and mixtures thereof. The above preferred silicone-containing vinylic monomers can be obtained from commercial suppliers or can be prepared according to procedures described in U.S. Pat. Nos. 5,070,215, 6,166,236, 6,867,245, 7,214,809, 8,415,405, 8,475,529, 8,614,261, 8,658,748, 9,097,840, 9,103,965, 9,217,813, 9,315,669, and 9,475,827.

Examples of preferred polysiloxane vinylic monomers include without limitation mono-(meth)acryloyl-terminated, monoalkyl-terminated polysiloxanes of formula (1) include without limitation α-(meth)acryloxypropyl terminated ω-butyl (or ω-methyl) terminated polydimethylsiloxane, α-(meth)acryloxy-2-hydroxypropyloxypropyl terminated ω-butyl (or ω-methyl) terminated polydimethylsiloxane, α-(2-hydroxyl-methacryloxypropyloxypropyl)-w-butyl-decamethylpentasiloxane, α-[3-(meth)acryloxyethoxy-2-hydroxypropyloxypropyl]-terminated ω-butyl (or ω-methyl) terminated polydimethylsiloxane, α-[3-(meth)acryloxy-propyloxy-2-hydroxypropyloxypropyl]-terminated ω-butyl (or ω-methyl) terminated polydimethylsiloxane, α-[3-(meth)acryloxyisopropyloxy-2-hydroxypropyloxypropyl]-terminated ω-butyl (or ω-methyl) terminated polydimethylsiloxane, α-[3-(meth)acryloxybutyloxy-2-hydroxypropyloxypropyl]-terminated ω-butyl (or ω-methyl) terminated polydimethylsiloxane, α-[3-(meth)acryloxy-ethylamino-2-hydroxypropyloxypropyl]-terminated ω-butyl (or ω-methyl) terminated polydimethylsiloxane, α-[3-(meth)acryloxypropylamino-2-hydroxypropyloxypropyl]-terminated ω-butyl (or ω-methyl) terminated polydimethylsiloxane, α-[3-(meth)acryloxy-butylamino-2-hydroxypropyloxypropyl]-terminated ω-butyl (or ω-methyl) terminated polydimethylsiloxane, α-(meth)acryloxy(polyethylenoxy)-2-hydroxypropyloxypropyl]-terminated ω-butyl (or ω-methyl) terminated polydimethylsiloxane, α-[(meth)acryloxy-2-hydroxypropyloxy-ethoxypropyl]-terminated ω-butyl (or ω-methyl) terminated polydimethylsiloxane, α-[(meth)acryloxy-2-hydroxypropyl-N-ethylaminopropyl]-terminated ω-butyl (or ω-methyl) terminated polydimethylsiloxane, α-[(meth)acryloxy-2-hydroxypropyl-aminopropyl]-terminated ω-butyl (or ω-methyl) terminated polydimethylsiloxane, α-[(meth)acryloxy-2-hydroxypropyloxy-(polyethylenoxy)propyl]-terminated ω-butyl (or ω-methyl) terminated polydimethylsiloxane, α-(meth)acryloylamidopropyloxypropyl terminated ω-butyl (or ω-methyl) terminated polydimethylsiloxane, α-N-methyl-(meth)acryloylamidopropyloxypropyl terminated ω-butyl (or ω-methyl) terminated polydimethylsiloxane, α-[3-(meth)acrylamidoethoxy-2-hydroxypropyloxypropyl]-terminated ω-butyl (or ω-methyl) polydimethylsiloxane, α-[3-(meth)acrylamido-propyloxy-2-hydroxypropyloxypropyl]-terminated ω-butyl (or ω-methyl) terminated polydimethylsiloxane, α-[3-(meth)acrylamidoisopropyloxy-2-hydroxypropyloxypropyl]-terminated ω-butyl (or ω-methyl) terminated polydimethylsiloxane, α-[3-(meth)acrylamido-butyloxy-2-hydroxypropyloxypropyl]-terminated ω-butyl (or ω-methyl) terminated polydimethylsiloxane, α-[3-(meth)acryloylamido-2-hydroxypropyloxypropyl] terminated ω-butyl (or ω-methyl) polydimethylsiloxane, α-[3-[N-methyl-(meth)acryloylamido]-2-hydroxypropyloxy-propyl]terminated ω-butyl (or ω-methyl) terminated polydimethylsiloxane, N-methyl-N′-(propyltetra(dimethylsiloxy)dimethylbutylsilane) (meth)acrylamide, N-(2,3-dihydroxypropane)-N′-(propyltetra(dimethylsiloxy)dimethylbutylsilane) (meth)acrylamide, (meth)acryloylamido-propyltetra(dimethylsiloxy)dimethylbutylsilane, mono-vinyl carbonate-terminated mono-alkyl-terminated polydimethylsiloxanes, mono-vinyl carbamate-terminated mono-alkyl-terminated polydimethylsiloxane, those disclosed in U.S. Pat. Nos. 9,097,840 and 9,103,965, and mixtures thereof. The above preferred polysiloxanes vinylic monomers can be obtained from commercial suppliers (e.g., Shin-Etsu, Gelest, etc.) or prepared according to procedures described in patents, e.g., U.S. Pat. Appl. Pub. Nos. 6,166,236, 6,867,245, 8,415,405, 8,475,529, 8,614,261, 9,217,813, and 9,315,669, or by reacting a hydroxyalkyl (meth)acrylate or (meth)acrylamide or a (meth)acryloxypolyethylene glycol with a mono-epoxypropyloxypropyl-terminated polydimethylsiloxane, by reacting glycidyl (meth)acrylate with a mono-carbinol-terminated polydimethylsiloxane, a mono-aminopropyl-terminated polydimethylsiloxane, or a mono-ethylaminopropyl-terminated polydimethylsiloxane, or by reacting isocyanatoethyl (meth)acrylate with a mono-carbinol-terminated polydimethylsiloxane according to coupling reactions well known to a person skilled in the art.

In accordance with the invention, any polysiloxane vinylic crosslinkers can be used in this invention. Examples of preferred polysiloxane vinylic crosslinkers include without limitation α,ω-(meth)acryloxy-terminated polydimethylsiloxanes of various molecular weight; α,ω-(meth)acrylamido-terminated polydimethylsiloxanes of various molecular weight; α,ω-vinyl carbonate-terminated polydimethylsiloxanes of various molecular weight; α,ω-vinyl carbamate-terminated polydimethylsiloxane of various molecular weight; bis-3-methacryloxy-2-hydroxypropyloxypropyl polydimethylsiloxane of various molecular weight; N,N,N′,N′-tetrakis(3-methacryloxy-2-hydroxypropyl)-alpha,omega-bis-3-aminopropyl-polydimethylsiloxane of various molecular weight; the reaction products of glycidyl methacrylate with di-amino-terminated polydimethylsiloxanes; the reaction products of glycidyl methacrylate with di-hydroxyl-terminated polydimethylsiloxanes; the reaction products of an azlactone-containing vinylic monomer (any one of those described above) with di-hydroxyl-terminated polydimethylsiloxanes; the reaction products of isocyantoethyl (meth)acrylate with di-hydroxyl-terminated polydimethylsiloxanes; the reaction products of isocyantoethyl (meth)acrylate with di-amino-terminated polydimethylsiloxanes; polysiloxane-containing macromer selected from the group consisting of Macromer A, Macromer B, Macromer C, and Macromer D described in U.S. Pat. No. 5,760,100; polysiloxane vinylic crosslinkers disclosed in U.S. Pat. Nos. 4,136,250, 4,153,641, 4,182,822, 4,189,546, 4,259,467, 4,260,725, 4,261,875, 4,343,927, 4,254,248, 4,355,147, 4,276,402, 4,327,203, 4,341,889, 4,486,577, 4,543,398, 4,605,712, 4,661,575, 4,684,538, 4,703,097, 4,833,218, 4,837,289, 4,954,586, 4,954,587, 5,010,141, 5,034,461, 5,070,170, 5,079,319, 5,039,761, 5,346,946, 5,358,995, 5,387,632, 5,416,132, 5,449,729, 5,451,617, 5,486,579, 5,962,548, 5,981,675, 6,039,913, 6,762,264, 7,423,074, 8,163,206, 8,480,227, 8,529,057, 8,835,525, 8,993,651, 9,187,601, 10,081,697, 10,301,451, and 10,465,047.

One class of preferred polysiloxane vinylic crosslinkers are vinylic crosslinkers which are prepared by: reacting glycidyl (meth)acrylate or (meth)acryloyl chloride with a di-amino-terminated polydimethylsiloxane or a di-hydroxyl-terminated polydimethylsiloxane; reacting isocyantoethyl (meth)acrylate with di-hydroxyl-terminated polydimethylsiloxanes; reacting an amino-containing acrylic monomer with di-carboxyl-terminated polydimethylsiloxane in the presence of a coupling agent (a carbodiimide); reacting a carboxyl-containing acrylic monomer with di-amino-terminated polydimethylsiloxane in the presence of a coupling agent (a carbodiimide); or reacting a hydroxyl-containing acrylic monomer with a di-hydroxy-terminated polydisiloxane in the presence of a diisocyanate or di-epoxy coupling agent.

Examples of such preferred polysiloxane vinylic crosslinkers are α,ω-bis[3-(meth)acrylamidopropyl]-terminated polydimethylsiloxane, α,ω-bis[3-(meth)acryloxypropyl]-terminated polydimethylsiloxane, α,ω-bis[3-(meth)acryloxy-2-hydroxypropyloxypropyl]-terminated polydimethylsiloxane, α,ω-bis[3-(meth)acryloxyethoxy-2-hydroxypropyloxypropyl]-terminated polydimethylsiloxane, α,ω-bis[3-(meth)acryloxypropyloxy-2-hydroxypropyloxypropyl]-terminated polydimethylsiloxane, α,ω-bis[3-(meth)acryloxy-isopropyloxy-2-hydroxypropyloxy-propyl]-terminated polydimethylsiloxane, α,ω-bis[3-(meth)acryloxybutyloxy-2-hydroxypropyloxy-propyl]-terminated polydimethylsiloxane, α,ω-bis[3-(meth)acrylamidoethoxy-2-hydroxypropyloxy-propyl]-terminated polydimethylsiloxane, α,ω-bis[3-(meth)acrylamidopropyloxy-2-hydroxypropyloxypropyl]-terminated polydimethylsiloxane, α,ω-bis[3-(meth)acrylamidoisopropyloxy-2-hydroxypropyloxypropyl]-terminated polydimethylsiloxane, α,ω-bis[3-(meth)acrylamidobutyloxy-2-hydroxypropyloxypropyl]-terminated polydimethylsiloxane, α,ω-bis[3-(meth)acryloxyethyl-amino-2-hydroxypropyloxypropyl]-terminated polydimethylsiloxane, α,ω-bis[3-(meth)acryloxy-propylamino-2-hydroxypropyloxypropyl]-terminated polydimethylsiloxane, α,ω-bis[3-(meth)acryloxybutylamino-2-hydroxypropyloxypropyl]-terminated polydimethylsiloxane, α,ω-bis[(meth)acrylamidoethylamino-2-hydroxypropyloxy-propyl]-terminated polydimethylsiloxane, α,ω-bis[3-(meth)acrylamidopropylamino-2-hydroxypropyloxypropyl]-terminated polydimethylsiloxane, α,ω-bis[3-(meth)acrylamide-butylamino-2-hydroxypropyloxypropyl]-terminated polydimethylsiloxane, α,ω-bis[(meth)acryloxy-2-hydroxypropyloxy-ethoxypropyl]-terminated polydimethylsiloxane, α,ω-bis[(meth)acryloxy-2-hydroxypropyl-N-ethylaminopropyl]-terminated polydimethylsiloxane, α,ω-bis[(meth)acryloxy-2-hydroxypropyl-aminopropyl]-polydimethylsiloxane, α,ω-bis[(meth)acryloxy-2-hydroxypropyloxy-(polyethylenoxy)propyl]-terminated polydimethylsiloxane, α,ω-bis[(meth)acryloxyethylamino-carbonyloxy-ethoxypropyl]-terminated polydimethylsiloxane, α,ω-bis[(meth)acryloxyethylamino-carbonyloxy-(polyethylenoxy)propyl]-terminated polydimethylsiloxane, and combinations thereof.

Another class of preferred polysiloxane vinylic crosslinkers are chain-extended polysiloxane vinylic crosslinkers each of which comprises at least two polysiloxane segments and can be prepared according to the procedures described in U.S. Pat. Nos. 5,034,461, 5,416,132, 5,449,729, 5,760,100, 7,423,074, 8,529,057, 8,835,525, 8,993,651, and 10,301,451 and in U.S. Pat. App. Pub. No. 2018-0100038 A1.

A further class of preferred polysiloxane vinylic crosslinkers are hydrophilized polysiloxane vinylic crosslinkers that each comprise at least about 1.50 (preferably at least about 2.0, more preferably at least about 2.5, even more preferably at least about 3.0) milliequivalent/gram (“meq/g”) of hydrophilic moieties, which preferably are hydroxyl groups (—OH), carboxyl groups (—COOH), amino groups (—NHR_{N1} in which R_{N1} is H or C₁-C₂ alkyl), amide moieties (—CO—NR_{N1}R_{N2} in which R_{N1} is H or C₁-C₂ alkyl and R_{N2} is a covalent bond, H, or C₁-C₂ alkyl), N—C₁-C₃ acylamino groups, urethane moieties (—NH—CO—O—), urea moieties (—NH—CO—NH—), a polyethylene glycol chain of

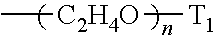

in which n is an integer of 2 to 20 and T₁ is H, methyl or acetyl or a phosphorylcholin group, or combinations thereof.

Examples of such preferred hydrophilized polysiloxane vinylic crosslinkers are those compounds of formula (1)

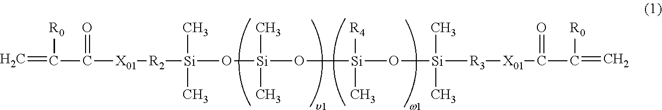

in which:
υ1 is an integer of from 30 to 500 and ω is an integer of from 1 to 75, provided that ω1/υ1 is from about 0.035 to about 0.15 (preferably from about 0.040 to about 0.12, even more preferably from about 0.045 to about 0.10);
X₀₁ is O or NRₙ in which Rₙ is hydrogen or C₁-C₁₀-alkyl;
Rₒ is hydrogen or methyl;
R₂ and R₃ independently of each other are a substituted or unsubstituted C₁-C₁₀ alkylene divalent radical or a divalent radical of —R₅—O—R₆— in which R₅ and R₆ independently of each other are a substituted or unsubstituted C₁-C₁₀ alkylene divalent radical;
R₄ is a monovalent radical of any one of formula (2) to (7)

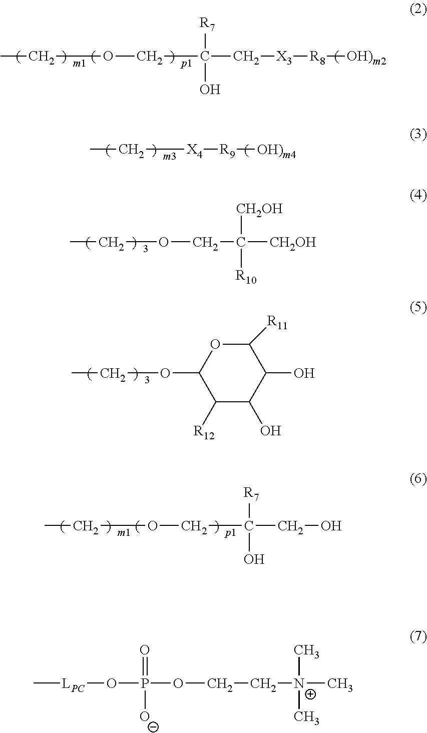

p1 is zero or 1; m1 is an integer of 2 to 4; m2 is an integer of 1 to 5; m3 is an integer of 3 to 6; m4 is an integer of 2 to 5;
R₇ is hydrogen or methyl;
R₈ is a C₂-C₆ hydrocarbon radical having (m2+1) valencies;
R₉ is a C₂-C₆ hydrocarbon radical having (m4+1) valencies;
R₁₀ is ethyl or hydroxymethyl;
R₁₁ is methyl or hydromethyl;
R₁₂ is hydroxyl or methoxy;
X₃ is a sulfur linkage of —S— or a teriary amino linkage of —NR₁₃— in which R₁₃ is C₁-C₁ alkyl, hydroxyethyl, hydroxypropyl, or 2,3-dihydroxypropyl;
X₄ is an amide linkage of

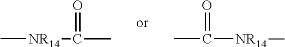

in which R₁₄ is hydrogen or C₁-C₁₀ alkyl;
L_{PC} is a divalent radical of —CH₂—CHR₀—R₁₅—, —C₃H₆—O—R₁₆—

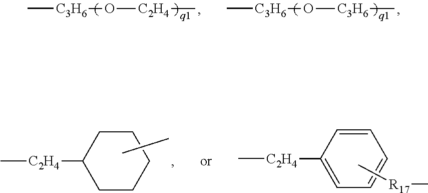

in which q1 is an integer of 1 to 20, R₁₅ is a linear or branched C₁-C₁₀alkylene divalent radical, R₁₆ is a linear or branched C₃-C₁₀ alkylene divalent radical, and R₁₇ is a direct bond or a linear or branched C₁-C₄ alkylene divalent radical.

Hydrophilized polysiloxane vinylic crosslinker of formula (1) can be prepared according to the procedures disclosed in U.S. patent Ser. No. 10/081,697 and U.S. Pat. Appl. Pub. No. 2022/0251302 A1.

Any hydrophilic vinylic monomers can be used in the invention. Examples of preferred hydrophilic vinylic monomers are alkyl (meth)acrylamides (as described later in this application), hydroxyl-containing acrylic monomers (as described below), amino-containing acrylic monomers (as described later in this application), carboxyl-containing acrylic monomers (as described later in this application), N-vinyl amide monomers (as described later in this application), methylene-containing pyrrolidone monomers (i.e., pyrrolidone derivatives each having a methylene group connected to the pyrrolidone ring at 3- or 5-position) (as described later in this application), acrylic monomers having a C₁-C₄ alkoxyethoxy group (as described later in this application), vinyl ether monomers (as described later in this application), allyl ether monomers (as described later in this application), phosphorylcholine-containing vinylic monomers (as described later in this application), N-2-hydroxyethyl vinyl carbamate, N-carboxyvinyl-β-alanine (VINAL), N-carboxyvinyl-α-alanine, and combinations thereof.

Examples of alkyl (meth)acrylamides include without limitation (meth)acrylamide, N,N-dimethyl (meth)acrylamide, N-ethyl (meth)acrylamide, N,N-diethyl (meth)acrylamide, N-propyl (meth)acrylamide, N-isopropyl (meth)acrylamide, N-3-methoxypropyl (meth)acrylamide, and combinations thereof.

Examples of hydroxyl-containing acrylic monomers include without limitation N-2-hydroxylethyl (meth)acrylamide, N,N-bis(hydroxyethyl) (meth)acrylamide, N-3-hydroxypropyl (meth)acrylamide, N-2-hydroxypropyl (meth)acrylamide, N-2,3-dihydroxypropyl (meth)acrylamide, N-tris(hydroxymethyl)methyl (meth)acrylamide, 2-hydroxyethyl (meth)acrylate, 3-hydroxypropyl (meth)acrylate, 2-hydroxypropyl (meth)acrylate, glycerol methacrylate (GMA), di(ethylene glycol) (meth)acrylate, tri(ethylene glycol) (meth)acrylate, tetra(ethylene glycol) (meth)acrylate, poly(ethylene glycol) (meth)acrylate having a number average molecular weight of up to 1500, poly(ethylene glycol)ethyl (meth)acrylamide having a number average molecular weight of up to 1500, and combinations thereof.

Examples of carboxyl-containing acrylic monomers include without limitation 2-(meth)acrylamidoglycolic acid, (meth)acrylic acid, ethylacrylic acid, 3-(meth)acrylamidopropionic acid, 5-(meth)acrylamidopentanoic acid, 4-(meth)acrylamidobutanoic acid, 3-(meth)acrylamido-2-methylbutanoic acid, 3-(meth)acrylamido-3-methylbutanoic acid, 2-(meth)acrylamido-2methyl-3,3-dimethyl butanoic acid, 3-(meth)acrylamidohaxanoic acid, 4-(meth)acrylamido-3,3-dimethylhexanoic acid, and combinations thereof.

Examples of amino-containing acrylic monomers include without limitation N-2-aminoethyl (meth)acrylamide, N-2-methylaminoethyl (meth)acrylamide, N-2-ethylaminoethyl (meth)acrylamide, N-2-dimethylaminoethyl (meth)acrylamide, N-3-aminopropyl (meth)acrylamide, N-3-methylaminopropyl (meth)acrylamide, N-3-dimethylaminopropyl (meth)acrylamide, 2-aminoethyl (meth)acrylate, 2-methylaminoethyl (meth)acrylate, 2-ethylaminoethyl (meth)acrylate, 3-aminopropyl (meth)acrylate, 3-methylaminopropyl (meth)acrylate, 3-ethylaminopropyl (meth)acrylate, 3-amino-2-hydroxypropyl (meth)acrylate, trimethylammonium 2-hydroxy propyl (meth)acrylate hydrochloride, dimethylaminoethyl (meth)acrylate, and combinations thereof.

Examples of N-vinyl amide monomers include without limitation N-vinylpyrrolidone (aka, N-vinyl-2-pyrrolidone), N-vinyl-3-methyl-2-pyrrolidone, N-vinyl-4-methyl-2-pyrrolidone, N-vinyl-5-methyl-2-pyrrolidone, N-vinyl-6-methyl-2-pyrrolidone, N-vinyl-3-ethyl-2-pyrrolidone, N-vinyl-4,5-dimethyl-2-pyrrolidone, N-vinyl-5,5-dimethyl-2-pyrrolidone, N-vinyl-3,3,5-trimethyl-2-pyrrolidone, N-vinyl piperidone (aka, N-vinyl-2-piperidone), N-vinyl-3-methyl-2-piperidone, N-vinyl-4-methyl-2-piperidone, N-vinyl-5-methyl-2-piperidone, N-vinyl-6-methyl-2-piperidone, N-vinyl-6-ethyl-2-piperidone, N-vinyl-3,5-dimethyl-2-piperidone, N-vinyl-4,4-dimethyl-2-piperidone, N-vinyl caprolactam (aka, N-vinyl-2-caprolactam), N-vinyl-3-methyl-2-caprolactam, N-vinyl-4-methyl-2-caprolactam, N-vinyl-7-methyl-2-caprolactam, N-vinyl-7-ethyl-2-caprolactam, N-vinyl-3,5-dimethyl-2-caprolactam, N-vinyl-4,6-dimethyl-2-caprolactam, N-vinyl-3,5,7-trimethyl-2-caprolactam, N-vinyl-N-methyl acetamide, N-vinyl formamide, N-vinyl acetamide, N-vinyl isopropylamide, N-vinyl-N-ethyl acetamide, N-vinyl-N-ethyl formamide, and mixtures thereof.

Examples of methylene-containing pyrrolidone monomers include without limitation 1-methyl-3-methylene-2-pyrrolidone, 1-ethyl-3-methylene-2-pyrrolidone, 1-methyl-5-methylene-2-pyrrolidone, 1-ethyl-5-methylene-2-pyrrolidone, 5-methyl-3-methylene-2-pyrrolidone, 5-ethyl-3-methylene-2-pyrrolidone, 1-n-propyl-3-methylene-2-pyrrolidone, 1-n-propyl-5-methylene-2-pyrrolidone, 1-isopropyl-3-methylene-2-pyrrolidone, 1-isopropyl-5-methylene-2-pyrrolidone, 1-n-butyl-3-methylene-2-pyrrolidone, 1-tert-butyl-3-methylene-2-pyrrolidone, and mixtures thereof.

Examples of acrylic monomers having a C₁-C₄ alkoxyethoxy group include without limitation ethylene glycol methyl ether (meth)acrylate, di(ethylene glycol) methyl ether (meth)acrylate, tri(ethylene glycol) methyl ether (meth)acrylate, tetra(ethylene glycol) methyl ether (meth)acrylate, C₁-C₄-alkoxy poly(ethylene glycol) (meth)acrylate having a number average molecular weight of up to 1500, methoxy-poly(ethylene glycol)ethyl (meth)acrylamide having a number average molecular weight of up to 1500, and combinations thereof.

Examples of vinyl ether monomers include without limitation ethylene glycol monovinyl ether, di(ethylene glycol) monovinyl ether, tri(ethylene glycol) monovinyl ether, tetra(ethylene glycol) monovinyl ether, poly(ethylene glycol) monovinyl ether, ethylene glycol methyl vinyl ether, di(ethylene glycol) methyl vinyl ether, tri(ethylene glycol) methyl vinyl ether, tetra(ethylene glycol) methyl vinyl ether, poly(ethylene glycol) methyl vinyl ether, and combinations thereof.

Examples of allyl ether monomers include without limitation ethylene glycol monoallyl ether, di(ethylene glycol) monoallyl ether, tri(ethylene glycol) monoallyl ether, tetra(ethylene glycol) monoallyl ether, poly(ethylene glycol) monoallyl ether, ethylene glycol methyl allyl ether, di(ethylene glycol) methyl allyl ether, tri(ethylene glycol) methyl allyl ether, tetra(ethylene glycol) methyl allyl ether, poly(ethylene glycol) methyl allyl ether, and combinations thereof.

Examples of phosphorylcholine-containing vinylic monomers include without limitation (meth)acryloyloxyethyl phosphorylcholine, (meth)acryloyloxypropyl phosphorylcholine, 4-((meth)acryloyloxy)butyl-2′-(trimethylammonio)ethylphosphate, 2-[(meth)acryloylamino]ethyl-2′-(trimethylammonio)-ethylphosphate, 3-[(meth)acryloylamino]-propyl-2′-(trimethylammonio)-ethylphosphate, 4-[(meth)acryloylamino]butyl-2′-(trimethyl-ammonio)ethylphosphate, 5-((meth)acryloyloxy)pentyl-2′-(trimethylammonio)ethyl phosphate, 6-((meth)acryloyloxy)hexyl-2′-(trimethylammonio)-ethylphosphate, 2-((meth)acryloyloxy)ethyl-2′-(triethylammonio)ethylphosphate, 2-((meth)acryloyloxy)ethyl-2′-(tripropylammonio)ethylphosphate, 2-((meth)acryloxy)-ethyl-2′-(tributylammonio)ethyl phosphate, 2-((meth)acryloyloxy)propyl-2′-(trimethylammonio)-ethylphosphate, 2-((meth)acryloyloxy)butyl-2′-(trimethylammonio)ethylphosphate, 2-((meth)acryloxy)pentyl-2′-(trimethylammonio)ethylphosphate, 2-((meth)acryloyloxy)hexyl-2′-(trimethylammonio)ethyl phosphate, 2-(vinyloxy)ethyl-2′-(trimethylammonio)ethylphosphate, 2-(allyloxy)ethyl-2′-(trimethylammonio)ethylphosphate, 2-(vinyloxycarbonyl)ethyl-2′-(trimethylammonio)ethyl phosphate, 2-(allyloxycarbonyl)ethyl-2′-(trimethylammonio)ethylphosphate, 2-(vinylcarbonyl-amino)ethyl-2′-(trimethylammonio)ethylphosphate, 2-(allyloxycarbonylamino)-ethyl-2′-(trimethylammonio)ethyl phosphate, 2-(butenoyloxy)ethyl-2′-(trimethylammonio)-ethylphosphate, and combinations thereof.

In accordance with the invention, the SiHy lens-forming composition can also comprise one or more hydrophobic non-silicone vinylic monomers. Examples of preferred hydrophobic non-silicone vinylic monomers can be non-silicone hydrophobic acrylic monomers (methyl (meth)acrylate, ethyl (meth)acrylate, propyl (meth)acrylate, isopropyl (meth)acrylate, cyclohexyl (meth)acrylate, 2-ethylhexyl (meth)acrylate, isobornyl (meth)acrylate, (meth)acrylonitrile, etc.), fluorine-containing acrylic monomers (e.g., perfluorohexylethyl-thio-carbonyl-aminoethyl-methacrylate, perfluoro-substituted-C₂-C₁₂ alkyl (meth)acrylates described below, etc.), vinyl alkanoates (e.g., vinyl acetate, vinyl propionate, vinyl butyrate, vinyl valerate, etc.), vinyloxyalkanes (e.g., vinyl ethyl ether, propyl vinyl ether, n-butyl vinyl ether, isobutyl vinyl ether, cyclohexyl vinyl ether, t-butyl vinyl ether, etc.), styrene, vinyl toluene, vinyl chloride, vinylidene chloride, 1-butene, and combinations thereof.

Any suitable perfluoro-substituted-C₂-C₁₂ alkyl (meth)acrylates can be used in the invention. Examples of perfluoro-substituted-C₂-C₁₂ alkyl (meth)acrylates include without limitation 2,2,2-trifluoroethyl (meth)acrylate, tetrafluoropropyl (meth)acrylate, hexafluoro-iso-propyl (meth)acrylate, hexafluorobutyl (meth)acrylate, heptafluorobutyl (meth)acrylate, octafluoropentyl (meth)acrylate, heptadecafluorodecyl (meth)acrylate, pentafluorophenyl (meth)acrylate, and combinations thereof.

In accordance with the invention, the SiHy lens-forming composition can also comprise one or more non-silicone vinylic crosslinkers (free of aryl group). Examples of preferred non-silicone vinylic cross-linking agents include without limitation: acrylic crosslinkers (free of aryl group) as described above, allyl methacrylate, allyl acrylate, N-allyl-methacrylamide, N-allyl-acrylamide, tetraethyleneglycol divinyl ether, triethyleneglycol divinyl ether, diethyleneglycol divinyl ether, ethyleneglycol divinyl ether, triallyl isocyanurate, 2,4,6-triallyloxy-1,3,5-triazine, 1,2,4-trivinylcyclohexane, or combinations thereof.

In accordance with the invention, the SiHy lens-forming composition can also comprises other polymerizable materials, such as, a UV-absorbing vinylic monomer, a UV/high-energy-violet-light (“HEVL”) absorbing vinylic monomer, polymerizable photochromic compound, a polymerizable tinting agent (polymerizable dye), or combinations thereof, as known to a person skilled in the art.

Any suitable UV-absorbing vinylic monomers and UV/HEVL-absorbing vinylic monomers can be used in a polymerizable composition for preparing a preformed SiHy contact lens of the invention. Examples of preferred UV-absorbing and UV/HEVL-absorbing vinylic monomers include without limitation: 2-(2-hydroxy-5-vinylphenyl)-2H-benzotriazole, 2-(2-hydroxy-5-acrylyloxyphenyl)-2H-benzotriazole, 2-(2-hydroxy-3-methacrylamido methyl-5-tert octylphenyl) benzotriazole, 2-(2′-hydroxy-5′-methacrylamidophenyl)-5-chlorobenzotriazole, 2-(2′-hydroxy-5′-methacrylamidophenyl)-5-methoxybenzotriazole, 2-(2′-hydroxy-5′-methacryloxypropyl-3′-t-butyl-phenyl)-5-chlorobenzotriazole, 2-(2′-hydroxy-5′-methacryloxypropylphenyl) benzotriazole, 2-hydroxy-5-methoxy-3-(5-(trifluoromethyl)-2H-benzo[d][1,2,3]triazol-2-yl)benzyl methacrylate (WL-1), 2-hydroxy-5-methoxy-3-(5-methoxy-2H-benzo[d][1,2,3]triazol-2-yl)benzyl methacrylate (WL-5), 3-(5-fluoro-2H-benzo[d][1,2,3]triazol-2-yl)-2-hydroxy-5-methoxybenzyl methacrylate (WL-2), 3-(2H-benzo[d][1,2,3]triazol-2-yl)-2-hydroxy-5-methoxybenzyl methacrylate (WL-3), 3-(5-chloro-2H-benzo[d][1,2,3]triazol-2-yl)-2-hydroxy-5-methoxybenzyl methacrylate (WL-4), 2-hydroxy-5-methoxy-3-(5-methyl-2H-benzo[d][1,2,3]triazol-2-yl)benzyl methacrylate (WL-6), 2-hydroxy-5-methyl-3-(5-(trifluoromethyl)-2H-benzo[d][1,2,3]triazol-2-yl)benzyl methacrylate (WL-7), 4-allyl-2-(5-chloro-2H-benzo[d][1,2,3]triazol-2-yl)-6-methoxyphenol (WL-8), 2-{2′-Hydroxy-3′-tert-5′[3″-(4″-vinylbenzyloxy)propoxy]phenyl}-5-methoxy-2H-benzotriazole, phenol, 2-(5-chloro-2H-benzotriazol-2-yl)-6-(1,1-dimethylethyl)-4-ethenyl- (UVAM), 2-[2′-hydroxy-5′-(2-methacryloxyethyl)phenyl)]-2H-benzotriazole (2-Propenoic acid, 2-methyl-, 2-[3-(2H-benzotriazol-2-yl)-4-hydroxyphenyl]ethyl ester, Norbloc), 2-{2′-Hydroxy-3′-tert-butyl-5′-[3′-methacryloyloxypropoxy]phenyl}-2H-benzotriazole, 2-{2′-Hydroxy-3′-tert-butyl-5′-[3′-methacryloyloxypropoxy]phenyl}-5-methoxy-2H-benzotriazole (UV13), 2-{2′-Hydroxy-3′-tert-butyl-5′-[3′-methacryloyloxypropoxy]phenyl}-5-chloro-2H-benzotriazole (UV28), 2-[2′-Hydroxy-3′-tert-butyl-5′-(3′-acryloyloxypropoxy)phenyl]-5-trifluoromethyl-2H-benzotriazole (UV23), 2-(2′-hydroxy-5-methacrylamidophenyl)-5-methoxybenzotriazole (UV6), 2-(3-allyl-2-hydroxy-5-methylphenyl)-2H-benzotriazole (UV9), 2-(2-Hydroxy-3-methallyl-5-methylphenyl)-2H-benzotriazole (UV12), 2-3′-t-butyl-2′-hydroxy-5′-(3″-dimethylvinylsilylpropoxy)-2′-hydroxy-phenyl)-5-methoxybenzotriazole (UV15), 2-(2′-hydroxy-5′-methacryloylpropyl-3′-tert-butyl-phenyl)-5-methoxy-2H-benzotriazole (UV16), 2-(2′-hydroxy-5′-acryloylpropyl-3′-tert-butyl-phenyl)-5-methoxy-2H-benzotriazole (UV16A), 2-Methylacrylic acid 3-[3-tert-butyl-5-(5-chlorobenzotriazol-2-yl)-4-hydroxyphenyl]-propyl ester (16-100, CAS #96478-15-8), 2-(3-(tert-butyl)-4-hydroxy-5-(5-methoxy-2H-benzo[d][1,2,3]triazol-2-yl)phenoxy)ethyl methacrylate (16-102); Phenol, 2-(5-chloro-2H-benzotriazol-2-yl)-6-methoxy-4-(2-propen-1-yl) (CAS #1260141-20-5); 2-[2-Hydroxy-5-[3-(methacryloyloxy)propyl]-3-tert-butylphenyl]-5-chloro-2H-benzotriazole; Phenol, 2-(5-ethenyl-2H-benzotriazol-2-yl)-4-methyl-, homopolymer (9C₁) (CAS #83063-87-0). In accordance with the invention, the polymerizable composition comprises about 0.1% to about 3.0%, preferably about 0.2% to about 2.5%, more preferably about 0.3% to about 2.0%, by weight of one or more UV-absorbing vinylic monomers, related to the amount of all polymerizable components in the polymerizable composition.

Examples of preferred photochromic vinylic monomers include polymerizable naphthopyrans, polymerizable benzopyrans, polymerizable indenonaphthopyrans, polymerizable phenanthropyrans, polymerizable spiro(benzindoline)-naphthopyrans, polymerizable spiro(indoline)benzopyrans, polymerizable spiro(indoline)-naphthopyrans, polymerizable spiro(indoline)quinopyrans, polymerizable spiro(indoline)-pyrans, polymerizable naphthoxazines, polymerizable spirobenzopyrans; polymerizable spirobenzopyrans, polymerizable spirobenzothiopyrans, polymerizable naphthacenediones, polymerizable spirooxazines, polymerizable spiro(indoline)naphthoxazines, polymerizable spiro(indoline)-pyridobenzoxazines, polymerizable spiro(benzindoline)pyridobenzoxazines, polymerizable spiro(benzindoline)naphthoxazines, polymerizable spiro(indoline)-benzoxazines, polymerizable diarylethenes, and combinations thereof, as disclosed in U.S. Pat. Nos. 4,929,693, 5,166,345 6,017,121, 7,556,750, 7,584,630, 7,999,989, 8,158,037, 8,697,770, 8,741,188, 9,052,438, 9,097,916, 9,465,234, 9,904,074, 10,197,707, 6,019,914, 6,113,814, 6,149,841, 6,296,785, and 6,348,604.

In accordance with the invention, the SiHy material of the embedded SiHy contact lens has an equilibrium water content (i.e., in fully hydrated state or when being fully hydrated) of from about 20% to about 70% (preferably from about 20% to about 65%, more preferably from about 25% to about 65%, even more preferably from about 30% to about 60%) by weight, an oxygen permeability of at least about 40 barrers (preferably at least about 60 barrers, more preferably at least about 80 barrers, more preferably at least about 100 barrers), and a modulus (i.e., Young's modulus) of about 1.5 MPa or less (preferably from about 0.2 MPa to about 1.2 MPa, more preferably from about 0.3 MPa to about 1.1 MPa, even more preferably from about 0.4 MPa to about 1.0 MPa).

A lens-forming composition or an insert-forming composition can be a solventless clear liquid prepared by mixing all polymerizable components (or materials) and other necessary component(or materials) or a solution prepared by dissolving all of the desirable components (or materials) in any suitable solvent, such as, a mixture of water and one or more organic solvents miscible with water, an organic solvent, or a mixture of one or more organic solvents, as known to a person skilled in the art. The term “solvent” refers to a chemical that cannot participate in free-radical polymerization reaction (any of those solvents as described later in this application).

A solventless SiHy lens formulation (SiHy lens-forming composition) typically comprises at least one blending vinylic monomer as a reactive solvent for dissolving all other polymerizable components of the solventless SiHy lens formulation. Examples of preferred blending vinylic monomers are described later in this application. Preferably, methyl methacrylate is used as a blending vinylic monomer in preparing a solventless SiHy lens formulation.

Examples of suitable solvents include acetone, methanol, cyclohexane, tetrahydrofuran, tripropylene glycol methyl ether, dipropylene glycol methyl ether, ethylene glycol n-butyl ether, ketones (e.g., acetone, methyl ethyl ketone, etc.), diethylene glycol n-butyl ether, diethylene glycol methyl ether, ethylene glycol phenyl ether, propylene glycol methyl ether, propylene glycol methyl ether acetate, dipropylene glycol methyl ether acetate, propylene glycol n-propyl ether, dipropylene glycol n-propyl ether, tripropylene glycol n-butyl ether, propylene glycol n-butyl ether, dipropylene glycol n-butyl ether, tripropylene glycol n-butyl ether, propylene glycol phenyl ether dipropylene glycol dimetyl ether, polyethylene glycols, polypropylene glycols, ethyl acetate, butyl acetate, amyl acetate, methyl lactate, ethyl lactate, i-propyl lactate, methylene chloride, 2-butanol, 1-propanol, 2-propanol, menthol, cyclohexanol, cyclopentanol and exonorborneol, 2-pentanol, 3-pentanol, 2-hexanol, 3-hexanol, 3-methyl-2-butanol, 2-heptanol, 2-octanol, 2-nonanol, 2-decanol, 3-octanol, norborneol, tert-butanol, tert-amyl alcohol, 2-methyl-2-pentanol, 2,3-dimethyl-2-butanol, 3-methyl-3-pentanol, 1-methylcyclohexanol, 2-methyl-2-hexanol, 3,7-dimethyl-3-octanol, 1-chloro-2-methyl-2-propanol, 2-methyl-2-heptanol, 2-methyl-2-octanol, 2-2-methyl-2-nonanol, 2-methyl-2-decanol, 3-methyl-3-hexanol, 3-methyl-3-heptanol, 4-methyl-4-heptanol, 3-methyl-3-octanol, 4-methyl-4-octanol, 3-methyl-3-nonanol, 4-methyl-4-nonanol, 3-methyl-3-octanol, 3-ethyl-3-hexanol, 3-methyl-3-heptanol, 4-ethyl-4-heptanol, 4-propyl-4-heptanol, 4-isopropyl-4-heptanol, 2,4-dimethyl-2-pentanol, 1-methylcyclopentanol, 1-ethylcyclopentanol, 1-ethylcyclopentanol, 3-hydroxy-3-methyl-1-butene, 4-hydroxy-4-methyl-1-cyclopentanol, 2-phenyl-2-propanol, 2-methoxy-2-methyl-2-propanol 2,3,4-trimethyl-3-pentanol, 3,7-dimethyl-3-octanol, 2-phenyl-2-butanol, 2-methyl-1-phenyl-2-propanol and 3-ethyl-3-pentanol, 1-ethoxy-2-propanol, 1-methyl-2-propanol, t-amyl alcohol, isopropanol, 1-methyl-2-pyrrolidone, N,N-dimethylpropionamide, dimethyl formamide, dimethyl acetamide, dimethyl propionamide, N-methyl pyrrolidinone, and mixtures thereof. More preferred organic solvents include without limitation methanol, ethanol, 1-propanol, isopropanol, sec-butanol, tert-butyl alcohol, tert-amyl alcohol, acetone, methyl ethyl ketone, methyl isopropyl ketone, methyl propyl ketone, ethyl acetate, heptane, methylhexane (various isomers), methylcyclohexane, dimethylcyclopentane (various isomers), 2,2,4-trimethylpentane, and mixtures thereof.

The insert-forming composition and the lens-forming composition can be introduced into the insert-molding cavity and the lens-molding cavity respectively according to any techniques known to a person skilled in the art.

When the first molding assembly is closed, any excess insert-forming composition is pressed into an overflow groove provided on the first male mold half having a second molding surface defining the back surface of an insert to be molded.

When the second molding assembly is closed, any excess lens-forming composition is pressed into an overflow groove provided on either one of the female mold half and the second male mold half. The overflow groove surrounds the molding surface defining one of the anterior and posterior surfaces of a contact lens to be molded.

The curing of the insert-forming composition within the insert-molding cavity of the closed first molding assembly and the lens-forming composition within the lens-molding cavity of the closed second molding assembly can be carried out thermally (i.e., by heating) or actinically (i.e., by actinic radiation, e.g., UV radiation and/or visible radiation) to activate the polymerization initiators.

The actinic polymerization of the insert- or lens-forming composition in a molding assembly can be carried out by irradiating the closed molding assembly with the insert- or lens-forming composition therein with an UV or visible light, according to any techniques known to a person skilled in the art.

The thermal polymerization of the insert- or lens-forming composition in a molding assembly can be carried out conveniently in an oven at a temperature of from 25 to 120° C. and preferably 40 to 100° C., as well known to a person skilled in the art. The reaction time may vary within wide limits, but is conveniently, for example, from 1 to 24 hours or preferably from 2 to 12 hours. It is advantageous to previously degas the silicone-hydrogel-lens-forming composition and to carry out said copolymerization reaction under an inert atmosphere, e.g., under N₂ or Ar atmosphere.

The step of separating the first molding assembly can be carried out according to any techniques known to a person skilled in the art. It is understood that the molded insert is adhered onto the female mold. As an illustrative example, the firs male mold half can be blasted with liquid nitrogen for several seconds and then pinched.

The step of separating the second molding assembly can be carried out according to any techniques known to a person skilled in the art. It is understood that the molded embedded hydrogel contact lens can be adhered onto either one of the two mold halves of the second molding assembly. As an illustrative example, a compression force can be applied by using a mold-opening device to non-optical surface (opposite to the molding surface) of one of the mold halves (not adhering the molded insert) of the second molding assembly at a location about the center area of non-optical molding surface at an angle of less than about 30 degrees, preferably less than about 10 degrees, most preferably less than about 5 degrees (i.e., in a direction substantially normal to center area of non-optical molding surface) relative to the axis of the mold to deform the mold half, thereby breaking bonds between the molding surface of the mold half and the molded lens. Various ways of applying a force to non-optical surface of the mold half at a location about the center area of non-optical molding surface along the axis of the mold to deform the mold half which breaks the bonds between the optical molding surface of the mold half and the molded lens. It is understood that the mold-opening device can have any configurations known to a person skilled in the art for performing the function of separating two mold halves from each other.

The embedded hydrogel contact lens precursor can be delensed (i.e., removed) from the lens-adhered mold half according to any techniques known to a person skilled in the art.

After the embedded hydrogel contact lens precursor is delensed, it typically is extracted with an extraction medium as well known to a person skilled in the art. The extraction liquid medium is any solvent capable of dissolving the diluent(s), unpolymerized polymerizable materials, and oligomers in the embedded SiHy contact lens precursor. Water, any organic solvents known to a person skilled in the art, or a mixture thereof can be used in the invention. Preferably, the organic solvents used extraction liquid medium are water, a buffered saline, a C₁-C₃ alkyl alcohol, 1,2-propylene glycol, a polyethyleneglycol having a number average molecular weight of about 400 Daltons or less, a C₁-C₆ alkylalcohol, or combinations thereof.

The extracted embedded hydrogel contact lens can then be hydrated according to any method known to a person skilled in the art.

The hydrated embedded hydrogel contact lens can further subject to further processes, such as, for example, surface treatment, packaging in lens packages with a packaging solution which is well known to a person skilled in the art; sterilization such as autoclave at from 118 to 124° C. for at least about 30 minutes; and the like.

Lens packages (or containers) are well known to a person skilled in the art for autoclaving and storing a soft contact lens. Any lens packages can be used in the invention. Preferably, a lens package is a blister package which comprises a base and a cover, wherein the cover is detachably sealed to the base, wherein the base includes a cavity for receiving a sterile packaging solution and the contact lens.

Lenses are packaged in individual packages, sealed, and sterilized (e.g., by autoclave at about 120° C. or higher for at least 30 minutes under pressure) prior to dispensing to users. A person skilled in the art will understand well how to seal and sterilize lens packages.

Although various embodiments of the invention have been described using specific terms, devices, and methods, such description is for illustrative purposes only. The words used are words of description rather than of limitation. As would be obvious to one skilled in the art, many variations and modifications of the invention may be made by those skilled in the art without departing from the spirit and scope of the novel concepts of the disclosure. In addition, it should be understood that aspects of the various embodiments of the invention may be interchanged either in whole or in part or can be combined in any manner and/or used together, as illustrated below:
1. A method for producing embedded hydrogel contact lenses, comprising the steps of:
   (1) obtaining a female mold half, a first male mold half and a second male mold half, wherein the female mold half has a first molding surface defining the anterior surface of a contact lens to be molded and also the front surface of an insert to be molded, wherein the first male mold half has a second molding surface defining the back surface of the insert to be molded and a diffractive structure thereon, wherein the second male mold half has a third molding surface defining the posterior surface of the contact lens to be molded, wherein the first male mold half and the female mold half are configured to receive each other such that an insert-molding cavity is formed between the second molding surface and a central portion of the first molding surface when the female mold half is closed with the first male mold half, wherein the second male mold half and the female mold half are configured to receive each other such that a lens-molding cavity is formed between the first and third molding surfaces when the female mold half is closed with the second male mold half;
   (2) treating a central circular area of the first molding surface by using a vacuum UV or a corona plasma, wherein the central circular area has a diameter equal to or smaller than the diameter of the insert to be molded;
   (3) dispensing an amount of an insert-forming composition on the central portion of the first molding surface of the female mold half obtained in step (2);
   (4) placing the first male mold half on top of the insert-forming composition in the female mold half and closing the first male mold half and the female mold half to form a first molding assembly comprising the insert-forming composition within the insert-molding cavity;
   (5) curing the insert-forming composition in the insert-molding cavity of the first molding assembly to form a molded insert made of a crosslinked polymeric material formed from the insert-forming composition;
   (6) separating the first molding assembly obtained in step (5) into the first male mold half and the female mold half with the molded insert that is adhered onto the central portion of the first molding surface;
   (7) dispensing a lens-forming composition in the female mold half with the molded insert adhered thereon in an amount sufficient for filling the lens-molding cavity;
   (8) placing the second male mold half on top of the lens-forming composition in the female mold half and closing the second male mold half and the female mold half to form a second molding assembly comprising the lens-forming composition and the molded insert immersed therein in the lens-molding cavity;
   (9) curing the lens-forming composition in the lens-molding cavity of the second molding assembly to form an embedded hydrogel contact lens precursor that comprise a bulk hydrogel material formed from the lens-forming composition and the insert embedded in the bulk hydrogel material;
   (10) separating the second molding assembly obtained in step (9) into the second male mold half and the female mold half, with the embedded hydrogel contact lens precursor adhered on a lens-adhered mold half which is one of the female and second male mold halves;
   (11) removing the embedded hydrogel contact lens precursor from the lens-adhered mold half (preferably before the embedded hydrogel contact lens precursor is contact with water or any liquid); and
   (12) subjecting the embedded hydrogel contact lens precursor to post-molding processes including one or more processes selected from the group consisting of extraction, hydration, surface treatment, packaging, sterilization, and combinations thereof to obtain an embedded hydrogel contact lens.
2. The method of embodiment 1, wherein the first male mold half comprise an overflow groove which surrounds the second molding surface and into which any excess insert-forming material is pressed when the first molding assembly is closed securely, wherein any flushes formed from the excess insert-forming material during step (5) can be stuck on the first male mold half during step of separating the first molding assembly, thereby removing the flushes.
3. The method of embodiment 1 or 2, wherein the central circular area of the first molding surface by using a vacuum UV.
4. The method of embodiment 1 or 2, wherein the central circular area of the first molding surface by using a corona plasma.
5. A method for producing embedded hydrogel contact lenses, comprising the steps of:
   (1) obtaining a first female mold half, a male mold half and a second female mold half, wherein the first female mold half has a first molding surface defining the front surface of an insert to be molded and a diffractive structure thereon, wherein the male mold half has a second molding surface defining the posterior surface of a contact lens to be molded and also the back surface of the insert to be molded, wherein the second female mold half has a third molding surface defining the anterior surface of the contact lens to be molded, wherein the first female mold half and the male mold half are configured to receive each other such that an insert-molding cavity is formed between the first molding surface and a central portion of the second molding surface when the male mold half is closed with the first female mold half, wherein the second female mold half and the male mold half are configured to receive each other such that a lens-molding cavity is formed between the second and third molding surfaces when the male mold half is closed with the second female mold half;
   (2) treating a central circular area of the second molding surface by using a vacuum UV or a corona plasma, wherein the central circular area has a diameter equal to or smaller than the diameter of the insert to be molded;
   (3) dispensing an amount of an insert-forming composition on the first molding surface of the first female mold half;
   (4) placing the male mold half obtained in step (2) on top of the insert-forming composition in the first female mold half and closing the first female mold half and the male mold half to form a first molding assembly comprising the insert-forming composition within the insert-molding cavity;
   (5) curing the insert-forming composition in the insert-molding cavity of the first molding assembly to form a molded insert made of a crosslinked polymeric material formed from the insert-forming composition;
   (6) separating the first molding assembly obtained in step (5) into the first female mold half and the male mold half with the molded insert that is adhered onto the central portion of the second molding surface;
   (7) dispensing a lens-forming composition in the second female mold half in an amount sufficient for filling the lens-molding cavity;
   (8) placing the male mold half with the molded insert adhered thereon on top of the lens-forming composition in the second female mold half and closing the male mold half and the second female mold half to form a second molding assembly comprising the lens-forming composition and the molded insert immersed therein in the lens-molding cavity;
   (9) curing the lens-forming composition in the lens-molding cavity of the second molding assembly to form an embedded hydrogel contact lens precursor that comprise a bulk hydrogel material formed from the lens-forming composition and the insert embedded in the bulk material;
   (10) separating the second molding assembly obtained in step (9) into the male mold half and the second female mold half, with the embedded hydrogel contact lens precursor adhered on a lens-adhered mold half which is one of the male and second female mold halves;
   (11) removing the embedded hydrogel contact lens precursor from the lens-adhered mold half (preferably before the embedded hydrogel contact lens precursor is contact with water or any liquid); and
   (12) subjecting the embedded hydrogel contact lens precursor to post-molding processes including one or more processes selected from the group consisting of extraction, hydration, surface treatment, packaging, sterilization, and combinations thereof to obtain an embedded hydrogel contact lens.
6. The method of embodiment 5, wherein the first female mold half comprise an overflow groove which surrounds the first molding surface and into which any excess insert-forming material is pressed when the first molding assembly is closed securely, wherein any flushes formed from the excess insert-forming material during step (5) can be stuck on the first female mold half during step of separating the first molding assembly, thereby removing the flushes.
7. The method of embodiment 5 or 6, wherein the central circular area of the first molding surface or the second molding surface by using a vacuum UV.
8. The method of embodiment 5 or 6, wherein the central circular area of the first molding surface or the second molding surface by using a corona plasma.
9. The method of any one of embodiments 1 to 9, wherein the central circular area has a diameter that is about 90% or smaller of the diameter of the insert.
10. The method of any one of embodiments 1 to 9, wherein the central circular area has a diameter that is about 75% or smaller of the diameter of the insert.
11. The method of any one of embodiments 1 to 9, wherein the central circular area has a diameter that is about 60% or smaller of the diameter of the insert.
12. The method of any one of embodiments 1 to 9, wherein the central circular area has a diameter that is about 45% or smaller of the diameter of the insert.
13. The method of any one of embodiments 1 to 12, wherein the crosslinked polymeric material has a refractive index that is at least 0.03 higher than the refractive index of the bulk hydrogel material.
14. The method of any one of embodiments 1 to 13, wherein the crosslinked polymeric material has a refractive index of at least 1.44.
15. The method of any one of embodiments 1 to 13, wherein the crosslinked polymeric material has a refractive index of at least 1.46.
16. The method of any one of embodiments 1 to 13, wherein the crosslinked polymeric material has a refractive index of at least 1.48.
17. The method of any one of embodiments 1 to 13, wherein the crosslinked polymeric material has a refractive index of at least 1.50.
18. The method of any one of embodiments 1 to 17, wherein the step of (5) curing the insert-forming composition is carried out actinically by using UV and/or visible light.
19. The method of any one of embodiments 1 to 17, wherein the step of (5) curing the insert-forming composition is carried out thermally by heating the first molding assembly in an oven at one or more curing temperature selected from about 40° C. to about 100° C.
20. The method of any one of embodiments 1 to 19, wherein the step of (9) curing the lens-forming composition is carried out actinically by using UV and/or visible light.
21. The method of any one of embodiments 1 to 19, wherein the step of (9) curing the lens-forming composition is carried out thermally by heating the first molding assembly in an oven at one or more curing temperature selected from about 40° C. to about 100° C.
22. The method of any one of embodiments 1 to 21, wherein the insert-forming composition comprises at least one aryl vinylic monomer and/or at least one aryl vinylic crosslinker.
23. The method of embodiment 22, wherein said at least one aryl vinylic monomer comprises: 2-ethylphenoxy acrylate; 2-ethylphenoxy methacrylate; phenyl acrylate; phenyl methacrylate; benzyl acrylate; benzyl methacrylate; 2-phenylethyl acrylate; 2-phenylethyl methacrylate; 3-phenylpropyl acrylate; 3-phenylpropyl methacrylate; 4-phenylbutyl acrylate; 4-phenylbutyl methacrylate; 4-methylphenyl acrylate; 4-methylphenyl methacrylate; 4-methylbenzyl acrylate; 4-methylbenzyl methacrylate; 2-(2-methylphenyl)ethyl acrylate; 2-(2-methylphenyl)ethyl methacrylate; 2-(3-methylphenyl)ethyl acrylate; 2-(3-methylphenyl)ethyl methacrylate; 2-(4-methylphenyl)ethyl acrylate; 2-(4-methylphenyl)ethyl methacrylate; 2-(4-propylphenyl)ethyl acrylate; 2-(4-propylphenyl)ethyl methacrylate; 2-(4-(1-methylethyl)phenyl)ethyl acrylate; 2-(4-(1-methylethyl)phenyl)ethyl methacrylate; 2-(4-methoxyphenyl)ethyl acrylate; 2-(4-methoxyphenyl)ethyl methacrylate; 2-(4-cyclohexylphenyl)ethyl acrylate; 2-(4-cyclohexylphenyl)ethyl methacrylate; 2-(2-chlorophenyl)ethyl acrylate; 2-(2-chlorophenyl)ethyl methacrylate; 2-(3-chlorophenyl)ethyl acrylate; 2-(3-chlorophenyl)ethyl methacrylate; 2-(4-chlorophenyl)ethyl acrylate; 2-(4-chlorophenyl)ethyl methacrylate; 2-(4-bromophenyl)ethyl acrylate; 2-(4-bromophenyl)ethyl methacrylate; 2-(3-phenylphenyl)ethyl acrylate; 2-(3-phenylphenyl)ethyl methacrylate; 2-(4-phenylphenyl)ethyl acrylate; 2-(4-phenylphenyl)ethyl methacrylate; 2-(4-benzylphenyl)ethyl acrylate; 2-(4-benzylphenyl)ethyl methacrylate; 2-(phenylthio)ethyl acrylate; 2-(phenylthio)ethyl methacrylate; 2-benzyloxyethyl acrylate; 3-benzyloxypropyl acrylate; 2-benzyloxyethyl methacrylate; 3-benzyloxypropyl methacrylate; 2-[2-(benzyloxy)ethoxy]ethyl acrylate; 2-[2-(benzyloxy)ethoxy]ethyl methacrylate; one or more silicone-containing aryl vinylic monomers; one or more aryl-containing ene monomers; or combinations thereof.
24. The method of embodiment 23, wherein said one or more aryl-containing ene monomer comprises: styrene, 2,5-dimethylstyrene, 2-(trifluoromethyl)styrene, 2-chlorostyrene, 3,4-dimethoxystyrene, 3-chlorostyrene, 3-bromostyrene, 3-vinylanisole, 3-methylstyrene, 4-bromostyrene, 4-tert-butylstyrene, 2,3,4,5,6-pentanfluorostyrene, 2,4-dimethylstyrene, 1-methoxy-4-vinylbenzene, 1-chloro-4-vinylbenzene, 1-methyl-4-vinylbenzene, 1-(chloromethyl)-4-vinylbenzene, 1-(bromomethyl)-4-vinylbenzene, 3-nitrostyrene, 1,2-vinyl phenyl benzene, 1,3-vinyl phenyl benzene, 1,4-vinyl phenyl benzene, 4-vinyl-1,1′-(4′-phenyl)biphenylene, 1-vinyl-4-(phenyloxy)benzene, 1-vinyl-3-(phenyloxy)benzene, 1-vinyl-2-(phenyloxy)benzene, 1-vinyl-4-(phenyl carbonyl)benzene, 1-vinyl-3-(phenylcarboxy)benzene, 1-vinyl-2-(phenoxycarbonyl)benzene, allyl phenyl ether, 2-biphenylylallyl ether, allyl 4-phenoxyphenyl ether, allyl 2,4,6-tribromophenyl ether, allyl phenyl carbonate, 1-allyloxy-2-trifluoromethylbenzene, allylbenzene, 1-phenyl-2-prop-2-enylbenzene, 4-phenyl-1-butene, 4-phenyl-1-butene-4-ol, 1-(4-methylphenyl)-3-buten-1-ol, 1-(4-chlorophenyl)-3-buten-1-ol, 4-allyltoluene, 1-allyl-4-fluorobenzene, 1-allyl-2-methylbenzene, 1-allyl-3-methylbenzene, 1-allyl-3-methylbenzene, 2-allylanisole, 4-allylanisole, 1-allyl-4-(trifluromethyl)benzene, allylpentafluorobenzene, 1-allyl-2-methoxybenzene, 4-allyl-1,2-dimethoxybenzene, 2-allylphenol, 2-allyl-6-methylphenol, 4-allyl-2-methoxyphenol, 2-allyloxyanisole, 4-allyl-2-methoxyphenyl acetate, 2-allyl-6-methoxyphenol, 1-allyl-2-bromobezene, alpha-vinylbenzyl alcohol, 1-phenyl-3-butene-1-one, allylbenzyl ether, (3-allyloxy)propyl)benzene, allyl phenylethyl ether, 1-benzyloxy-4-pentene, (1-allyloxy)ethyl)benzene, 1-phenylallyl ethyl ether, (2-methyl-2-(2-propenyloxy)propyl)benzene, ((5-hexenyloxy)methyl)benzene, 1-allyloxy-4-propoxybenzene, 1-phenoxy-4-(3-prop-2-enoxypropoxy)benzene, 6-(4′-Hydroxyphenoxy)-1-Hexene, 4-but-3-enoxyphenol, 1-allyloxy-4-butoxybenzene, 1-allyloxy-4-ethoxybenzene, 1-allyl-4-benzyloxybenzene, 1-allyl-4-(phenoxy)benzene, 1-allyl-3-(phenoxy)benzene, 1-allyl-2-(phenoxy)benzene, 1-allyl-4-(phenyl carbonyl)benzene, 1-allyl-3-(phenyl carboxy)benzene, 1-allyl-2-(phenoxycarbonyl)benzene, 1,2-allyl phenyl benzene, 1,3-allyl phenyl benzene, 1,4-allyl phenyl benzene, 4-vinyl-1,1′-(4′-phenyl)biphenylene, 1-allyl-4-(phenyloxy)benzene, 1-allyl-3-(phenyloxy)benzene, 1-allyl-2-(phenyloxy)benzene, 1-allyl-4-(phenyl carbonyl)benzene, 1-allyl-3-(phenyl carboxy)benzene, and 1-allyl-2-(phenoxycarbonyl)benzene, 1-vinyl naphthylene, 2-vinyl naphthylene, 1-allyl naphthalene, 2-allyl naphthalene, allyl-2-naphthyl ether, 2-(2-methylprop-2-enyl)naphthalene, 2-prop-2-enylnaphthalene, 4-(2-naphthyl)-1-butene, 1-(3-butenyl)naphthalene, 1-allyl naphthalene, 2-allyl naphthalene, 1-allyl-4-napthyl naphthalene, 2-(allyloxy)-1-bromonaphthalene, 2-bromo-6-allyloxynaphthalene, 1,2-vinyl(1-naphthyl)benzene, 1,2-vinyl(2-naphthyl)benzene, 1,3-vinyl(1-naphthyl)benzene, 1,3-vinyl(2-naphthyl)benzene, 1,4-vinyl(1-naphthyl)benzene, 1,4-vinyl(2-naphthyl)benzene, 1-naphthyl-4-vinyl naphthalene, 1-allyl naphthalene, 2-allyl naphthalene, 1,2-allyl(1-naphthyl) benzene, 1,2-allyl(2-naphthyl)benzene, 1,3-allyl(1-naphthyl)benzene, 1,3-allyl(2-naphthyl)benzene, 1,4-allyl(1-naphthyl)benzene, 1,4-allyl(2-naphthyl)benzene, 1-allyl-4-napthyl naphthalene, 1-vinyl anthracene, 2-vinyl anthracene, 9-vinyl anthracene, 1-allyl anthracene, 2-allyl anthracene, 9-allyl anthracene, 9-pent-4-enylanthracene, 9-allyl-1,2,3,4-tetrachloroanthracene, 1-vinyl phenanthrene, 2-vinyl phenanthrene, 3-vinyl phenanthrene, 4-vinyl phenanthrene, 9-vinyl phenanthrene, 1-allyl phenanthrene, 2-allyl phenanthrene, 3-allyl phenanthrene, 4-allyl phenanthrene, 9-allyl phenanthrene, or combinations thereof.
25. The method of embodiment 23 or 24, wherein said one or more silicone-containing aryl vinylic monomer comprises: p-vinylphenyl-tris(trimethylsiloxy)silane; m-vinylphenyltris(trimethylsiloxy)silane; o-vinylphenyl-tris(trimethylsiloxy)silane; p-styrylethyltris(trimethylsiloxy)silane; m-styrylethyl-tris(trimethylsiloxy)silane; o-styrylethyltris(trimethylsiloxy)silane; or combinations thereof.
26. The method of embodiment 23, wherein said at least one aryl vinylic monomer comprises 2-phenylethyl acrylate; 3-phenylpropyl acrylate; 4-phenylbutyl acrylate; 5-phenylpentyl (meth)acrylate; 2-benzyloxyethyl (meth)acrylate; 3-benzyloxypropyl (meth)acrylate; 2-[2-(benzyloxy)ethoxy]ethyl (meth)acrylate; p-vinylphenyl-tris(trimethylsiloxy)silane; m-vinylphenyltris(trimethylsiloxy)silane; o-vinylphenyl-tris(trimethylsiloxy)silane; p-styrylethyltris(trimethylsiloxy)silane; m-styrylethyl-tris(trimethylsiloxy)silane; o-styrylethyltris(trimethylsiloxy)silane; or combinations thereof.
27. The method of embodiment 23, wherein said at least one aryl vinylic monomer comprises p-vinylphenyltris(trimethylsiloxy)silane; m-vinylphenyltris(trimethylsiloxy)silane; o-vinylphenyltris(trimethylsiloxy)silane; p-styrylethyltris(trimethylsiloxy)silane; m-styrylethyl-tris(trimethylsiloxy)silane; o-styrylethyltris(trimethylsiloxy)silane; or combinations thereof.
28. The method of any one of embodiments 23 to 27, wherein said at least one aryl vinylic crosslinker comprises divinylbenzene, 2-methyl-1,4-divinylbenzene, bis(4-vinylphenyl)methane, 1,2-bis(4-vinylphenyl)ethane, or combinations thereof.
29. The method of any one of embodiments 23 to 27, wherein said at least one aryl vinylic crosslinker comprises a silicone-containing aryl vinylic crosslinker.
30. The method of any one of embodiments 1 to 29, wherein the insert-forming composition comprises at least one silicone-containing aryl vinylic monomer and at least one silicone-containing aryl vinylic crosslinker.
31. The method of embodiment 29 or 30, wherein said at least one silicone-containing aryl vinylic crosslinker comprises at least one aryl-containing polysiloxane vinylic crosslinker that comprises: (1) a polydiorganosiloxane segment comprising dimethylsiloxane units and aryl-containing siloxane units each having at least one aryl-containing substituent having up to 45 carbon atoms; and (2) ethylenically-unsaturated groups (preferably (meth)acryloyl groups).
32. The method of embodiment 31, wherein the polydiorganosiloxane segment comprises at least 25% by mole of the aryl-containing siloxane units.
33. The method of embodiment 31 or 32, wherein said at least one aryl-containing polysiloxane vinylic crosslinker has a number average molecular weight of at least 1000 Daltons (preferably from 1500 Daltons to 100000 Daltons, more preferably from 2000 to 80000 Daltons, even more preferably from 2500 to 60000 Dalton).
34. The method of any one of embodiments 31 to 33, wherein said at least one aryl-containing polysiloxane vinylic crosslinker comprises a vinyl terminated polyphenylmethysiloxane, a vinylphenylmethyl terminated phenylmethyl-vinylphenylsiloxane copolymer, a vinyl terminated diphenylsiloxane-dimethylsiloxane copolymer, a (meth)acryloxyalkyl-terminated polyphenylmethysiloxane, a (meth)acryloxyalkyl-terminated phenylmethyl-vinylphenylsiloxane copolymer, a (meth)acryloxyalkyl-terminated diphenylsiloxane-dimethylsiloxane copolymer, an ethylenically-unsaturated group-terminated dimethylsiloxane-arylmethylsiloxane copolymer, or combinations thereof.
35. The method of any one of embodiments 31 to 34, wherein said at least one aryl-containing polysiloxane vinylic crosslinker comprises at least 30% by mole of siloxane units each having at least one phenyl substituent.
36. The method of any one of embodiments 31 to 34, wherein said at least one aryl-containing polysiloxane vinylic crosslinker comprises at least 60% by mole of siloxane units each having at least one phenyl substituent.
37. The method of any one of embodiments 31 to 34, wherein said at least one aryl-containing polysiloxane vinylic crosslinker comprises at least 90% by mole of siloxane units each having at least one phenyl substituent.
38. The method of any one of embodiments 31 to 34, wherein said at least one aryl-containing polysiloxane vinylic crosslinker comprises three or more vinylphenylsiloxane units each having at least one phenyl substituent and one vinyl substituent.
39. The method of any one of embodiments 31 to 34, wherein said at least one aryl-containing polysiloxane vinylic crosslinker comprises three or more phenylmethylsiloxane units.
40. The method of any one of embodiments 31 to 34, wherein said at least one aryl-containing polysiloxane vinylic crosslinker comprises three or more diphenylsiloxane units.
41. The method of any one of embodiments 30 to 40, wherein said at least one silicone-containing aryl vinylic monomer comprises p-vinylphenyltris(trimethylsiloxy)silane; m-vinylphenyltris(trimethylsiloxy)silane; o-vinylphenyltris(trimethylsiloxy)silane; p-styrylethyltris(trimethylsiloxy)silane; m-styrylethyl-tris(trimethylsiloxy)silane; o-styrylethyltris(trimethylsiloxy)silane; or combinations thereof.
42. The method of any one of embodiments 1 to 41, wherein the lens-forming composition is a non-silicone hydrogel lens-forming composition that is (1) a monomeric reaction composition comprising (a) at least one hydrophilic vinylic monomer and (b) at least one component selected from the group consisting of a vinylic crosslinking agent, a hydrophobic vinylic monomer, a free-radical initiator, a UV-absorbing vinylic monomer, a high-energy-violet-light (“HEVL”) absorbing vinylic monomer, a visibility tinting agent, a lubricating agent (or so-called internal wetting agents incorporated in a lens formulation), and combinations thereof; or (2) an aqueous solution comprising one or more water-soluble prepolymers and at least one component selected from the group consisting of hydrophilic vinylic monomer, a vinylic crosslinker, a hydrophobic vinylic monomer, a lubricating agent, a free-radical initiator, a UV-absorbing vinylic monomer, a HEVL absorbing vinylic monomer, a visibility tinting agent, and combinations thereof.
43. The method of any one of embodiments 1 to 41, wherein the lens-forming composition is a non-silicone hydrogel lens-forming composition that comprises at least 50% by mole of at least one hydroxyl-containing vinylic monomer, preferably selected from the group consisting of hydroxyethyl (meth)acrylate, glycerol (meth)acrylate, 3-hydroxypropyl (meth)acrylate, 2-hydroxypropyl (meth)acrylate, 3-amino-2-hydroxypropyl (meth)acrylate, N-2-hydroxyethyl (meth)acrylamide, N-3-hydroxypropyl (meth)acrylamide, N-2-hydroxypropyl (meth)acrylamide, N-2,3-dihydroxypropyl (meth)acrylamide, N-tris(hydroxymethyl)methyl (meth)acrylamide, vinyl alcohol, allyl alcohol, and combinations thereof, more preferably selected from the group consisting of hydroxyethyl (meth)acrylate, glycerol (meth)acrylate, and vinyl alcohol.
44. The method of any one of embodiments 1 to 41, wherein the lens-forming composition is a silicone hydrogel lens-forming composition that comprises (a) at least one silicone-containing vinylic monomer and/or at least one polysiloxane vinylic crosslinker, (b) at least one hydrophilic vinylic monomer, (c) at least one free-radical initiator, (d) at least one component selected from the group consisting of at least one non-silicone vinylic crosslinker, at least one UV-absorbing vinylic monomer, at least one HEVL-absorbing vinylic monomer, a visibility tinting agent, and combinations thereof.
45. The method of embodiment 44, wherein the lens-forming composition comprises at least one silicone-containing vinylic monomer and at least one polysiloxane vinylic crosslinker, wherein said at least one silicone containing vinylic monomer is selected from the group consisting of a vinylic monomer having a bis(trialkylsilyloxy)alkylsilyl group, a vinylic monomer having a tris(trialkylsilyloxy)silyl group, a polysiloxane vinylic monomer, 3-methacryloxy propylpentamethyldisiloxane, t-butyldimethyl-siloxyethyl vinyl carbonate, trimethylsilylethyl vinyl carbonate, and trimethylsilylmethyl vinyl carbonate, and combinations thereof, wherein said at least one polysiloxane vinylic crosslinker comprises a di-(meth)acryloyl-terminated polydimethylsiloxane, a di-vinyl carbonate-terminated polydimethylsiloxane; a di-vinyl carbamate-terminated polydimethylsiloxane; N,N,N′,N′-tetrakis(3-methacryloxy-2-hydroxypropyl)-alpha,omega-bis-3-aminopropyl-polydimethylsiloxane, or a combination thereof.
46. The method of embodiment 44 or 45, wherein said at least one silicone-containing vinylic monomer comprises tris(trimethylsilyloxy)-silylpropyl (meth)acrylate, [3-(meth)acryloxy-2-hydroxypropyloxy]propyl-bis(trimethylsiloxy)-methylsilane, [3-(meth)acryloxy-2-hydroxypropyloxy]propylbis(trimethyl-siloxy)butylsilane, 3-(meth)acryloxy-2-(2-hydroxyethoxy)-propyloxy)propyl-bis(trimethylsiloxy)-methylsilane, 3-(meth)acryloxy-2-hydroxypropyloxy)propyltris(trimethylsiloxy) silane, N-[tris(trimethylsiloxy)silylpropyl]-(meth)acrylamide, N-(2-hydroxy-3-(3-(bis(trimethylsilyloxy)-methylsilyl)propyloxy)-propyl)-2-methyl (meth)acrylamide, N-(2-hydroxy-3-(3-(bis(trimethyl-silyloxy)methylsilyl)-propyloxy)propyl) (meth)acrylamide, N-(2-hydroxy-3-(3-(tris(trimethyl-silyloxy)silyl)-propyloxy)propyl)-2-methyl acrylamide, N-(2-hydroxy-3-(3-(tris(trimethylsilyloxy)-silyl)propyloxy)propyl) (meth)acrylamide, N-[tris(dimethylpropylsiloxy)-silylpropyl]-(meth)acrylamide, N-[tris(dimethylphenylsiloxy)silylpropyl] (meth)acrylamide, N-[tris(dimethyl-ethylsiloxy)silylpropyl] (meth)acrylamide, N,N-bis[2-hydroxy-3-(3-(bis(trimethylsilyloxy)-methylsilyl)propyloxy)propyl]-2-methyl (meth)acrylamide, N,N-bis[2-hydroxy-3-(3-(bis(trimethyl-silyloxy)methylsilyl)propyloxy)-propyl] (meth)acrylamide, N,N-bis[2-hydroxy-3-(3-(tris(trimethyl-silyloxy)silyl)propyloxy)propyl]-2-methyl (meth)acrylamide, N,N-bis[2-hydroxy-3-(3-(tris(trimethyl-silyloxy)silyl)propyloxy)propyl](meth)acrylamide, N-[2-hydroxy-3-(3-(t-butyldimethylsilyl)-propyloxy)propyl]-2-methyl (meth)acrylamide, N-[2-hydroxy-3-(3-(t-butyldimethylsilyl)propyloxy)-propyl](meth)acrylamide, N,N-bis[2-hydroxy-3-(3-(t-butyldimethylsilyl)propyloxy)propyl]-2-methyl (meth)acrylamide, N-2-(meth)acryloxyethyl-O-(methyl-bis-trimethylsiloxy-3-propyl)silyl carbamate, 3-(trimethylsilyl)propylvinyl carbonate, 3-(vinyloxycarbonylthio)propyl-tris(trimethyl-siloxy)silane, 3-[tris(trimethylsiloxy)silyl]propylvinyl carbamate, 3-[tris(trimethylsiloxy)silyl] propyl allyl carbamate, 3-[tris(trimethylsiloxy)silyl]propyl vinyl carbonate, α-(meth)acryloxypropyl terminated ω—C₁-C₄-alkyl terminated polydimethylsiloxane, α-(meth)acryloxy-2-hydroxypropyloxypropyl terminated ω—C₁-C₄-alkyl terminated polydimethylsiloxane, α-(2-hydroxyl-methacryloxypropyloxypropyl)-w-butyl-decamethylpentasiloxane, α-[3-(meth)acryloxyethoxy-2-hydroxypropyloxypropyl]-terminated ω—C₁-C₄-alkyl terminated polydimethylsiloxane, α-[3-(meth)acryloxy-propyloxy-2-hydroxypropyloxypropyl]-terminated ω—C₁-C₄-alkyl terminated polydimethylsiloxane, α-[3-(meth)acryloxyisopropyloxy-2-hydroxypropyloxypropyl]-terminated ω—C₁-C₄-alkyl terminated polydimethylsiloxane, α-[3-(meth)acryloxy-butyloxy-2-hydroxypropyloxypropyl]-terminated ω—C₁-C₄-alkyl terminated polydimethylsiloxane, α-[3-(meth)acryloxy-ethylamino-2-hydroxypropyloxypropyl]-terminated ω—C₁-C₄-alkyl terminated polydimethylsiloxane, α-[3-(meth)acryloxypropylamino-2-hydroxypropyloxypropyl]-terminated ω—C₁-C₄-alkyl terminated polydimethylsiloxane, α-[3-(meth)acryloxy-butylamino-2-hydroxypropyloxy-propyl]-terminated ω—C₁-C₄-alkyl terminated polydimethylsiloxane, α-(meth)acryloxy(polyethylenoxy)-2-hydroxypropyloxypropyl]-terminated ω—C₁-C₄-alkyl terminated polydimethylsiloxane, α-[(meth)acryloxy-2-hydroxypropyloxy-ethoxypropyl]-terminated ω—C₁-C₄-alkyl terminated polydimethylsiloxane, α-[(meth)acryloxy-2-hydroxypropyl-N-ethylaminopropyl]-terminated ω—C₁-C₄-alkyl terminated polydimethylsiloxane, α-[(meth)acryloxy-2-hydroxypropyl-aminopropyl]-terminated ω-butyl (or ω-methyl) terminated polydimethylsiloxane, α-[(meth)acryloxy-2-hydroxypropyloxy-(polyethylenoxy)propyl]-terminated ω—C₁-C₄-alkyl terminated polydimethylsiloxane, α-(meth)acryloylamidopropyloxypropyl terminated ω—C₁-C₄-alkyl terminated polydimethylsiloxane, α-N-methyl-(meth)acryloylamidopropyloxypropyl terminated ω—C₁-C₄-alkyl terminated polydimethylsiloxane, α-[3-(meth)acrylamido-ethoxy-2-hydroxypropyloxy-propyl]-terminated ω—C₁-C₄-alkyl polydimethylsiloxane, α-[3-(meth)acrylamido-propyloxy-2-hydroxypropyloxypropyl]-terminated ω—C₁-C₄-alkyl terminated polydimethylsiloxane, α-[3-(meth)acrylamidoisopropyloxy-2-hydroxypropyloxypropyl]-terminated ω—C₁-C₄-alkyl terminated polydimethylsiloxane, α-[3-(meth)acrylamido-butyloxy-2-hydroxypropyloxypropyl]-terminated ω—C₁-C₄-alkyl terminated polydimethylsiloxane, α-[3-(meth)acryloylamido-2-hydroxypropyloxypropyl] terminated ω—C₁-C₄-alkyl polydimethylsiloxane, α-[3-[N-methyl-(meth)acryloylamido]-2-hydroxypropyloxy-propyl] terminated ω—C₁-C₄-alkyl terminated polydimethylsiloxane, N-methyl-N′-(propyltetra(dimethylsiloxy)-dimethylbutylsilane) (meth)acrylamide, N-(2,3-dihydroxypropane)-N′-(propyltetra(dimethylsiloxy)dimethylbutylsilane) (meth)acrylamide, (meth)acryloylamido-propyltetra(dimethylsiloxy)dimethylbutylsilane, mono-vinyl carbonate-terminated mono-alkyl-terminated polydimethylsiloxanes, mono-vinyl carbamate-terminated mono-alkyl-terminated polydimethylsiloxane, or combinations thereof.
47. The method of any one of embodiments 44 to 46, wherein said at least one polysiloxane vinylic crosslinker comprises (1) a vinylic crosslinker which comprises one sole polydiorganosiloxane segment and two terminal ethylenically-unsaturated groups selected from the group consisting of (meth)acryloyloxy groups, (meth)acryloylamino groups, vinyl carbonate groups, vinylcarbamate groups; and/or (2) a chain-extended polysiloxane vinylic crosslinker which comprises at least two polydiorganosiloxane segment and a covalent linker between each pair of polydiorganosiloxane segments and two terminal ethylenically-unsaturated groups selected from the group consisting of (meth)acryloyloxy groups, (meth)acryloylamino groups, vinyl carbonate groups, vinylcarbamate groups.
48. The method of any one of embodiments 44 to 47, wherein said at least one polysiloxane vinylic crosslinker comprises α,ω-bis[3-(meth)acrylamidopropyl]-terminated polydimethylsiloxane, α,ω-bis[3-(meth)acryloxypropyl]-terminated polydimethylsiloxane, α,ω-bis[3-(meth)acryloxy-2-hydroxypropyloxypropyl]-terminated polydimethylsiloxane, α,ω-bis[3-(meth)acryloxyethoxy-2-hydroxypropyloxypropyl]-terminated polydimethylsiloxane, α,ω-bis[3-(meth)acryloxypropyloxy-2-hydroxypropyloxypropyl]-terminated polydimethylsiloxane, α,ω-bis[3-(meth)acryloxy-isopropyloxy-2-hydroxypropyloxypropyl]-terminated polydimethylsiloxane, α,ω-bis[3-(meth)acryloxybutyloxy-2-hydroxypropyloxypropyl]-terminated polydimethylsiloxane, α,ω-bis[3-(meth)acrylamidoethoxy-2-hydroxypropyloxypropyl]-terminated polydimethylsiloxane, α,ω-bis[3-(meth)acrylamidopropyloxy-2-hydroxypropyloxypropyl]-terminated polydimethylsiloxane, α,ω-bis[3-(meth)acrylamidoisopropyloxy-2-hydroxypropyloxypropyl]-terminated polydimethylsiloxane, α,ω-bis[3-(meth)acrylamidobutyloxy-2-hydroxypropyloxypropyl]-terminated polydimethylsiloxane, α,ω-bis[3-(meth)acryloxyethylamino-2-hydroxypropyloxypropyl]-terminated polydimethylsiloxane, α,ω-bis[3-(meth)acryloxypropylamino-2-hydroxypropyloxypropyl]-terminated polydimethylsiloxane, α,ω-bis[3-(meth)acryloxybutylamino-2-hydroxypropyloxypropyl]-terminated polydimethylsiloxane, α,ω-bis[(meth)acrylamidoethylamino-2-hydroxypropyloxy-propyl]-terminated polydimethylsiloxane, α,ω-bis[3-(meth)acrylamidopropylamino-2-hydroxypropyloxypropyl]-terminated polydimethylsiloxane, α,ω-bis[3-(meth)acrylamide-butylamino-2-hydroxypropyloxypropyl]-terminated polydimethylsiloxane, α,ω-bis[(meth)acryloxy-2-hydroxypropyloxy-ethoxypropyl]-terminated polydimethylsiloxane, α,ω-bis[(meth)acryloxy-2-hydroxypropyl-N-ethylaminopropyl]-terminated polydimethylsiloxane, α,ω-bis[(meth)acryloxy-2-hydroxypropyl-aminopropyl]-polydimethylsiloxane, α,ω-bis[(meth)acryloxy-2-hydroxypropyloxy-(polyethylenoxy)propyl]-terminated polydimethylsiloxane, α,ω-bis[(meth)acryloxyethylamino-carbonyloxy-ethoxypropyl]-terminated polydimethylsiloxane, α,ω-bis[(meth)acryloxyethylamino-carbonyloxy-(polyethylenoxy)propyl]-terminated polydimethylsiloxane, or combinations thereof.
49. The method of any one of embodiments 44 to 47, wherein said at least one polysiloxane vinylic crosslinker comprises at least one hydrophilized polysiloxane vinylic crosslinker that comprises at least about 1.50 (preferably at least about 2.0, more preferably at least about 2.5, even more preferably at least about 3.0) milliequivalent/gram (“meq/g”) of hydrophilic moieties selected from the group consisting of hydroxyl groups (—OH), carboxyl groups (—COOH), amino groups of —NHR_{N1} in which R_{N1} is H or C₁-C₂ alkyl, amide moieties of —CO—NR_{N1}R_{N2} in which R_{N1} is H or C₁-C₂ alkyl and R_{N2} is a covalent bond, H, or C₁-C₂ alkyl, N—C₁-C₃ acylamino groups, urethane moieties of —NH—CO—O—, urea moieties of —NH—CO—NH—, a polyethylene glycol chain of

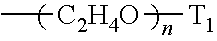

in which n is an integer of 2 to 20 and T₁ is H, methyl or acetyl or a phosphorylcholin group, or combinations thereof.
50. The method of any one of embodiments 44 to 47, wherein said at least one polysiloxane vinylic crosslinker comprises a vinylic crosslinker of formula (1)

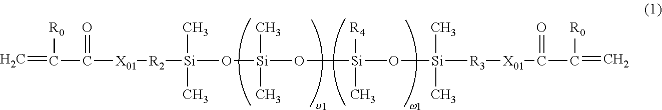

in which:
υ1 is an integer of from 30 to 500 and ω1 is an integer of from 1 to 75, provided that
ω/υ1 is from about 0.035 to about 0.15;
X₀₁ is 0 or NRₙ in which Rₙ is hydrogen or C₁-C₁₀-alkyl;
Rₒ is hydrogen or methyl;
R₂ and R₃ independently of each other are a substituted or unsubstituted C₁-C₁₀ alkylene divalent radical or a divalent radical of —R₅—O—R₆— in which R₅ and R₆ independently of each other are a substituted or unsubstituted C₁-C₁₀ alkylene divalent radical;
R₄ is a monovalent radical of any one of formula (2) to (7)

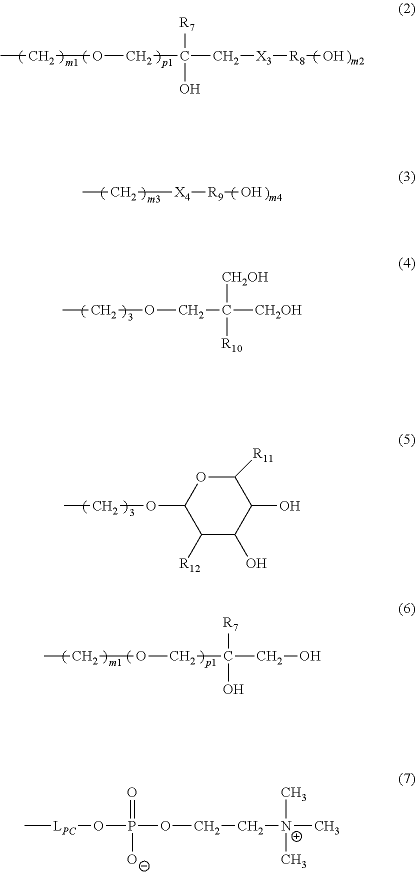

p1 is zero or 1; m1 is an integer of 2 to 4; m2 is an integer of 1 to 5; m3 is an integer of 3 to 6; m4 is an integer of 2 to 5;
R₇ is hydrogen or methyl;
R₈ is a C₂-C₆ hydrocarbon radical having (m2+1) valencies;
R₉ is a C₂-C₆ hydrocarbon radical having (m4+1) valencies;
R₁₀ is ethyl or hydroxymethyl;
R₁₁ is methyl or hydromethyl;
R₁₂ is hydroxyl or methoxy;
X₃ is a sulfur linkage of —S— or a teriary amino linkage of —NR₁₃— in which R₁₃ is C₁-C₁ alkyl, hydroxyethyl, hydroxypropyl, or 2,3-dihydroxypropyl;
X₄ is an amide linkage of

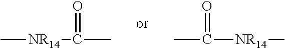

in which R₁₄ is hydrogen or C₁-C₁₀ alkyl; and
L_{PC} is a divalent radical of —CH₂—CHR₀—R₁₅—, —C₃H₆—O—R₁₆—

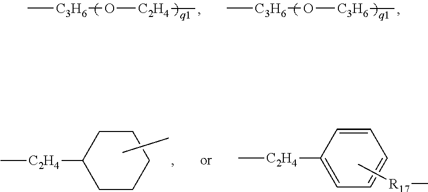

in which q1 is an integer of 1 to 20, R₁₅ is a linear or branched C₁-C₁₀alkylene divalent radical, R₁₆ is a linear or branched C₃-C₁₀ alkylene divalent radical, and R₁₇ is a direct bond or a linear or branched C₁-C₄ alkylene divalent radical.
51. The method of any one of embodiments 44 to 50, wherein said at least one hydrophilic vinylic monomer comprises: (1) an alkyl (meth)acrylamide selected from the group consisting of (meth)acrylamide, N,N-dimethyl (meth)acrylamide, N-ethyl (meth)acrylamide, N,N-diethyl (meth)acrylamide, N-propyl (meth)acrylamide, N-isopropyl (meth)acrylamide, N-3-methoxypropyl (meth)acrylamide, and combinations thereof; (2) a hydroxyl-containing acrylic monomer selected from the group consisting of N-2-hydroxylethyl (meth)acrylamide, N,N-bis(hydroxyethyl) (meth)acrylamide, N-3-hydroxypropyl (meth)acrylamide, N-2-hydroxypropyl (meth)acrylamide, N-2,3-dihydroxypropyl (meth)acrylamide, N-tris(hydroxymethyl)methyl (meth)acrylamide, 2-hydroxyethyl (meth)acrylate, 3-hydroxypropyl (meth)acrylate, 2-hydroxypropyl (meth)acrylate, glycerol methacrylate (GMA), di(ethylene glycol) (meth)acrylate, tri(ethylene glycol) (meth)acrylate, tetra(ethylene glycol) (meth)acrylate, poly(ethylene glycol) (meth)acrylate having a number average molecular weight of up to 1500, poly(ethylene glycol)ethyl (meth)acrylamide having a number average molecular weight of up to 1500, and combinations thereof; (3) a carboxyl-containing acrylic monomer selected from the group consisting of 2-(meth)acrylamidoglycolic acid, (meth)acrylic acid, ethylacrylic acid, 3-(meth)acrylamidopropionic acid, 5-(meth)acrylamidopentanoic acid, 4-(meth)acrylamidobutanoic acid, 3-(meth)acrylamido-2-methylbutanoic acid, 3-(meth)acrylamido-3-methylbutanoic acid, 2-(meth)acrylamido-2methyl-3,3-dimethyl butanoic acid, 3-(meth)acrylamidohaxanoic acid, 4-(meth)acrylamido-3,3-dimethylhexanoic acid, and combinations thereof; (4) an amino-containing acrylic monomer selected from the group consisting of N-2-aminoethyl (meth)acrylamide, N-2-methylaminoethyl (meth)acrylamide, N-2-ethylaminoethyl (meth)acrylamide, N-2-dimethylaminoethyl (meth)acrylamide, N-3-aminopropyl (meth)acrylamide, N-3-methylaminopropyl (meth)acrylamide, N-3-dimethylaminopropyl (meth)acrylamide, 2-aminoethyl (meth)acrylate, 2-methylaminoethyl (meth)acrylate, 2-ethylaminoethyl (meth)acrylate, 3-aminopropyl (meth)acrylate, 3-methylaminopropyl (meth)acrylate, 3-ethylaminopropyl (meth)acrylate, 3-amino-2-hydroxypropyl (meth)acrylate, trimethylammonium 2-hydroxy propyl (meth)acrylate hydrochloride, dimethylaminoethyl (meth)acrylate, and combinations thereof; (5) an N-vinyl amide monomer selected from the group consisting of N-vinylpyrrolidone (aka, N-vinyl-2-pyrrolidone), N-vinyl-3-methyl-2-pyrrolidone, N-vinyl-4-methyl-2-pyrrolidone, N-vinyl-5-methyl-2-pyrrolidone, N-vinyl-6-methyl-2-pyrrolidone, N-vinyl-3-ethyl-2-pyrrolidone, N-vinyl-4,5-dimethyl-2-pyrrolidone, N-vinyl-5,5-dimethyl-2-pyrrolidone, N-vinyl-3,3,5-trimethyl-2-pyrrolidone, N-vinyl piperidone (aka, N-vinyl-2-piperidone), N-vinyl-3-methyl-2-piperidone, N-vinyl-4-methyl-2-piperidone, N-vinyl-5-methyl-2-piperidone, N-vinyl-6-methyl-2-piperidone, N-vinyl-6-ethyl-2-piperidone, N-vinyl-3,5-dimethyl-2-piperidone, N-vinyl-4,4-dimethyl-2-piperidone, N-vinyl caprolactam (aka, N-vinyl-2-caprolactam), N-vinyl-3-methyl-2-caprolactam, N-vinyl-4-methyl-2-caprolactam, N-vinyl-7-methyl-2-caprolactam, N-vinyl-7-ethyl-2-caprolactam, N-vinyl-3,5-dimethyl-2-caprolactam, N-vinyl-4,6-dimethyl-2-caprolactam, N-vinyl-3,5,7-trimethyl-2-caprolactam, N-vinyl-N-methyl acetamide, N-vinyl formamide, N-vinyl acetamide, N-vinyl isopropylamide, N-vinyl-N-ethyl acetamide, N-vinyl-N-ethyl formamide, and mixtures thereof; (6) a methylene-containing pyrrolidone monomer selected from the group consisting of 1-methyl-3-methylene-2-pyrrolidone, 1-ethyl-3-methylene-2-pyrrolidone, 1-methyl-5-methylene-2-pyrrolidone, 1-ethyl-5-methylene-2-pyrrolidone, 5-methyl-3-methylene-2-pyrrolidone, 5-ethyl-3-methylene-2-pyrrolidone, 1-n-propyl-3-methylene-2-pyrrolidone, 1-n-propyl-5-methylene-2-pyrrolidone, 1-isopropyl-3-methylene-2-pyrrolidone, 1-isopropyl-5-methylene-2-pyrrolidone, 1-n-butyl-3-methylene-2-pyrrolidone, 1-tert-butyl-3-methylene-2-pyrrolidone, and combinations thereof; (7) an acrylic monomer having a C,—C₄ alkoxyethoxy group and selected from the group consisting of ethylene glycol methyl ether (meth)acrylate, di(ethylene glycol) methyl ether (meth)acrylate, tri(ethylene glycol) methyl ether (meth)acrylate, tetra(ethylene glycol) methyl ether (meth)acrylate, C₁-C₄-alkoxy poly(ethylene glycol) (meth)acrylate having a number average molecular weight of up to 1500, methoxy-poly(ethylene glycol)ethyl (meth)acrylamide having a number average molecular weight of up to 1500, and combinations thereof; (8) a vinyl ether monomer selected from the group consisting of ethylene glycol monovinyl ether, di(ethylene glycol) monovinyl ether, tri(ethylene glycol) monovinyl ether, tetra(ethylene glycol) monovinyl ether, poly(ethylene glycol) monovinyl ether, ethylene glycol methyl vinyl ether, di(ethylene glycol) methyl vinyl ether, tri(ethylene glycol) methyl vinyl ether, tetra(ethylene glycol) methyl vinyl ether, poly(ethylene glycol) methyl vinyl ether, and combinations thereof; (9) an allyl ether monomer selected from the group consisting of ethylene glycol monoallyl ether, di(ethylene glycol) monoallyl ether, tri(ethylene glycol) monoallyl ether, tetra(ethylene glycol) monoallyl ether, poly(ethylene glycol) monoallyl ether, ethylene glycol methyl allyl ether, di(ethylene glycol) methyl allyl ether, tri(ethylene glycol) methyl allyl ether, tetra(ethylene glycol) methyl allyl ether, poly(ethylene glycol) methyl allyl ether, and combinations thereof; (10) a phosphorylcholine-containing vinylic monomer selected from the group consisting of (meth)acryloyloxyethyl phosphorylcholine, (meth)acryloyloxypropyl phosphorylcholine, 4-((meth)acryloyloxy)butyl-2′-(trimethylammonio)ethylphosphate, 2-[(meth)acryloylamino]ethyl-2′-(trimethylammonio)-ethylphosphate, 3-[(meth)acryloylamino]propyl-2′-(trimethylammonio)ethylphosphate, 4-[(meth)acryloylamino]butyl-2′-(trimethylammonio)ethylphosphate, 5-((meth)acryloyloxy)pentyl-2-(trimethylammonio)ethyl phosphate, 6-((meth)acryloyloxy)hexyl-2′-(trimethylammonio)-ethylphosphate, 2-((meth)acryloyloxy)ethyl-2′-(triethylammonio)ethylphosphate, 2-((meth)acryloyloxy)ethyl-2′-(tripropylammonio)ethylphosphate, 2-((meth)acryloyloxy)ethyl-2 (tributylammonio)ethyl phosphate, 2-((meth)acryloyloxy)propyl-2′-(trimethylammonio)-ethylphosphate, 2-((meth)acryloyloxy)butyl-2′-(trimethylammonio)ethylphosphate, 2-((meth)acryloyloxy)pentyl-2′-(trirmethylarmmonio)ethylphosphate, 2-((meth)acryloyloxy)hexyl-2-(trimethylammonio)ethyl phosphate, 2-(vinyloxy)ethyl-2′-(trimethylammonio)ethylphosphate, 2-(allyloxy)ethyl-2′-(trimethylammonio)ethylphosphate, 2-(vinyloxycarbonyl)ethyl-2′-(trimethylammonio)ethyl phosphate, 2-(allyloxycarbonyl)ethyl-2′-(trimethylammonio)-ethylphosphate, 2-(vinylcarbonylamino)ethyl-2′-(trimethylammonio)ethylphosphate, 2-(allyloxycarbonylamino)ethyl-2′-(trimethylammonio)ethyl phosphate, 2-(butenoyloxy)ethyl-2′-(trimethylammonio)ethylphosphate, and combinations thereof; (11) allyl alcohol; (12)N-2-hydroxyethyl vinyl carbamate; (13)N-carboxyvinyl-R-alanine (VINAL); (14)N-carboxyvinyl-α-alanine; (15) or combinations thereof.
52. The method of any one of embodiments 44 to 50, wherein said at least one hydrophilic vinylic monomer comprises N-vinylpyrrolidone, N-vinyl-N-methyl acetamide, or combinations thereof.
53. The method of any one of embodiments 44 to 50, wherein said at least one hydrophilic vinylic monomer comprises N,N-dimethyl (meth)acrylamide.
54. The method of any one of embodiments 44 to 50, wherein said at least one hydrophilic vinylic monomer comprises N-2-hydroxylethyl (meth)acrylamide, N,N-bis(hydroxyethyl) (meth)acrylamide, N-3-hydroxypropyl (meth)acrylamide, N-2-hydroxypropyl (meth)acrylamide, N-2,3-dihydroxypropyl (meth)acrylamide, N-tris(hydroxymethyl)methyl (meth)acrylamide, 2-hydroxyethyl (meth)acrylate, 3-hydroxypropyl (meth)acrylate, 2-hydroxypropyl (meth)acrylate, glycerol methacrylate (GMA), di(ethylene glycol) (meth)acrylate, tri(ethylene glycol) (meth)acrylate, tetra(ethylene glycol) (meth)acrylate, poly(ethylene glycol) (meth)acrylate having a number average molecular weight of up to 1500, poly(ethylene glycol)ethyl (meth)acrylamide having a number average molecular weight of up to 1500, or combinations thereof.
55. The method of any one of embodiments 44 to 54, wherein the lens-forming composition comprises at least one non-silicone vinylic crosslinker that comprises ethyleneglycol di-(meth)acrylate, diethyleneglycol di-(meth)acrylate, triethyleneglycol di-(meth)acrylate, tetraethyleneglycol di-(meth)acrylate, glycerol di-(meth)acrylate, 1,3-propanediol di-(meth)acrylate, 1,3-butanediol di-(meth)acrylate, 1,4-butanediol di-(meth)acrylate, glycerol 1,3-diglycerolate di-(meth)acrylate, ethylenebis[oxy(2-hydroxypropane-1,3-diyl)] di-(meth)acrylate, bis[2-(meth)acryloxyethyl] phosphate, trimethylolpropane di-(meth)acrylate, and 3,4-bis[(meth)acryloyl]tetrahydrofuan, diacrylamide, dimethacrylamide, N,N-di(meth)acryloyl-N-methylamine, N,N-di(meth)acryloyl-N-ethylamine, N,N′-methylene bis(meth)acrylamide, N,N′-ethylene bis(meth)acrylamide, N,N′-dihydroxyethylene bis(meth)acrylamide, N,N′-propylene bis(meth)acrylamide, N,N′-2-hydroxypropylene bis(meth)acrylamide, N,N′-2,3-dihydroxybutylene bis(meth)acrylamide, 1,3-bis(meth)acrylamidepropane-2-yl dihydrogen phosphate, piperazine diacrylamide, tetraethyleneglycol divinyl ether, triethyleneglycol divinyl ether, diethyleneglycol divinyl ether, ethyleneglycol divinyl ether, triallyl isocyanurate, triallyl cyanurate, trimethylopropane trimethacrylate, pentaerythritol tetramethacrylate, bisphenol A dimethacrylate, allylmethacrylate, allylacrylate, N-allyl-methacrylamide, N-allyl-acrylamide, or combinations thereof.
56. The method of any one of embodiments 44 to 55, wherein the lens-forming composition comprises at least one blending vinylic monomer that comprises C₁-C₁₀ alkyl (meth)acrylate, cyclopentylacrylate, cyclohexylmethacrylate, cyclohexylacrylate, isobornyl (meth)acrylate, styrene, 4,6-trimethylstyrene (TMS), t-butyl styrene (TBS), trifluoroethyl (meth)acrylate, hexafluoro-isopropyl (meth)acrylate, hexafluorobutyl (meth)acrylate, or combinations thereof.
57. The method of any one of embodiments 44 to 56, wherein the bulk hydrogel material has an equilibrium water content (i.e., in fully hydrated state or when being fully hydrated) of from about 20% to about 70% by weight, an oxygen permeability of at least about 40 barrers, and a modulus (i.e., Young's modulus) of about 1.5 MPa or less.
58. An embedded contact lens, comprising a lens body that comprises an anterior surface, an opposite posterior surface, a bulk hydrogel material having a first refractive index, and a circular insert embedded in the bulk hydrogel material, wherein the circular insert has a diameter of about 11.0 mm or less and is made of a crosslinked polymeric material having a second refractive index, wherein the circular insert has a front surface and an opposite back surface and is concentric with a central axis of the lens body, wherein one of the front and back surfaces of the circular insert merges with one of the anterior and posterior surface of the lens body while the other one of the front and back surfaces of the circular insert is buried within the bulk hydrogel material and designated as buried surface, wherein the buried surface of the circular insert comprises a diffractive structure, wherein the second refractive index is at least 0.03 higher than the first refractive index, wherein the crosslinked polymeric material comprising repeating units of at least one aryl vinylic monomer and at least one aryl vinylic crosslinker.
59. The embedded contact lens of embodiment 58, wherein the second refractive index is at least 1.44.
60. The embedded contact lens of embodiment 58, wherein the second refractive index is at least 1.46.
61. The embedded contact lens of embodiment 58, wherein the second refractive index is at least 1.48.
62. The embedded contact lens of embodiment 58, wherein the second refractive index is at least 1.50.
63. The embedded contact lens of any one of embodiments 58 to 62, wherein said at least one aryl vinylic monomer comprises any one of the aryl vinylic monomers recited in any one of embodiments 23 to 27, wherein said at least one aryl vinylic crosslinker comprises any one of the aryl vinylic crosslinkers recited in any one of embodiments 28 to 40.
64. The embedded contact lens of any one of embodiments 58 to 62, wherein the crosslinked polymeric material comprising repeating units of at least one silicone-containing aryl vinylic monomer and at least one aryl-containing polysiloxane vinylic crosslinker.
65. The embedded contact lens of embodiment 64, wherein said at least one silicone-containing aryl vinylic monomer comprises p-vinylphenyltris(trimethylsiloxy)silane; m-vinylphenyltris(trimethylsiloxy)silane; o-vinylphenyltris(trimethylsiloxy)silane; p-styrylethyltris(trimethylsiloxy)silane; m-styrylethyl-tris(trimethylsiloxy)silane; o-styrylethyltris(trimethylsiloxy)silane; or combinations thereof, wherein said at least one aryl-containing polysiloxane vinylic crosslinker comprises any one of the aryl-containing polysiloxane vinylic crosslinkers recited in any one of embodiments 31 to 40.
66. The embedded contact lens of any one of embodiments 58 to 65, wherein the bulk hydrogel material is a non-silicone hydrogel material.
67. The embedded contact lens of any one of embodiments 58 to 65, wherein the bulk hydrogel material is a silicone hydrogel material that has an equilibrium water content (i.e., in fully hydrated state or when being fully hydrated) of from about 20% to about 70% by weight, an oxygen permeability of at least 60 barrers, and an elastic modulus of about 1.5 MPa or less.

The previous disclosure will enable one having ordinary skill in the art to practice the invention. Various modifications, variations, and combinations can be made to the various embodiment described herein. In order to better enable the reader to understand specific embodiments and the advantages thereof, reference to the following examples is suggested. It is intended that the specification and examples be considered as exemplary.

### Example 1

### Oxygen Permeability Measurements

Unless specified, the oxygen transmissibility (Dk/t), the intrinsic (or edge-corrected) oxygen permeability (Dkᵢ or Dk_{c}) of an insert and an insert material are determined according to procedures described in ISO 18369-4.

### Equilibrium Water Content

The equilibrium water content (EWC) of contact lenses is determined as follows.

Amount of water (expressed as percent by weight) present in a hydrated hydrogel contact lens, which is fully equilibrated in saline solution, is determined at room temperature. Quickly stack the lenses, and transfer the lens stack to the aluminum pan on the analytical balance after blotting lens in a cloth. The number of lenses for each sample pan is typically five (5). Record the pan plus hydrated weight of the lenses. Cover the pan with aluminum foil. Place pans in a laboratory oven at 100±2° C. to dry for 16-18 hours. Remove pan plus lenses from the oven and cool in a desiccator for at least 30 minutes. Remove a single pan from the desiccator, and discard the aluminum foil. Weigh the pan plus dried lens sample on an analytical balance. Repeat for all pans. The wet and dry weight of the lens samples can be calculated by subtracting the weight of the empty weigh pan.

### Elastic Modulus

The storage modulus (Young's modulus) of inserts is determined using a TA RSA-G2 DMA (Dynamic Mechanical Analyzer). The insert is cut into a 3.08 mm wide strip using Precision Concept dry lens cutter. Five thickness values are measured within 6.5 mm gauge length. The strip is mounted on the instrument with metal grips. Oscillation temperature ramp test with a linear ramping rate at 2° C./minute from 10° C.˜50° C. is applied on the insert, the material response to increasing temperature is monitored at a constant frequency of 1 Hz, constant amplitude of 0.5% deformation and sampling rate of 10.0 pts/s. Storage modulus (E′), loss modulus (E″) and tan δ data are calculated by TRIOS software.

The elastic modulus of a SiHy material or contact lens is determined using a MTS insight instrument. The contact lens is first cut into a 3.12 mm wide strip using Precision Concept two stage cutter. Five thickness values are measured within 6.5 mm gauge length. The strip is mounted on the instrument grips and submerged in PBS (phosphate buffered saline) with the temperature controlled at 21±2° C. Typically 5N Load cell is used for the test. Constant force and speed is applied to the sample until the sample breaks. Force and displacement data are collected by the TestWorks software. The elastic modulus value is calculated by the TestWorks software which is the slope or tangent of the stress vs. strain curve near zero elongation, in the elastic deformation region.

### Refractive Index

The refractive index (RI) of inserts is determined by Abbe transmission laboratory refractometer Reichert Abbe Mark Ill at 25° C. The inserts are fully equilibrated in PBS saline solution before measurement.

### Delamination

Embedded hydrogel contact lenses are examined for possible delamination either using Optimec instrument or Optical Coherence Tomography (OCT).

Regardless of evaluation method, contact lenses are staged for a minimum of 12 hours at room temperature after autoclave run and prior to delamination study.

After meeting required staging time, fully hydrated contact lens is placed in a “V” graticule assembly of Optimec instrument (Model JCF; OPTIMEC England). After the contact lens is settled under the influence of gravity, the front view of the contact lens is inspected carefully for any sign of circular pattern. Delamination displays as circular patterns in Optimec image.

OCT (Spectral Domain Optical Coherence Tomography; Telesto-II; Thorlabs) could also be utilized to study delamination. OCT allows non-invasive imaging of the contact lens to obtain high resolution cross-section image. For this purpose, after meeting the minimum staging requirement, the contact lens is removed from its blister and is soaked into PBS solution for a minimum of 30 min to come to equilibrium. Then a cuvette with a “V” block feature will be filled approximately ¾ with fresh PBS solution and the contact lens will be transferred to the cuvette using Q-tips. The lens will be allowed to freely float to the “V” shape at the bottom of the cuvette and the entire contact lens will be scanned in increment of 10 degree. Delamination appears as air pocket in interval surface of insert and carrier in OCT images.

### Chemicals

The following abbreviations are used in the following examples: RI Si-Macromer represents a methacryloxypropyl-terminated polysiloxane of formula (B) in which m˜32-34 and n˜17-18 as determined by ²⁹Si-NMR); Sty-Tris represents p-vinylphenyltris(trimethylsiloxy)silane (aka, 3-(4-ethenylphenyl)1,1,1,5,5,5-hexamethyl-3-[(trimethylsilyl)oxy]trisiloxane); CuP dispersion represents a dispersion of Cu(II)-phthalocyanin particles dispersed in 3-[tris(trimethylsiloxyl)silyl]propyl-methacrylate; DC 1173 represents a photoinitiator made of 2-hydroxy-2-methyl-1-phenylpropanone; PETA represents pentaerythritol tetraacrylate; Tris-AAm represents 3-acrylamidopropyltris (trimethyl-siloxy) silane; TrisMA represents 3-[Tris(trimethylsiloxy)silyl]propyl methacrylate; HFIPMA represents hexafluoroisopropyl methacrylate; NPGDMA represents neopentyl glycol dimethacrylate; DMA represents N,N-dimethyl acrylamide; MMA represents methyl methacrylate; TEGDMA represent triethyleneglycol dimethacrylate; VAZO 67 represents 2,2′-azobis(2-methylbutyronitrile); RB247 is Reactive Blue 247; EGBE represents ethylene glycol butyl ether; PBS represents a phosphate-buffered saline which has a pH of 7.2±0.2 at 25° C. and contains about 0.044 wt. % NaH₂PO₄·H₂O, about 0.388 wt. % Na₂HPO₄·2H₂O, and about 0.79 wt. % NaCl and; wt. % represents weight percent; “H4” macromer represents a di-methacryloyloxypropyl-terminated polysiloxane (Mn˜11.3K-12.3K g/mol, OH content ˜1.82-2.01 meq/g) of formula (A) shown below.

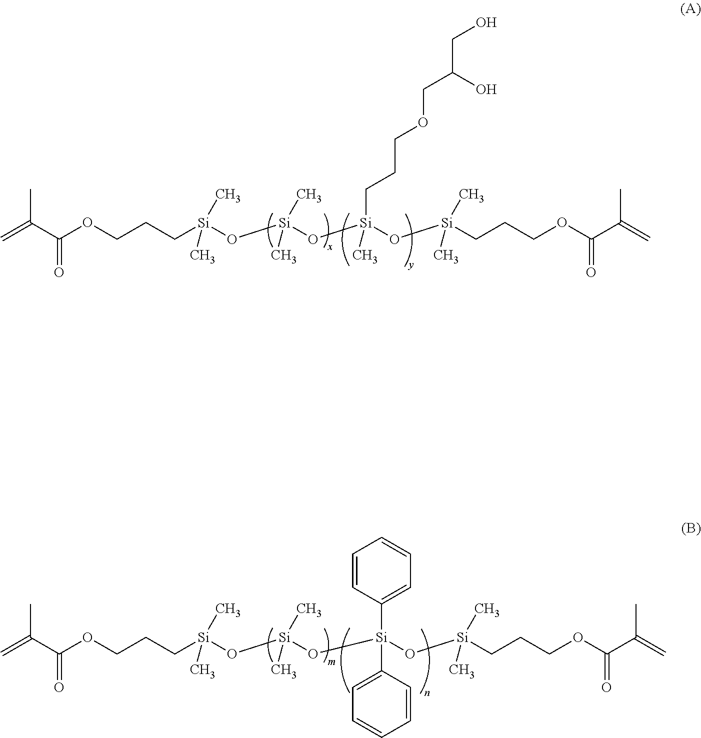

### Example 2

### Insert-Forming Compositions

Insert-forming compositions (i.e., Insert formulations) for making diffractive inserts are prepared at room temperature in air by blending all the components (materials) in their desired amounts (weight parts units) to have the composition shown in Table 1.

TABLE 1

| | Insert formulation 1 | Insert Formulation 2 |
|---|---|---|
| RI Si Macromer | 50 | 50 |
| Sty-Tris | 50 | 50 |
| DC1173 | 0.5 | |
| CuP dispersion | 0.5 | 0.5 |
| VAZO 67 | | 0.5 |

Inserts (a diameter of 6.0 mm and a thickness of 60 μm) molded from the insert-forming compositions prepared above has a refractive index of 1.50 and a modulus of about 20 MPa.

### Lens-Forming Compositions

Lens-forming compositions (i.e., SiHy lens formulations) are prepared at room temperature in air by blending all the components (materials) in their desired amounts (weight parts units) to have the composition shown in Table 2.

TABLE 2

| | Lens-Forming Composition (weight part units) | | | | | |
|---|---|---|---|---|---|---|
| SiHy Lens | | | | | DC | |
| Formulation # | CE-PDMS | Tris-AAm | Tris-MA | DMA | 1173 | PrOH |
| 1 | 32 | 21 | — | 24 | 1 | 22 |
| 2 | 32 | 10.5 | 10.5 | 24 | 1 | 22 |

### Molds for Making Embedded SiHy Contact Lenses

A set of three mold halves, a female mold half, a first male half and a second male mold half, are made of polypropylene and are used in this Example for preparing embedded diffractive SiHy contact lenses, each of which comprises an insert having a diameter of about 6.0 mm, a thickness of about 60 microns, and a diffractive structure on its back surface.

The female mold half are used twice in the process for preparing an embedded diffractive SiHy contact lens: the first time for molding the insert with the diffractive structure thereon and the second time for molding the embedded SiHy contact lens. The molding surface of the female mold half defines both the anterior surface of the embedded SiHy contact lens and the front surface of the insert.

The first male mold half has a molding surface defining the back surface of the insert and the diffractive structure. It has an overflow groove into which any excess insert-forming composition can be pressed into during closing of the female mold half and the first male mold half for forming a first molding assembly.

The second male mold half has molding surface defining the posterior surface of the embedded SiHy contact lens.

### Example 3

### Treatment of Female Mold Halves

The molding surfaces of the female mold halves described in Example 2 are treated with a corona plasma before being used in the production of embedded SiHy diffractive contact lenses.

First male halves (described in Example 2) each with a 2 mm hole drilled in the center are used as masks. The 2 mm diameter opening in the mask is used to ensure that the insert is not completely stuck with the front curve side since the overall diameter of the insert is around 6 mm. Such a mask can ensure that the insert is attached just enough to remain intact after the insert demolding/flash removal step but not too strong to prevent it from being released after curing with the lens-forming composition.

Each mask is placed on one female mold half (described in Example 2) and closed to form one assembly that is in turn to be treated in a corona treatment instrument (Tantec LabTEC custom corona treater) under the conditions: power applied −30W; applied voltage −2 kV; duration −0.5 second; at a distance of ˜10 mm from the tip of the electrode. The female mold halves with their molding surface treated with a corona plasma are used later in the production of embedded SiHy contact lenses.

It is understood that any corona treatment instrument can be used in treating the female mold halves.

### Preparation of Embedded Silicone Hydrogel Contact Lenses

An insert-forming composition (Insert Formulation 1) prepared in Example 2 is purged with nitrogen at room temperature for 30 to 35 minutes. A specific volume (e.g., ˜20 μl) of the N₂-purged insert-forming composition is disposed in the center of the molding surface of a female lens mold half that has been treated with a corona plasma above. The female lens mold half with the insert-forming composition therein is closed with a first male mold half described in Example 2 to form a first molding assembly. The insert-forming composition in the first molding assembly is cured by using a UV LED oven at 2.5 mW/cm² for 45 minutes.

After the curing step, the first male mold half of the first molding assembly is gently blasted with liquid nitrogen for 2-5 seconds, then the first male mold half is pinched and released gently. The molded inserts (100%) are adhered onto the central area of the molding surface of the female mold half whereas the insert flash is stuck on the overflow groove of the first male mold half.

A lens-forming composition (lens-forming composition 1) prepared in Example 2 is purged with nitrogen at room temperature for 30 to 35 minutes. A specific volume (e.g., 50-60 mg) of the N₂-purged lens-forming composition is disposed onto the molded insert adhered onto the central portion of the molding surface of the female lens mold half. The female lens mold half with the insert adhered thereonto and with the lens-forming composition is closed with a second male mold half (described in Example 2) to form a second molding assembly.

The lens-forming composition in closed second molding assemblies are irradiated with a UV LED oven (with intensity of 7.5 mW/cm2; double sided exposure) for 2.5 minutes. The 2^{nd} molding assemblies each with a molded embedded SiHy contact lens precursor therein are mechanically opened.

The molded embedded silicone hydrogel contact lens precursors adhere to the male mold halves or female mold halves. Molded embedded silicone hydrogel contact lens precursors adhered to male mold halves are delensed using ultrasonic unit or liquid nitrogen to remove the embedded lens from the molds; molded embedded silicone hydrogel contact lens precursors adhered to female mold halves are delensed are manually from lens-adhered female mold halves.

The delensed embedded silicone hydrogel contact lens precursors can be extracted with a mixture of 50:50 of propylene glycol:water. Preferably, the delensed embedded silicone hydrogel contact lens precursors are subjected to the following extraction/hydration, coating, autoclave processes as follows. The embedded silicone hydrogel contact lens precursors are soaked in a bath containing deionized water or an aqueous solution of Tween 80 (500 PPM), for about 60 minutes, then in a bath containing an aqueous solution of polyacrylic acid (PAA, Mw 450K) at a concentration of ca. 0.1% by weight at 40° C. for about 120 minutes; then in a bath containing a PBS solution at room temperature for about 60 minutes; packed/sealed in polypropylene lens packaging shells (or blisters) (one lens per shell) with 0.65 mL of a in-package-coating packaging saline which is prepared according to the procedure described in Example 19 of U.S. Pat. No. 8,480,227; and finally autoclaved for about 45 minutes at 121° C. The resultant embedded SiHy contact lenses each have a hydrogel coating thereon.

### Example 4

### Treatment of Female Mold Halves

The molding surfaces of the female mold halves (described in Example 2) are treated with a vacuum UV before being used in the production of embedded SiHy diffractive contact lenses.

First male halves (described in Example 2) each with a 6 mm hole drilled in the center are used as masks. Each mask is placed on one female mold half (described in Example 2) and closed to form one assembly that is in turn to be treated in N₂ glove by using H2D2 Hamamatsu source (a vacuum UV source, 160 nm, 50-2000 uW/cm2). The molding surface of each female half (described in Example 2) is irradiated with vacuum UV for 10-30 min. The female mold halves with their molding surfaces treated with vacuum UV are used later in the production of embedded SiHy contact lenses.

It is understood that female mold halves can be irradiated with vacuum UV for a longer time or any time required for ensuring that the insert is attached just enough to remain intact after the insert demolding/flash removal step but not too strong to prevent it from being released after curing with the lens-forming composition.

It is also understood that the opening of the mask can have a diameter smaller than the diameter of the insert. But, the duration of irradiation of vacuum UV can be increased to achieve the similar effects as understood by a person skilled in the art.

### Preparation of Embedded Silicone Hydrogel Contact Lenses

An insert-forming composition (Insert Formulation 2) prepared in Example 2 is purged with nitrogen at room temperature for 30 to 35 minutes. A specific volume (e.g. ˜20 μl) of the N₂-purged insert-forming composition is disposed in the center of the molding surface of a female lens mold half (described in Example 2) the molding surface of which has been treated with vacuum UV above. The female lens mold half with the insert-forming composition therein is closed with a first male mold half (described in Example 2) to form a first molding assembly.

The oven is configured as follows: a nitrogen supply is connected to the oven through a higher flow capacity controller which can control the flow rate of nitrogen through the oven; at the exhaust line of the oven, vacuum pumps are connected to control the differential pressure of the oven.

The insert-forming compositions in the first molding assemblies are thermally cured in the oven under the following conditions: ramp from room temperature to 55° C. at a ramp rate of about 7° C./minute; holding at 55° C. for about 30 minutes; ramp from 55° C. to 80° C. at a ramp rate of about 7° C./minute; holding at 80° C. for about 39 minutes; ramp from 80° C. to 100° C. at a ramp rate of about 7° C./minute; and holding at 100° C. for about 30 minutes. The first molding assemblies are opened, and the molded inserts are adhered onto the central area of the molding surface of the female lens mold halves.

After the curing step, the first male mold half of the first molding assembly is gently blasted with liquid nitrogen for 2-5 seconds, then the first male mold half is pinched and released gently. The molded inserts (8 out of 10) are adhered onto the central area of the molding surface of the female mold half whereas the insert flash is stuck on the overflow groove of the first male mold half.

A lens-forming composition (lens-forming composition 2) prepared in Example 2 is purged with nitrogen at room temperature for 30 to 35 minutes. A specific volume (e.g., 50-60 mg) of the N₂-purged lens-forming composition is disposed onto the molded insert adhered onto the central portion of the molding surface of the female lens mold half. The female lens mold half with the insert adhered thereonto and with the lens-forming composition is closed with a second male mold half (described in Example 2) to form a second molding assembly.

The lens-forming composition in closed second molding assemblies are irradiated with a UV LED oven (with intensity of 5 mW/cm2; double sided exposure) for 5 minutes. The 2^{nd} molding assemblies each with a molded embedded SiHy contact lens precursor therein are mechanically opened.

The molded embedded silicone hydrogel contact lens precursors adhere to the male mold halves or female mold halves. Molded embedded silicone hydrogel contact lens precursors adhered to male mold halves are delensed using ultrasonic unit or liquid nitrogen to remove the embedded lens from the molds; molded embedded silicone hydrogel contact lens precursors adhered to female mold halves are delensed are manually from lens-adhered female mold halves.

The delensed embedded silicone hydrogel contact lens precursors can be extracted with a mixture of 50:50 of propylene glycol:water. Preferably, the delensed embedded silicone hydrogel contact lens precursors are subjected to the following extraction/hydration, coating, autoclave processes as follows. The embedded silicone hydrogel contact lens precursors are soaked in a bath containing deionized water or an aqueous solution of Tween 80 (500 PPM), for about 60 minutes, then in a bath containing an aqueous solution of polyacrylic acid (PAA, Mw 450K) at a concentration of ca. 0.1% by weight at 40° C. for about 120 minutes; then in a bath containing a PBS solution at room temperature for about 60 minutes; packed/sealed in polypropylene lens packaging shells (or blisters) (one lens per shell) with 0.65 mL of a in-package-coating packaging saline which is prepared according to the procedure described in Example 19 of U.S. Pat. No. 8,480,227; and finally autoclaved for about 45 minutes at 121° C. The resultant embedded SiHy contact lenses each have a hydrogel coating thereon.

All the publications, patents, and patent application publications, which have been cited herein above in this application, are hereby incorporated by reference in their entireties.

What is claimed is:

1. A method for producing embedded hydrogel contact lenses, comprising the steps of:
(1) obtaining a female mold half, a first male mold half and a second male mold half, wherein the female mold half has a first molding surface defining the anterior surface of a contact lens to be molded and also the front surface of an insert to be molded, wherein the first male mold half has a second molding surface defining the back surface of the insert to be molded and a diffractive structure thereon, wherein the second male mold half has a third molding surface defining the posterior surface of the contact lens to be molded, wherein the first male mold half and the female mold half are configured to receive each other such that an insert-molding cavity is formed between the second molding surface and a central portion of the first molding surface when the female mold half is closed with the first male mold half, wherein the second male mold half and the female mold half are configured to receive each other such that a lens-molding cavity is formed between the first and third molding surfaces when the female mold half is closed with the second male mold half;
(2) treating a central circular area of the first molding surface by using a vacuum UV or a corona plasma, wherein the central circular area has a diameter equal to or smaller than the diameter of the insert to be molded;
(3) dispensing an amount of an insert-forming composition on the central portion of the first molding surface of the female mold half obtained in step (2);
(4) placing the first male mold half on top of the insert-forming composition in the female mold half and closing the first male mold half and the female mold half to form a first molding assembly comprising the insert-forming composition within the insert-molding cavity;
(5) curing the insert-forming composition in the insert-molding cavity of the first molding assembly to form a molded insert made of a crosslinked polymeric material formed from the insert-forming composition;
(6) separating the first molding assembly obtained in step (5) into the first male mold half and the female mold half with the molded insert that is adhered onto the central portion of the first molding surface;
(7) dispensing a lens-forming composition in the female mold half with the molded insert adhered thereon in an amount sufficient for filling the lens-molding cavity;
(8) placing the second male mold half on top of the lens-forming composition in the female mold half and closing the second male mold half and the female mold half to form a second molding assembly comprising the lens-forming composition and the molded insert immersed therein in the lens-molding cavity;
(9) curing the lens-forming composition in the lens-molding cavity of the second molding assembly to form an embedded hydrogel contact lens precursor that comprise a bulk hydrogel material formed from the lens-forming composition and the insert embedded in the bulk hydrogel material;
(10) separating the second molding assembly obtained in step (9) into the second male mold half and the female mold half, with the embedded hydrogel contact lens precursor adhered on a lens-adhered mold half which is one of the female and second male mold halves;
(11) removing the embedded hydrogel contact lens precursor from the lens-adhered mold half (preferably before the embedded hydrogel contact lens precursor is contact with water or any liquid); and
(12) subjecting the embedded hydrogel contact lens precursor to post-molding processes including one or more processes selected from the group consisting of extraction, hydration, surface treatment, packaging, sterilization, and combinations thereof to obtain an embedded hydrogel contact lens.

2. The method of claim 1, wherein the first male mold half comprise an overflow groove which surrounds the second molding surface and into which any excess insert-forming material is pressed when the first molding assembly is closed securely, wherein any flushes formed from the excess insert-forming material during step (5) can be stuck on the first male mold half during step of separating the first molding assembly, thereby removing the flushes.

3. The method of claim 2, wherein the central circular area of the first molding surface by using a vacuum UV.

4. The method of claim 2, wherein the central circular area of the first molding surface by using a corona plasma.

5. The method of claim 2, wherein the central circular area has a diameter that is about 90% or smaller of the diameter of the insert, wherein the insert-forming composition comprises at least one aryl vinylic monomer and/or at least one aryl vinylic crosslinker, wherein the lens-forming composition is a silicone hydrogel lens-forming composition that comprises (a) at least one silicone-containing vinylic monomer and/or at least one polysiloxane vinylic crosslinker, (b) at least one hydrophilic vinylic monomer, (c) at least one free-radical initiator, (d) at least one component selected from the group consisting of at least one non-silicone vinylic crosslinker, at least one UV-absorbing vinylic monomer, at least one HEVL-absorbing vinylic monomer, a visibility tinting agent, and combinations thereof, wherein the crosslinked polymeric material has a refractive index that is at least 0.03 higher than the refractive index of the bulk hydrogel material.

6. The method of claim 5, wherein the step of (5) curing the insert-forming composition is carried out thermally by heating the first molding assembly in an oven at one or more curing temperature selected from about 40° C. to about 100° C.

7. The method of claim 6, wherein the step of (9) curing the lens-forming composition is carried out actinically by using UV and/or visible light.

8. The method of claim 6, wherein the step of (9) curing the lens-forming composition is carried out thermally by heating the first molding assembly in an oven at one or more curing temperature selected from about 40° C. to about 100° C.

9. A method for producing embedded hydrogel contact lenses, comprising the steps of:
(1) obtaining a first female mold half, a male mold half and a second female mold half, wherein the first female mold half has a first molding surface defining the front surface of an insert to be molded and a diffractive structure thereon, wherein the male mold half has a second molding surface defining the posterior surface of a contact lens to be molded and also the back surface of the insert to be molded, wherein the second female mold half has a third molding surface defining the anterior surface of the contact lens to be molded, wherein the first female mold half and the male mold half are configured to receive each other such that an insert-molding cavity is formed between the first molding surface and a central portion of the second molding surface when the male mold half is closed with the first female mold half, wherein the second female mold half and the male mold half are configured to receive each other such that a lens-molding cavity is formed between the second and third molding surfaces when the male mold half is closed with the second female mold half;
(2) treating a central circular area of the second molding surface by using a vacuum UV or a corona plasma, wherein the central circular area has a diameter equal to or smaller than the diameter of the insert to be molded;
(3) dispensing an amount of an insert-forming composition on the first molding surface of the first female mold half;
(4) placing the male mold half obtained in step (2) on top of the insert-forming composition in the first female mold half and closing the first female mold half and the male mold half to form a first molding assembly comprising the insert-forming composition within the insert-molding cavity;
(5) curing the insert-forming composition in the insert-molding cavity of the first molding assembly to form a molded insert made of a crosslinked polymeric material formed from the insert-forming composition;
(6) separating the first molding assembly obtained in step (5) into the first female mold half and the male mold half with the molded insert that is adhered onto the central portion of the second molding surface;
(7) dispensing a lens-forming composition in the second female mold half in an amount sufficient for filling the lens-molding cavity;
(8) placing the male mold half with the molded insert adhered thereon on top of the lens-forming composition in the second female mold half and closing the male mold half and the second female mold half to form a second molding assembly comprising the lens-forming composition and the molded insert immersed therein in the lens-molding cavity;
(9) curing the lens-forming composition in the lens-molding cavity of the second molding assembly to form an embedded hydrogel contact lens precursor that comprise a bulk hydrogel material formed from the lens-forming composition and the insert embedded in the bulk material;
(10) separating the second molding assembly obtained in step (9) into the male mold half and the second female mold half, with the embedded hydrogel contact lens precursor adhered on a lens-adhered mold half which is one of the male and second female mold halves;
(11) removing the embedded hydrogel contact lens precursor from the lens-adhered mold half (preferably before the embedded hydrogel contact lens precursor is contact with water or any liquid); and
(12) subjecting the embedded hydrogel contact lens precursor to post-molding processes including one or more processes selected from the group consisting of extraction, hydration, surface treatment, packaging, sterilization, and combinations thereof to obtain an embedded hydrogel contact lens.

10. The method of claim 9, wherein the first male mold half comprise an overflow groove which surrounds the second molding surface and into which any excess insert-forming material is pressed when the first molding assembly is closed securely, wherein any flushes formed from the excess insert-forming material during step (5) can be stuck on the first male mold half during step of separating the first molding assembly, thereby removing the flushes.

11. The method of claim 10, wherein the central circular area of the first molding surface by using a vacuum UV.

12. The method of claim 10, wherein the central circular area of the first molding surface by using a corona plasma.

13. The method of claim 10, wherein the central circular area has a diameter that is about 90% or smaller of the diameter of the insert, wherein the insert-forming composition comprises at least one aryl vinylic monomer and/or at least one aryl vinylic crosslinker, wherein the lens-forming composition is a silicone hydrogel lens-forming composition that comprises (a) at least one silicone-containing vinylic monomer and/or at least one polysiloxane vinylic crosslinker, (b) at least one hydrophilic vinylic monomer, (c) at least one free-radical initiator, (d) at least one component selected from the group consisting of at least one non-silicone vinylic crosslinker, at least one UV-absorbing vinylic monomer, at least one HEVL-absorbing vinylic monomer, a visibility tinting agent, and combinations thereof, wherein the crosslinked polymeric material has a refractive index that is at least 0.03 higher than the refractive index of the bulk hydrogel material.

14. The method of claim 13, wherein the step of (5) curing the insert-forming composition is carried out thermally by heating the first molding assembly in an oven at one or more curing temperature selected from about 40° C. to about 100° C.

15. The method of claim 14, wherein the step of (9) curing the lens-forming composition is carried out actinically by using UV and/or visible light.

16. The method of claim 14, wherein the step of (9) curing the lens-forming composition is carried out thermally by heating the first molding assembly in an oven at one or more curing temperature selected from about 40° C. to about 100° C.

17. The method of claim 13, wherein the step of (5) curing the insert-forming composition is carried out actinically by using UV and/or visible light.

18. The method of claim 17, wherein the step of (9) curing the lens-forming composition is carried out actinically by using UV and/or visible light.

19. The method of claim 17, wherein the step of (9) curing the lens-forming composition is carried out thermally by heating the first molding assembly in an oven at one or more curing temperature selected from about 40° C. to about 100° C.

20. An embedded contact lens, comprising a lens body that comprises an anterior surface, an opposite posterior surface, a bulk hydrogel material having a first refractive index, and a circular insert embedded in the bulk hydrogel material, wherein the circular insert has a diameter of about 11.0 mm or less and is made of a crosslinked polymeric material having a second refractive index, wherein the circular insert has a front surface and an opposite back surface and is concentric with a central axis of the lens body, wherein one of the front and back surfaces of the circular insert merges with one of the anterior and posterior surface of the lens body while the other one of the front and back surfaces of the circular insert is buried within the bulk hydrogel material and designated as buried surface, wherein the buried surface of the circular insert comprises a diffractive structure, wherein the second refractive index is at least 0.03 higher than the first refractive index, wherein the crosslinked polymeric material comprising repeating units of at least one silicone-containing aryl vinylic monomer and at least one aryl-containing polysiloxane vinylic crosslinker.
